(19) United States
(12) Patent Application Publication
(10) Pub. No.: US 2020/0397012 A1
(43) Pub. Date: Dec. 24, 2020

(54) COMPOUNDS EXTRACTED FROM PLANT MATTER AND METHODS OF PREPARATION THEREOF

(71) Applicant: Apeel Technology, Inc., Goleta, CA (US)

(72) Inventors: David Sandoval, Goleta, CA (US); Ronald C. Bakus, II, Santa Barbara, CA (US); Daniel Essert, Goleta, CA (US); Derek Falcone, Santa Barbara, CA (US); David Fisher, Goleta, CA (US); Charles Frazier, Goleta, CA (US); Taylor Hayward, Santa Barbara, CA (US); Bardia Soltanzadeh, Santa Barbara, CA (US)

(21) Appl. No.: 16/906,735

(22) Filed: Jun. 19, 2020

Related U.S. Application Data
(60) Provisional application No. 62/865,006, filed on Jun. 21, 2019.

(51) Int. Cl. A23D 7/04; A23D 9/04; A23L 5/20

(52) U.S. Cl. CPC A23D 7/04; A23L 5/27; A23D 9/04

(57) ABSTRACT

Described herein are compositions from refined oil from plant matter, and in particular from seed, bean, nut, kernel, or pulp (e.g., wood pulp) material of virgin and/or non-virgin plant matter, and methods of forming those compositions. The methods typically include the steps of (i) at least partially separating the seed, bean, nut, kernel, or pulp material from other portions of the plant matter; (ii) extracting an oil comprising one or more triglycerides from the seed, bean, nut, kernel, or pulp material; (iii) refining the oil to remove one or more impurity components; and (iv) chemically or physically modifying the refined oil.

### RELATED APPLICATION

This application claims priority to and benefit from U.S. Provisional Patent Application No. 62/865,006, filed Jun. 21, 2019, the contents and disclosures of which are incorporated herein by reference in their entirety.

### TECHNICAL FIELD

The present disclosure relates to compositions formed from plant extracts, and to methods of forming the same.

### BACKGROUND

Triglycerides are a ubiquitous family of molecules found in many living organisms that have found use in a variety of consumer products, including edible oils, personal care products, cosmetics, and many others. The fatty acid composition of triglycerides can vary widely among biological sources, including fatty acid chain length, substitution, degree and position of unsaturation, as well as other variations. In addition to their use in consumer products, triglycerides can also be utilized as precursors for obtaining other products, for example 1,2-diglycerides, 1,3-diglycerides, 1-monoglycerides, 2-monoglycerides, fatty acid esters, fatty amides, fatty alcohols, fatty acids, fatty acid salts, alkyl amines, and long chain hydrocarbons, among others. These other products can subsequently be used in a variety of applications. For example, specific fatty acid derivatives can be used to form protective coatings for preserving perishable and/or edible products.

Certain crops (i.e., virgin crops) are grown for the purpose of extracting oil for use in consumer products (e.g., palm, olive, shea, soy, sunflower, cocoa, coconut and rapeseed). However, oil can also be extracted from other, non-virgin crops, e.g., cherry, pumpkin, grape, citrus, mango, stone fruit, grapefruit and wood pulp. These non-virgin sources are rarely used for the purpose of extracting oil to be refined for use in consumer products. This is due to the complexities associated with chemically and/or physically modifying the oils that can be extracted from these non-virgin sources. Thus, any portion of non-virgin plants that are not used for their primary purpose go to waste. Therefore, in order to reduce waste there is a need to develop methods that can be used to refine oil from non-virgin plant sources such that it is suitable for chemical and/or physical modification, and subsequent use in consumer products.

### SUMMARY

Described herein are methods of forming compositions from plant matter (e.g., virgin and/or non-virgin), and, in particular, from seed, bean, nut, kernel, or pulp (e.g., wood pulp) material of plant matter. The methods typically include the steps of (i) at least partially separating the seed, bean, nut, kernel, or pulp material from other portions of the plant matter, e.g., the raw biomass; (ii) extracting an oil comprising one or more triglycerides from the seed, bean, nut, kernel, or pulp material; (iii) refining the oil to remove one or more impurity components; and (iv) chemically or physically modifying the oil.

### BRIEF DESCRIPTION OF THE DRAWINGS

FIG. 1 illustrates an exemplary method for forming a composition.

FIG. 2 illustrates a method for separating seed, bean, nut, kernel, or pulp material from raw biomass.

FIG. 3 illustrates a method for purifying and refining raw oil extracts.

FIG. 4 shows the hydrogenation conversion rate of triglycerides in grapeseed oil after 30-minute hydrogenations performed after various purification and refining steps described herein.

FIG. 5 shows the hydrogenation conversion rate of triglycerides in oils obtained from peach kernel and grapefruit seed after 1-hour hydrogenations performed after various purification and refining steps described herein.

Like numerals in the figures represent like elements.

### DETAILED DESCRIPTION

Described herein are methods of forming compositions from non-virgin and/or virgin plant matter, and in particular from seed, bean, nut, kernel, or pulp (e.g., wood pulp) material of plant matter. The methods can allow plant matter that may otherwise go to waste to be used to produce specific compositions that can be useful in a variety of applications, or to produce compounds to which other components are added in order to form a composition. The resulting compositions can, for example, include fatty acids, fatty acid salts, and fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters of fatty acids (e.g., methyl esters, ethyl esters, propyl esters, butyl esters, pentyl esters, hexyl esters, among others). The extracted compositions can, for example, be used to form protective coatings for preserving perishable and/or edible products. In some cases, the methods described herein provide a more environmentally sustainable approach to forming the compositions than those that are typically used. The methods can in some cases also result in the resulting compositions being certifiable as USDA organic.

As used herein, the term “virgin plants” refers to plants that are typically grown for purposes including extracting and refining oil for human consumption or other industrial uses. Examples of virgin plants include, but are not limited to, palm trees, castor plant, peanut plants, olive trees, shea trees, soybeans, sunflowers, cocoa plants, coconut trees, and rapeseed. Because virgin plants are grown for the purpose of extracting and refining oil for human consumption or other industrial uses, they are bred and/or refined specifically such that the presence of certain adverse components that are toxic or otherwise undesirable, e.g., result in off-flavors or aromas, are eliminated or reduced. For this reason, without wishing to be bound by theory, oil that has been sourced from virgin plants can contain less impurities that adversely impact subsequent physical and or chemical modifications.

As used herein, the term “non-virgin plants” refers to plants that are typically grown for purposes other than extracting and refining their oil for human consumption or other industrial uses. Examples of non-virgin plants include, but are not limited to, cherry trees, apple trees, avocado trees, pumpkin plants, grape vines, citrus trees, mango trees, and stone fruit trees. Because non-virgin plants are not grown for the purposes of extracting and refining oil for human consumption or other industrial uses, they are not bred and/or refined such that the presence of certain adverse components that are toxic or otherwise undesirable, e.g., result in off-flavors or aromas, are eliminated or reduced. Without wishing to be bound by theory, because non-virgin plants are not grown for the purposes of extracting oil for human consumption or other industrial purposes, the oil extracted therefrom can contain impurities that make subsequent physical and/or chemical modifications difficult.

As used herein, the term “non-virgin oil” refers to oil that has been extracted from a non-virgin plant.

As used herein, the term “virgin oil” refers to oil that has been extracted from a virgin plant.

As used herein, the term “edible oil” refers to an oil that has been sourced from a virgin or non-virgin plant that has been commercially refined to remove toxic or other adverse impurities, that may result in off-flavors and/or aromas, such that the oil is fit for human consumption.

As used herein, the term “non-edible oil” refers to an oil that has been sourced from a virgin or non-virgin plant that has not been commercially refined to remove toxic and or other adverse impurities, that may result in off-flavors and/or aromas. Non-edible oils are not fit for human consumption.

As used herein, the term “commercially refined” refers to refinement processes that are used to remove toxic and/or other adverse impurities, that may result in off-flavors and/or aromas, from oil that is intended to be fit for human consumption or other industrial uses. Examples of commercial refinement steps include, but are not limited to, degumming, neutralizing, bleaching, or deodorizing the extracted oil.

As used herein, the term “plant matter” refers to any portion of a plant, including, for example, fruits (in the botanical sense, including fruit peels and juice sacs), leaves, stems, barks, seeds, flowers, peels, nuts, kernels, flesh, or roots. The plant matter referred to herein can be plant matter derived from virgin plants, non-virgin plants, or a combination thereof.

As used herein, the term “physical modification” refers to modifications to the compounds in the extracted crude, refined, purified or chemically modified oil that result in the exchange of fatty acid side chains of the compounds therein. Such physical modifications do not change the chemical class of a compound being modified, e.g., physical modifications performed on a triglyceride still result in a triglyceride. Similarly, physical modifications performed on a fatty acid ester still result in a fatty acid ester. As used herein, physical modifications also refer to modifications that alter (e.g., enrich) the purity of the oil. For example, the oil can be enriched with compounds having certain properties (e.g., saturated fatty acid side chains). Physical modifications can include, for example, crystallization of the triglycerides to separate high melting triglycerides (e.g. triglycerides with saturated fatty acid chains) from low melting triglycerides (e.g. triglycerides with unsaturated fatty acid chains); positional interchange of fatty acids on the glyceride backbone of glyceryl esters (e.g., mono-, di- and triglycerides); fatty acid interchange (e.g. interesterification) between the fatty acids on the glyceride backbone of glyceryl esters (e.g., mono-, di- and triglycerides) and free fatty acids; or combinations thereof.

As used herein, the term “chemical modification” refers to modifications to the compounds in the extracted crude, refined, purified or physically modified oil that chemically change the fatty acid side chains of the compounds therein (e.g., hydrogenation), and/or modifications that result in a change in the class of the compound (e.g., forming fatty acids, fatty acid salts, fatty acid amides, fatty amines, fatty alcohols, or fatty acid esters from triglycerides). Chemical modifications can include, for example, hydrogenation of the composition (i.e., reduction of unsaturated fatty acid side chains) to form saturated compounds; deprotonation of the composition (i.e. oxidation of saturated fatty acid side chains) to form unsaturated compounds; transesterification of the composition with an organic alcohol to form saturated or unsaturated fatty acid esters such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters among others); hydrolysis of the composition to form saturated or unsaturated free fatty acids; saponification of the composition to form saturated or unsaturated fatty acid salts; reduction of fatty acids to form alcohols; amidation of fatty acids to form fatty acid amides; amination of fatty alcohols to form alkyl amines or combinations thereof. The skilled worker will recognize that many chemical modifications are possible.

As used herein, the term “saturated molecules” refers to a compound that is characterized by a fatty acid side chain that is free of unsaturation, i.e., free of carbon-carbon, or other, double bonds or triple bonds. The saturated molecules referred to herein include saturated monoglycerides, saturated diglycerides, saturated triglycerides, saturated fatty acids, saturated fatty acid esters and saturated fatty acid salts.

As used herein, the term “unsaturated molecules” refers to a compound that is characterized by a fatty acid side chain that contains one or more carbon-carbon, or other, double bonds or triple bonds. The unsaturated molecules referred to herein include unsaturated monoglycerides, unsaturated diglycerides, unsaturated triglycerides, unsaturated fatty acids, unsaturated fatty acid esters and unsaturated fatty acid salts.

### Methods of the Disclosure

In one aspect, this disclosure is directed to a method of forming a composition from seed, bean, nut, kernel, or pulp material of non-virgin or virgin plant matter, comprising:
a. at least partially separating the seed, bean, nut, kernel, or pulp material from other portions of the plant matter;
b. extracting a crude oil comprising one or more triglycerides from the seed, bean, nut, kernel, or pulp material;
c. optionally refining the crude oil to remove one or more impurity components; and
d. modifying the refined oil to form the composition.

In some embodiments, the methods further include separating and/or purifying the modified oil.

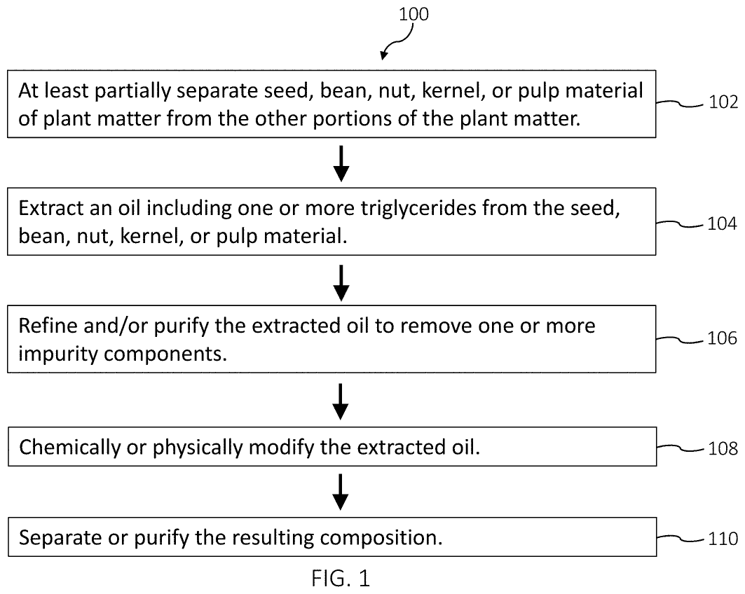

An exemplary method 100 for forming a composition from seed, bean, nut, kernel, or pulp material of plant matter is illustrated in FIG. 1. First, the seed, bean, nut, kernel, or pulp material of plant matter is at least partially separated from the other portions of the plant matter (step 102). Next, an oil that includes one or more triglycerides is extracted from the seed, bean, nut, or kernel material, or pulp (step 104). In some embodiments, this oil will include other impurities in addition to the triglyceride components, such as diglycerides (e.g., 1,2-diacylglycerides, 1,3-diacylglycerides), monoglycerides (e.g., 1-monoacyglycerides, 2-monoacylglycerides), free fatty acids, phospholipids (e.g., phosphatidic acids, phosphatidylethanolamines, phosphatidylcholines, phosphatidylserines, phosphatidylinositides, among others), proteins, sulfur-containing compounds, phosphorous-containing compounds, nitrogen containing compounds (e.g. alkylamines), saccharides (e.g., monosaccharides, disaccharides, oligosaccharides, polysaccharides), cyanogenic glucosides, phenols and polyphenols, carotenoids, steroids, vitamins, and minerals, among other impurities. The extracted oil is then refined to remove one or more impurity components (step 106), chemically or physically modified (step 108), and optionally, the resulting composition is separated or purified (step 110).

In some embodiments, the seed, bean, nut, kernel or pulp material is from non-virgin or virgin plants. In a preferred embodiment, the seed, bean, nut, kernel or pulp material is from non-virgin plants. Without wishing to be bound by theory, using non-virgin plant matter to produce compositions can be advantageous from the standpoint of life cycle environmental impact (e.g. global warming potential, eutrophication, acidification, land use, non-renewable energy demand, cumulative water withdrawals, etc.) relative to the use of virgin plant matter. In some embodiments, the global warming potential, (in kg CO₂eq) for producing compositions comprising, for example, fatty acids, fatty acid salts, and fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters of fatty acids (e.g., methyl esters, ethyl esters, propyl esters, butyl esters, pentyl esters, hexyl esters, among others) from the seed, bean, nut, kernel, or pulp (e.g. wood pulp) of a non-virgin plant can be lower than similar compositions made from virgin plant matter. For example, the global warming potential (in kg CO₂eq) for the production of 1 kg of saturated monoglycerides from different plant matter is given in the table below.

TABLE 1
Global Warming Potential for Production of
1 kg Saturated Monoglycerides

| | Global Warming Potential |
|---|---|
| Plant Matter | (kg CO_{2eq}) |
| Pumpkin Seed | 3.5 |
| Grapeseed | 3.8 |
| Rapeseed | 6.4 |
| Palm | 7.4 |

As shown in the table, the global warming potential for the production of 1 kg of saturated monoglyceride from the non-virgin plant matter (i.e. pumpkin seed and grapeseed) is lower than that from the virgin plant matter (i.e. rapeseed and palm). Without wishing to be bound to theory, by utilizing non-virgin plant matter, the majority of the environmental burden of the plant production can be allocated to the primary product from that plant (e.g. wine from grapes), rather than to the production of oil (e.g. oil from grape seeds), resulting in a lower overall global warming potential as compared to the virgin plant matter, which must assume the majority of the environmental burden. In some embodiments, the compositions derived from non-virgin plant matter using the methods according to this disclosure have a lower global warming potential than similar compositions derived from virgin plant matter. In some embodiments, the global warming potential for production of the composition can be less than 10 kg CO₂eq (e.g. less than 9 kg CO₂eq, less than 8 kg CO₂eq, less than 7 kg CO₂eq, less than 6 kg CO₂eq, less than 5 kg CO₂eq, less than 4 kg CO₂eq, less than 3 kg CO₂eq, less than 2 kg CO₂eq, or less than 1 kg CO₂eq).

### Separation

In some embodiments, at least partially separating the seed, bean, nut, kernel, or pulp material from the other portions of the plant matter (step 102) can be followed by chemical or physical modification of the seed, bean, nut, kernel, or pulp material to afford a composition. In some embodiments, at least partially separating the seed, bean, nut, kernel, or pulp material from the other portions of the plant matter (step 102) can be followed by the extraction of the oil from the seed, bean, nut, kernel, or pulp material (step 104), and then the resulting oil can then optionally be physically or chemically modified (as in step 108) to afford a composition. The composition can then be optionally separated or purified to afford a subsequent composition (as in step 110).

Referring to step 102 in FIG. 1, the virgin and/or non-virgin seed can be, for example, rapeseed, grapeseed, citrus seed, apple seed, sunflower seed, cottonseed, mango seed, safflower seed, pumpkin seed, among others; the virgin and/or non-virgin bean can be, for example, soy, cacao, castor, coffee, among others; the virgin and/or non-virgin nut can be, for example, peanut, shea nut, tree nuts, among others; the virgin and/or non-virgin kernel can be, for example, cherry kernel, stone fruit kernel, palm kernel, avocado pit, among others; the virgin and/or non-virgin pulp material from which the oil is extracted can be, for example, coconut, olive, palm, corn, or wood pulp (e.g., for the extraction of tall oil). The raw biomass or plant matter from which the virgin and/or non-virgin seed, bean, nut, kernel, or pulp material is obtained typically includes other portions of plant matter, for example stems, sticks, skins, flesh, pulp, pomace, water, and/or juice. The virgin and/or non-virgin seed, bean, nut, kernel, or pulp material can be at least partially separated from these other portions through a number of methods. In some embodiments, the virgin and/or non-virgin seed, bean, nut, kernel, or pulp material can be manually separated (e.g., separated by hand) from the rest of the raw biomass. In some embodiments, the seed, bean, kernel or pulp material is from a non-virgin plant. In some embodiments, the seed, bean, kernel or pulp material is from a virgin plant. In some embodiments, the seed, bean, kernel or pulp material is combined from virgin and non-virgin plants.

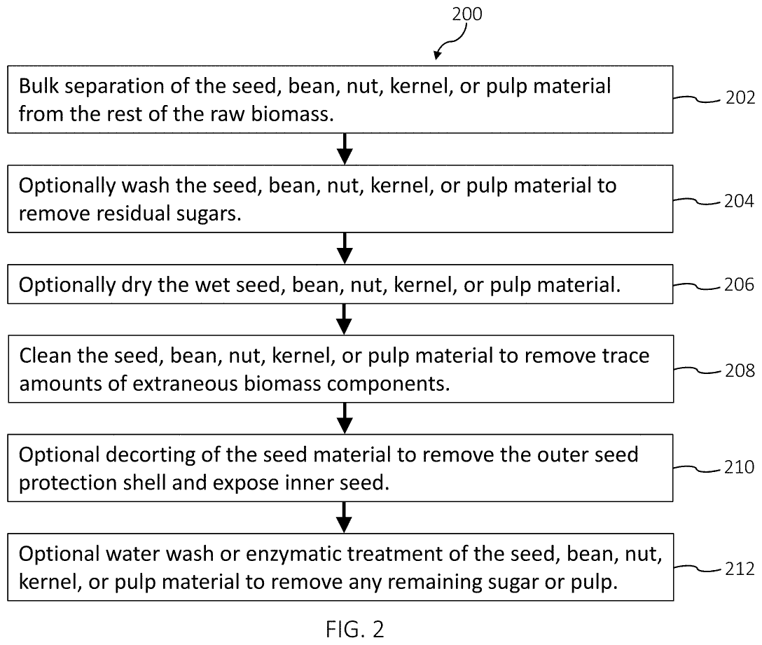

In some embodiments, the virgin and/or non-virgin seed, bean, nut, kernel, or pulp material can be separated from rest of the biomass or plant matter via the process 200 shown in FIG. 2. The first step of process 200 involves bulk separation of the virgin and/or non-virgin seed, bean, nut, kernel, or pulp material from the rest of the biomass (step 202 in FIG. 2), e.g., via manual hand separation or via mechanical equipment configured to perform the separation. Next, the virgin and or non-virgin seed, bean, nut, kernel, or pulp material can optionally be washed, e.g., with water or an enzymatic treatment, to remove residual sugars (step 204 in FIG. 2), optionally followed by drying of the wet seed, bean, nut, kernel, or pulp material (step 206 in FIG. 2), e.g., by heating and/or forced convection. Next, the dry virgin and/or non-virgin seed, bean, nut, kernel, or pulp material may be sifted to remove trace amounts of skin, sticks, and/or other extraneous biomass components (step 208 in FIG. 2). Optionally, some seed or nut material (e.g., mango seeds) may also require decorting (step 210 in FIG. 2) to remove the outer seed protection shell and expose the internal seed. Finally, the seeds can optionally be treated via water wash or via an enzymatic treatment (e.g., pectinase, cellulase, or hemicellulase enzymes) to remove any remaining sugar or pulp (step 212 in FIG. 2). In some embodiments, the virgin and/or non-virgin seed, bean, kernel, or pulp material can be further processed by grinding. Each of the separation steps exemplified above can be conducted independently or in one or more combinations. For example, 1,530 lbs of Grenache pomace (white wine pomace) was processed through a rotary screen separator for the bulk separation of seeds from the rest of the plant biomass. The seeds were then washed with water to remove residual sugars present on the seeds. The seeds were then spread out for sun drying to remove the bulk moisture. The seeds were then further dried by forced convection drying. The seeds were then sifted to remove residual skins, sticks, and extraneous biomass to afford 100 lbs of extracted seeds. Additionally, for example, 982 lbs of Pinot Noir pomace (red wine pomace) was processed through a rotary screen separator for the bulk separation of seeds from the rest of the biomass. The seeds were then spread out for sun drying to remove the bulk moisture. The seeds were then further dried by forced convection drying. The seeds were then sifted to remove residual skins, sticks, and extraneous biomass to afford 110 lb of extracted seeds. Additionally, for example, 2.6 g of lemon seeds were extracted manually from 67.48 g of lemon pomace. The seeds were treated with ColorX Enzyme and dried to 15% moisture using an oven. Additionally, for example, 50 g of apple pomace was diluted with 400 mL of water and then treated with 0.7 mL of a concentrated ColorX Enzyme solution for 2 hr. The material was then filtered, the seeds were removed manually and then dried to remove the bulk moisture. This afforded 6.5 g of dried Apple seeds. Additionally, for example, avocado pits were manually separated from the flesh of the avocado, cracked, and the husks were peeled away from the pit. The cracked pits were hammered into quarters, then the quarters were flattened. The flattened pieces were torn into smaller pieces and then ground in a spice grinder for 30 seconds to afford 158 grams of ground avocado pit.

### Extraction

Referring back to step 104 in FIG. 1, after the at least partial separation of the virgin and/or non-virgin seed, bean, nut, kernel, or pulp material from the other portions of the plant matter, an oil containing triglycerides is extracted from the seed, bean, nut, kernel, or pulp material. The extraction of the oil can be achieved, for example, by mechanical pressing (e.g. hydraulic pressing, screw pressing, among others), extraction using organic solvents (e.g. hexanes, heptane, ethyl acetate, ethanol, diethyl ether, toluene, among others), extraction with supercritical solvents (e.g. CO₂, propane, among others), distillation (steam, water, or solvent), maceration, or enfleurage (i.e. cold or hot enfleurage) methods. In some embodiments, the oil is extracted from the virgin and/or non-virgin seed, bean, nut, kernel, or pulp material by mechanical pressing. In some embodiments, the oil is extracted from the seed, bean, nut, kernel, or pulp material by the use of organic solvents. In some embodiments, the oil is extracted from the seed, bean, nut, kernel, or pulp material by the use of supercritical solvents. In some embodiments, the oil is extracted from the seed, bean, nut, kernel, or pulp material by maceration. In some embodiments, the oil is extracted from the seed, bean, nut, kernel, or pulp material by enfleurage.

As described above, at least, partial separation of the virgin and/or non-virgin seed, bean, nut, kernel, or pulp material from the other portions of the plant matter, an oil containing triglycerides is extracted from the seed, bean, nut, kernel, or pulp material. For example, 14 g of apple seeds were ground with a spice grinder and subjected to Soxhlet extraction for 24 hours using 700 mL of hexane as solvent. The hexane was then removed by vacuum distillation to afford 1.6 g of Apple seed oil. Additionally, for example, 65 g of cherry kernels were ground with a spice grinder and subjected to Soxhlet extraction for 24 hours using 1.2 L of hexane as solvent. The hexane was then removed by vacuum distillation to afford 3.0 g of cherry kernel oil. Additionally, for example, 11.4 g of ground raw peanuts were packed into a 0.5″ OD by 6″ supercritical fluid extractor equipped with a 2000 PSI back pressure regulator at a temperature of 60° C. The ground raw peanuts were extracted using a 1.25 mL/min flow rate of pure CO₂ for 3 hours, followed by 1 hour using 10% ethanol in CO₂ followed by 5 hours using pure CO₂ to afford 3.7 g of peanut oil. Additionally, for example, 5.7 g of dried and ground olive pomace (250-500 μm particle size) was packed into a 0.5″ OD by 6″ supercritical fluid extractor equipped with a 2000 PSI back pressure regulator at a temperature of 60° C. The olive pomace was extracted using 7 mL/min CO₂ with 0.4 mL/min ethanol for 3 hours to afford 1.1 g of olive pomace oil. Additionally, for example, 60 kg of red grape seeds were processed with an expeller press to afford crude oil. The oil was then clarified using a bowl centrifuge to afford 5 kg of clear grape seed oil. Additionally, for example, 67 kg of concord grape seeds were processed with an expeller press to afford crude oil. The oil was then clarified using a bowl centrifuge followed by a filter press to afford 3.6 kg of clear grape seed oil.

In some embodiments, the triglycerides in the extracted oils from the virgin and/or non-virgin seed, bean, nut, kernel, or pulp, which are optionally physically and/or chemically modified, and are optionally separated and/or purified from non-preferred components, can be compounds of Formula I, where Formula I is:

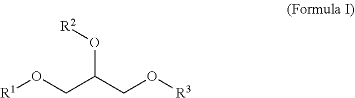

wherein:

R¹, R², and R³ are each independently at each occurrence fragments of Formula II, where Formula II is:

wherein.

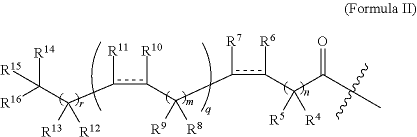

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

### Refinement/Purification

For many crude oil extracts, in the absence of particular refining steps, some or all of the chemical or physical processes described herein are either highly ineffective or are not sufficiently efficient to be useful in the applications for which the resulting compositions are intended. Additionally, many impurities in the crude oil extracts can have an adverse impact on properties of the compositions in cases where the compositions are subsequently eaten or otherwise consumed. For example, in applications where the compositions are used to form protective coatings over edible items, impurities can affect the flavor and/or physical appearance of the coated items. Commercial refinement of edible oils is generally carried out to remove toxic impurities, or other impurities that adversely affect the flavor, aroma or the appearance of the oil. Traditional refinement methods that are commonly used in commercial refinement include degumming, neutralizing, bleaching or deodorizing the oil. Without wishing to be bound by theory, while commercial refinement may be useful for removing impurities from the oil that render the oil fit for human consumption, they are not always affective at removing impurities that are detrimental to subsequent physical and/or chemical modification of the oil. Accordingly, more rigorous refinement methods can be required if further physical and or chemical modifications are desirable. The oil refining techniques/conditions described below have been developed to allow for affective processing of the oils (e.g., by physical and or chemical modification) into compositions that are suitable for use in applications where the compositions are eaten or are applied to edible products (e.g., edible coatings for perishable items such as produce). Many of the techniques/conditions may also be useful in other applications as well.

In some embodiments, the disclosure is directed to a method of refining oil extracted from virgin and/or non-virgin plant matter such that it is suitable for chemical and/or physical modification. In some embodiments, the disclosure is directed to a method of refining crude oil extracted from virgin and/or non-virgin plant matter comprising one or more of clarifying, degumming, neutralizing, bleaching, deodorizing and/or washing the oil with a solvent. In some embodiments, the disclosure is directed to a method of refining crude oil extracted from non-virgin and/or virgin plant matter comprising washing the crude oil with a solvent. In some embodiments, the solvent is water, an alcohol, a hydrocarbon, or a mixture thereof.

Residual impurities that can negatively impact physical or chemical modification of the oils extracted in this disclosure, such as hydrolysis, saponification, hydrogenation, or transesterification, can include diglycerides (e.g., 1,2-diacylglycerides, 1,3-diacylglycerides), monoglycerides (e.g., 1-monoacyglycerides, 2-monoacylglycerides), free fatty acids, phospholipids (e.g., phosphatidic acids, phosphatidylethanolamines, phosphatidylcholines, phosphatidylserines, phosphatidylinositides, among others), proteins, sulfur-containing compounds, phosphorous-containing compounds, nitrogen containing compounds (e.g. alkylamines), saccharides (e.g., monosaccharides, disaccharides, oligosaccharides, polysaccharides), cyanogenic glucosides, phenols and polyphenols, carotenoids, steroids, vitamins, and minerals, among other impurities. These impurities may also impact flavor or refinement.

Accordingly, in some embodiments, after extracting the oil (step 104 in FIG. 1) and prior to chemically or physically modifying the oil (step 108 in FIG. 1), the extracted oil can optionally be refined and/or purified (step 106 in FIG. 1). Without wishing to be bound by theory, the optional refinement and/or purification step is useful for removing these impurities. Accordingly, in some embodiments, the optional refinement and/or purification of the non-virgin and/or virgin oil renders the oil suitable for chemical and/or physical modification. Thus, in some embodiments, the refinement and/or purification steps described herein may be required to enable the subsequent chemical or physical modification of the oil in order to form the final composition.

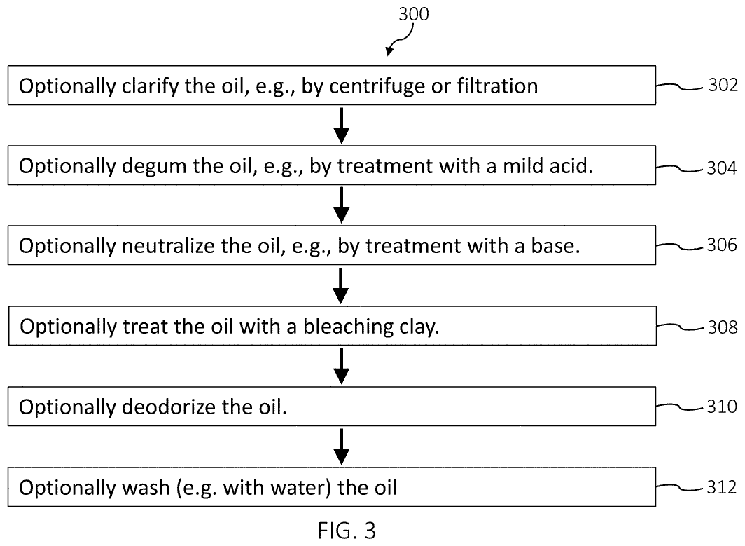

Referring to process 300 in FIG. 3, the optional purification and/or refinement of the extracted oil can, for example, optionally include clarifying the oil by, for example, centrifugation or filtration as in step 302 in FIG. 3. Optionally, the oil can be degummed by, for example, treatment with a mild acid (e.g., phosphoric, citric, among others) as in step 304 in FIG. 3. Optionally, the oil can be neutralized using a base (e.g., NaOH, among others) as in step 306 in FIG. 3. Optionally, the oil can be treated with bleaching clay (e.g., Fuller's earth, bentonite, attapulgite, among others) as in step 308 in FIG. 3. Optionally, the oil can be deodorized by, for example, distillation or steam stripping as in step 310 in FIG. 3. Optionally, the oil can be washed using a solvent (e.g., water, an alcohol, a hydrocarbon such as hexane, or any mixtures thereof), for example, as in step 312 in FIG. 3. Each of the separation steps described herein can be conducted independently or in one or more combinations.

As described above, in some embodiments, the disclosure is directed to a method (e.g., method 300) that can, for example, allow for improved physical or chemical modification of triglycerides in oils obtained (e.g., extracted) from virgin and/or non-virgin seed, bean, nut, kernel, or pulp material, as shown in FIG. 3. First, prior to refining, the oil can optionally be purified, e.g., centrifuged, to form a clarified oil (step 302). Next, the oil can optionally be degummed, for example by treatment with a mild acid such as citric acid (step 304). The acidified oil can then, optionally, be neutralized by treatment with a base such as NaOH (step 306). Degumming and neutralizing of the oil can reduce the levels of phosphorous and free fatty acids in the oil. In some embodiments, the degumming can reduce the phosphorous content below about 250 ppm, below about 200 ppm, below about 150, below about 125 ppm, below about 100 ppm, below about 75 ppm, below about 50 ppm, below about 25 ppm, below about 10 ppm, below about 9 ppm, below about 8 ppm, below about 7 ppm, below about 6 ppm, below about 5 ppm, below about 4 ppm, below about 3 ppm, below about 2 ppm, or below about 1 ppm. In some embodiments, the degumming can afford an oil that is substantially free of phosphorous containing compounds. In some embodiments, the neutralization can reduce the fatty acid contents below about 5%, below about 4%, below about 3%, below about 2%, below about 1%, or below about 0.5%. In some embodiments, the neutralization can afford an oil that is substantially free of free fatty acids. Optionally, the peroxide value of the oil can, for example, be reduced by treating the oil with a bleaching clay (step 308). In some embodiments, refining the oil (e.g., by treating the oil with a bleaching clay) can cause the peroxide value of the oil to drop to below about 20 mEqO₂/kg, below about 15 mEqO₂/kg, below about 10 mEqO₂/kg, below about 8 mEqO₂/kg, below about 6 mEqO₂/kg, below about 5 mEqO₂/kg, below about 4 mEqO₂/kg, below about 3 mEqO₂/kg, below about 2 mEqO₂/kg or below about 1 mEqO₂/kg. In some embodiments, treating the oil with a bleaching clay can afford an oil that is substantially free of peroxides. The oil can optionally be deodorized (step 310) to remove any remaining trace amounts of free fatty acids or other volatile impurities. Finally, the oil can be optionally washed (e.g. with water, and alcohol, a hydrocarbon or a mixture thereof) to remove any additional impurities that can negatively impact physical or chemical modification.

As described above, the optional purification and/or refinement of the extracted oil can, for example, include one or more of clarification, degumming, neutralization, bleaching, deodorization, and/or washing (e.g., with water, an alcohol, a hydrocarbon, or any combination thereof) of the oils or compounds extracted from the oils (FIG. 3). For example, 71 g of clarified pumpkin seed oil was degummed by treatment with 0.268 g of citric acid at 85° C. for 1 hour, after which 1.4 mL of water was added to the solution and the temperature was increased to 95° C. The resulting mixture was left to react for 1 hour. The degummed pumpkin seed oil was then neutralized by treatment with 0.18 g of NaOH in 1.4 mL of water at 95° C. for 30 minutes. The product was then isolated by centrifugation. Subsequently, 31 g of neutralized pumpkin seed oil was bleached by treatment with 0.725 g of bleaching clay and 0.1 wt % water at 115° C. for 30 hours under a vacuum of 50 torr. The bleached oil was then isolated by filtration or centrifugation to afford 19.5 g of bleached oil. In some embodiments, the bleached oil is subsequently washed with a solvent. In some embodiments, the crude oil is washed with a solvent prior to degumming. In some embodiments, the solvent is water, an alcohol, a hydrocarbon, or a mixture thereof.

Additionally, for example, 1.58 g of citric acid was added to 631.7 g of crude grape seed oil and the mixture was heated to 80° C. with stirring for 1 hour, then 12.63 mL of water was added and the temperature was increased to 95° C. for an additional hour. The mixture was then neutralized with 2.85 g of NaOH in 12.6 mL of water, the solution was left stirring for 30 minutes. The solution was then cooled and filtered (or centrifuged) to afford 578.8 g of oil. The degummed and neutralized grape seed oil was determined to have <0.03% free fatty acid and a peroxide value of >50 mEq O₂/kg oil. Subsequently, 7.5 g of bleaching clay was added to 299.8 g of neutralized grape seed oil, and the mixture was heated to 115° C. with stirring for 30 hours under a vacuum of 50 torr. The material was then filtered to afford bleached grape seed oil. The bleached grape seed oil was determined to have <0.03 wt % free fatty acid and a peroxide value of 3.2 mEq O₂/kg oil. Subsequently, 100 g of bleached grape seed oil was deodorized by treating the oil with steam at 225° C. for 2.5 hours, yielding 95.2 g of deodorized oil that was isolated by filtration. In some embodiments, the deodorized oil is further washed with a solvent. In some embodiments, the crude oil is washed with a solvent prior to degumming. In some embodiments, the solvent is water, an alcohol, a hydrocarbon or a mixture thereof.

Each of the refining steps exemplified above can be conducted independently or in one or more combinations to improve the efficacy of subsequent physical or chemical modification of the oil.

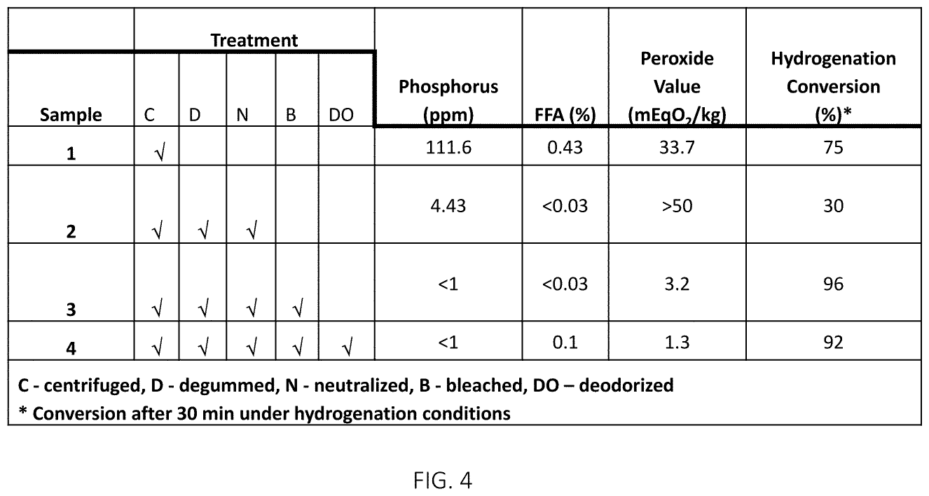

As an example of how oil refining steps can impact physical or chemical modification, FIG. 4 shows the hydrogenation conversion rate of triglycerides in grapeseed oil after 30-minute hydrogenations performed on various samples after each of the steps described above, as well as the phosphorous levels, free fatty acid (FFA) levels, and peroxide values in the oil prior to hydrogenation. For grapeseed oil that was only centrifuged without any other refining (Sample 1), 75% hydrogenation conversion was achieved. For grapeseed oil that was centrifuged and then degummed in citric acid followed by neutralization with NaOH to reduce phosphorous and FFA levels (Sample 2), the percent hydrogenation conversion actually substantially decreased to 30%, even though the degumming/neutralization did substantially decrease both phosphorous levels (from 111.6 ppm to 4.43 ppm) and FFA percentage (from 0.43% to <0.03%). This decrease in hydrogenation conversion percentage is believed to result from the increase in peroxide value from 33.7 mEqO₂/kg prior to degumming/neutralization (Sample 1) to >50 mEqO₂/kg after degumming/neutralization (Sample 2). By performing the same steps as for Sample 2 followed by treatment with a bleaching clay (Sample 3), the phosphorous and FFA levels remained low while the peroxide value dropped to 3.2 mEqO₂/kg, resulting in a hydrogenation conversion percentage of 96%, which was substantially higher than that for Sample 1 or Sample 2. If the grapeseed oil was further deodorized to remove trace FFA and other volatile impurities which can negatively impact the performance of coatings that are subsequently formed from the compositions (Sample 4), the hydrogenation conversion percentage was not substantially impacted, remaining above 90% (e.g., at about 92%).

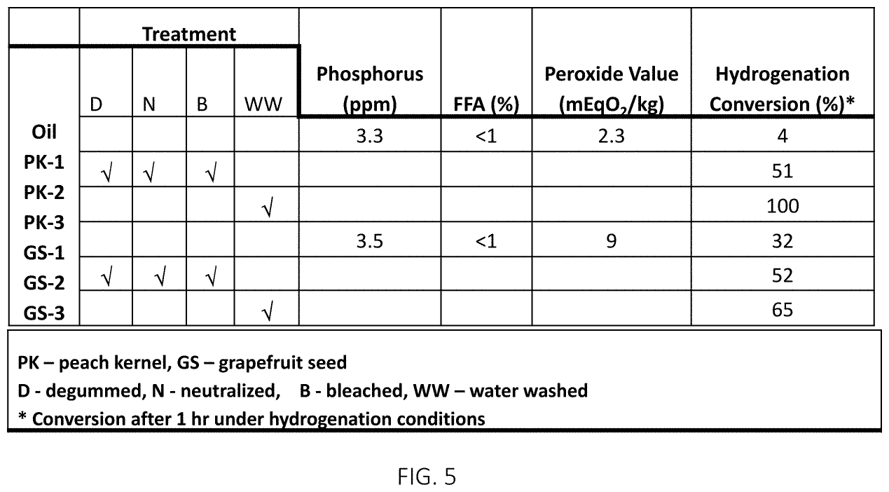

While the processes described above and illustrated in FIG. 4 can be effective for refining non-virgin derived edible oils (e.g., grapeseed oil) in order to provide high yields and other favorable properties in subsequent chemical modification steps, such as hydrogenation, these same refinement processes were found to not yield favorable results when applied to some non-virgin derived non-edible oils, such as those obtained from peach kernel, grapefruit seed, and other non-edible oils. For example, hydrogenation reactions performed for 1 hour on commercially sourced peach kernel oil and grapefruit seed oil yielded extremely low hydrogenation conversion percentages. For example, as shown in FIG. 5, after hydrogenation for 1 hour, only 4% conversion was obtained from commercially sourced peach kernel oil (PK-1) and only 32% conversion was obtained from commercially sourced grapefruit seed oil (GS-1). Performing the refining steps that resulted in >90% hydrogenation conversion for edible oils (degumming, neutralizing, and bleaching as previously described) on the commercially sourced peach kernel oil and grapefruit seed oil only increased the hydrogenation conversion percentage to 51% (PK-2) and 52% (GS-2) respectively, which is not sufficiently high for many applications. Accordingly, many oils (particularly many non-edible oils) can require additional purification and/or refining steps, either in addition to or in place of the ones described above (e.g., degumming, neutralizing, and/or bleaching) in order to allow for sufficiently high yield during subsequent chemical (e.g., hydrogenation) or physical processing. For example, washing the commercially sourced oils with a solvent (e.g., water) in lieu of the other aforementioned refining steps resulted in an improvement in hydrogenation conversion of peach kernel oil and grapefruit seed oil to 100% (PK-3) and 65% (GS-3), respectively.

### Modification of the Oil

The methods according to the disclosure optionally include the modification of oil that has been extracted from virgin and/or non-virgin plant matter or biomass. In some embodiments, the oil is chemically modified and/or physically modified. In some embodiments, the oil is chemically modified. In some embodiments, the oil is physically modified. In some embodiments, the oil is physically modified prior to being chemically modified. In some embodiments, the oil is chemically modified prior to being physically modified. The compositions according to the disclosure are then formed from the resulting compounds, or by adding or mixing the resulting compounds with additional components. The chemical and physical modifications are described in more detail below.

After optionally purifying and/or refining the extracted oil (step 106 in FIG. 1), the oil can optionally be physically modified to obtain compounds that can form or be used in the compositions (step 108 in FIG. 1). Physically modifying the oil can, for example, include one or more of the following processes: (i) crystallization of the triglycerides to separate high melting triglycerides (e.g. triglycerides with saturated fatty acid chains) from low melting triglycerides (e.g. triglycerides with unsaturated fatty acid chains); (ii) positional interchange of fatty acids on the glyceride backbone of mono-, di- or triglycerides (iii) fatty acid interchange (e.g. interesterification) between the fatty acids on the glyceride backbone of mono-, di- or triglycerides and free fatty acids. Each of the physical modification steps exemplified above can be conducted independently or in one or more combinations. Physical modification can be conducted in solution by dissolving the reagents in a solvent. Physical modification can be conducted in the absence of the exogenous addition of a solvent by liquifying the reagents. Physical modification can by conducted in the solid state by mechanical mixing of reagents (e.g. using a ball mill or an equivalent mechanical method).

In one or more embodiments, the oil is physically modified to enrich the content of compounds with saturated fatty acid side chains. In some embodiments, the oil is physically modified by crystallization, winterization, melt fractionalization or any combinations thereof. In some embodiments, the molecules containing the saturated fatty acid side chains of the physically modified oil can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the saturated molecules can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, about 90% to 100% of the mass of the composition. In some embodiments, the iodine value of the composition is less than 10, less than 9, less than 8, less than 7, less than 6, less than 5, less than 4, less than 3, or less than 2. In some embodiments, the molecule containing the saturated fatty acid side chain is one or more monoglycerides, diglycerides, triglycerides, fatty acids, fatty acid esters or fatty acid salts.

Physical modification of the oil can also, for example, include crystallization of the triglycerides to separate high melting triglycerides (e.g. triglycerides with saturated fatty acid chains) from low melting triglycerides (e.g. triglycerides with unsaturated fatty acid chains). For example, 40 g of mango butter (53% saturated fat content) was heated to 70° C. for 30 minutes. The oil was then allowed to cool to 25° C. over 2 hours and held for an additional hour. The material was then filtered to afford 2 g of mango butter (thereof 65% saturated fat content).

Physical modification of the oil can also, for example, include positional interchange of fatty acids on the glyceride backbone of fatty acid glyceryl esters (e.g., mono-, di- or triglycerides).

Physical modification of the oil can, for example, include fatty acid interchange (e.g. interesterification) between the fatty acids on the glyceride backbone of glyceryl esters and free fatty acids. For example, to a 20 mL microwave vial, 10.00 g of canola oil (thereof, 4.1% palmitic acid) and 2.93 g of palmitic acid was added. A stir bar was added to the mixture to ensure efficient mixing, and the vial was heated to 65° C. in a heating block. 190 mg of 4-dodecylbenzenesulfonic acid was added to the stirring vial and quickly capped. After heating for 24 hours, the vial was poured into a stirring mix of 150 mL heptane and 150 mL of 70/30 of IPA/H2O+3 mL of saturated sodium carbonate. The vial was washed out with heptane and the combined mixture transferred to a separatory funnel. The heptane layer was separated, and the aqueous layer was extracted with 150 mL fresh heptane. The combined heptane washes were extracted with 150 mL of 70/30 of IPA/H2O and dried to give the crude triglyceride (thereof, 15.3% palmitic acid).

Alternatively, after purifying and/or refining the extracted oil (step 106 in FIG. 1) to form a first composition, the oil can optionally be chemically modified to obtain compounds that can form or be used in subsequent compositions (step 108 in FIG. 1). Chemically modifying the compositions can, for example, include any of the following processes: (i) hydrogenation of the composition to form saturated compounds; (ii) transesterification of composition with an organic alcohol to form saturated or unsaturated fatty acid esters such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters among others); (iii) hydrolysis of the composition to form saturated or unsaturated free fatty acids; (iv) saponification of the composition to form saturated or unsaturated fatty acid salts; and other processes, for example, glyceroysis, esterification, deprotonation, amidation or combinations of any of the above. In some embodiments, the extracted crude, refined and/or physically modified oil is chemically modified by at least one of hydrogenation, glycerolysis, transesterification, hydrolysis, saponification, esterification, deprotonation, amidation or any combinations thereof.

Each of the chemical modifications of compositions exemplified above can be conducted independently or in one or more combinations. Chemical modification can be conducted in solution by dissolving the reagents and/or any catalysts in a solvent. Chemical modification can also be conducted in the absence of the exogenous addition of a solvent by liquifying the reagents and/or any catalysts. Chemical modification can also be conducted in the solid state by mechanical mixing of reagents and/or any catalysts (e.g. using a ball mill or an equivalent mechanical method). Example combinations of chemical modifications, which are not to be construed as limiting this disclosure in scope or spirit to the specific combinations outlined, are given in the following paragraphs.

In some embodiments, the saturated compounds that result from hydrogenation of the triglycerides in the crude or refined oil extract can be further chemically modified. Further chemical modification of the saturated compounds from hydrogenation can, for example, include one or more of the following processes: (i) transesterification of the hydrogenated triglycerides to form saturated fatty acid esters such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (ii) hydrolysis of the hydrogenated triglycerides to form saturated free fatty acids; (iii) saponification of the hydrogenated triglycerides to form saturated fatty acid salts.

In some embodiments, the saturated fatty acid esters, such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others), resulting from hydrogenation of the triglycerides in the crude or refined oil extract followed by transesterification with an organic alcohol, can be further chemically modified. Such further chemical modifications can, for example, include: (i) transesterification of the saturated fatty acid esters with an organic alcohol to form different saturated fatty acid esters (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (ii) hydrolysis of the saturated fatty acid esters to form the saturated fatty acids; (iii) saponification of the saturated fatty acid esters to form saturated fatty acid salts.

In some embodiments, the saturated fatty acids resulting from hydrogenation of the triglycerides in the crude or refined oil extract followed by hydrolysis, can be further chemically modified. Such further chemical modifications can, for example, include: (i) esterification of the saturated fatty acids with an organic alcohol to form saturated fatty acid esters, such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (ii) deprotonation of the saturated fatty acid with an organic or inorganic base to form saturated fatty acid salts.

In some embodiments, the fatty acid esters resulting from transesterification of the triglycerides can be further chemically modified. Such further chemical modifications of the saturated and unsaturated fatty acid esters from transesterification can, for example, include one or more of the following processes: (i) hydrogenation of the unsaturated fatty acid esters from transesterification to form saturated fatty acid esters such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (ii) hydrolysis of the saturated and unsaturated fatty acid esters to form saturated and unsaturated fatty acids; (iii) saponification of the saturated and unsaturated fatty acid esters to form saturated and unsaturated fatty acid salts.

In some embodiments, the saturated fatty acid esters resulting from transesterification of the triglycerides with an organic alcohol followed by hydrogenation, can be further chemically modified. Such further chemical modifications can, for example, include: (i) transesterification of the saturated fatty acid esters with an organic alcohol to form different saturated fatty acid esters, such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (ii) hydrolysis of the saturated fatty acid esters to form saturated fatty acids; (iii) saponification of the saturated fatty acid to form saturated fatty acid salts.

In some embodiments, the saturated and unsaturated fatty acids resulting from transesterification of the triglycerides with an organic alcohol followed by hydrolysis, can be further chemically modified. Such further chemical modifications can, for example, include: (i) hydrogenation of the unsaturated fatty acids to form saturated fatty acids; (ii) esterification of the saturated and unsaturated fatty acids with an organic alcohol to form saturated and unsaturated fatty acid esters, such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (iii) deprotonation of the saturated and unsaturated fatty acids with an organic or inorganic alcohol to form saturated and unsaturated fatty acid salts.

In some embodiments, the saturated and unsaturated fatty acids resulting from the hydrolysis of triglycerides, can be further chemically modified. Such further chemical modifications can, for example, include: (i) hydrogenation of the unsaturated fatty acids to form saturated fatty acids; (ii) esterification of the saturated and unsaturated fatty acids with an organic alcohol to form saturated and unsaturated fatty acid esters, such as glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others); (iii) deprotonation of the saturated and unsaturated fatty acids with an organic or inorganic alcohol to form saturated and unsaturated fatty acid salts.

Table 2 below gives representative examples of various combinations of chemical modification steps for triglycerides from crude or refined oil extracts. These combinations can, optionally, be further combined before or after with physical modifications. The chemical modification combinations given below are not intended to be limiting in scope, but serve to exemplify combinations that can be used to produce compositions containing saturated and/or unsaturated fatty acids, fatty acid salts, or fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others).

TABLE 2
Representative chemical modifications of triglycerides from crude or refined oil extracts

| Chemical Modification Step | | | Major Product | | |
|---|---|---|---|---|---|
| Step 1 | Step 2 | Step 3 | saturated | unsaturated | product |
| hydrogenation | — | — | X | | triglyceride |
| hydrogenation | transesterification | — | X | | fatty acid ester |
| hydrogenation | transesterification | transesterification | X | | fatty acid ester |
| hydrogenation | transesterification | hydrolysis | X | | fatty acid |
| hydrogenation | transesterification | saponification | X | | fatty acid salt |
| hydrogenation | hydrolysis | — | X | | fatty acid |
| hydrogenation | hydrolysis | esterification | X | | fatty acid ester |
| hydrogenation | hydrolysis | deprotonation | X | | fatty acid salt |
| hydrogenation | saponification | — | X | | fatty acid salt |
| transesterification | — | — | X | X | fatty acid ester |
| transesterification | hydrogenation | — | X | | fatty acid ester |
| transesterification | hydrogenation | transesterification | X | | fatty acid ester |
| transesterification | hydrogenation | hydrolysis | X | | fatty acid |
| transesterification | hydrogenation | saponification | X | | fatty acid salt |
| transesterification | hydrolysis | — | X | X | fatty acid |
| transesterification | hydrolysis | hydrogenation | X | | fatty acid |
| transesterification | hydrolysis | esterification | X | X | fatty acid ester |
| transesterification | hydrolysis | deprotonation | X | X | fatty acid salt |
| transesterification | saponification | — | X | X | fatty acid salt |
| hydrolysis | — | — | X | X | fatty acid |
| hydrolysis | hydrogenation | — | X | | fatty acid |
| hydrolysis | esterification | — | X | X | fatty acid ester |
| hydrolysis | deprotonation | — | X | X | fatty acid salt |
| saponification | — | — | X | X | fatty acid salt |

In some embodiments, physical and/or chemical modification to crude and/or refined virgin and/or non-virgin oil extracts affords triglycerides that are substantially free of unsaturation. For example, 150 mg of a 20 wt % Ni hydrogenation catalyst was added to 30 g of refined grape seed oil. The mixture was then heated to 150° C. under an inert atmosphere in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were then diluted with chloroform and filtered through a plug of Celite. The solvent was then removed by vacuum distillation to afford 30 g of hydrogenated grape seed oil. Additionally, for example, 150 mg of a 20 wt % Ni hydrogenation catalyst was added to 30 g of refined pumpkin seed oil. The mixture was then heated to 150° C. under an inert atmosphere in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were then diluted with chloroform and filtered through a plug of Celite. The solvent was then removed by vacuum distillation to afford 30 g of hydrogenated pumpkin seed oil.

Because the refinement methods of this disclosure result in refined oils that are more amenable to chemical modification (i.e., hydrogenation), the content of saturated molecules (i.e., monoglycerides, diglycerides, triglycerides, fatty acids, fatty acid salts, fatty acid esters) in the oils after hydrogenation is higher than that of the crude or unrefined oil. Table 3 below summarizes the saturated fatty acid (SFA), monounsaturated fatty acid (MUFA) and polyunsaturated fatty acid (PUFA) content of unrefined oil obtained from non-virgin plant matter or biomass. For a more comprehensive list of fatty acid content for a variety of virgin and non-virgin oils, see Dubois, V.; Breton, S.; Linder, M.; Fanni, J.; Parmentier, M., Eur. J. Lipid Sci. Technol. 109 (2007), pp 710-732.

TABLE 3
SFA, MUFA, PUFA Content of Oils

| | | | Grape | Peach |
|---|---|---|---|---|
| | Mango | Pumpkin | seed | kernel |
| | Butter* | seed oil* | oil* | oil** |
| % SFA | 52.8 | 22 | 6.7 | 7.5 |
| % MUFA | 41.3 | 26.1 | 18.4 | 76.5 |
| % PUFA | 7.4 | 51.5 | 65.4 | 16 |

*Data from Dubois, V.; Breton, S.; Linder, M.; Fanni, J.; Parmentier, M., Eur. J. Lipid Sci. Technol. 109 (2007), pp 710-732.
**Data from Chamli, D.; Bootello, M.A.; Bouali, I.; Jouhri, S.; Boukhchina, S.; Martinez-Force, E., Grasas Aceites 68.3 (2017): e211.

In some embodiments, the methods according to this disclosure result in non-virgin oil that is characterized by a saturated molecule (i.e., fatty acid, fatty acid salt or fatty acid ester or any combination thereof) content of greater than 50%. For example, in some embodiments the methods result in non-virgin oils that have a saturated molecule content of greater than 55%, 60%, 65%, 70%, 75%, 80%, 85%, 90%, 95%, 96%, 97%, 98% or 99%.

In one or more embodiments, the compositions that are formed using the methods described herein that contain predominantly saturated triglycerides can be further chemically or physically modified. In one or more embodiments, the compositions that are formed from the methods described herein that contain predominantly saturated triglycerides can be further chemically modified. In one or more embodiments, the compositions that are formed from the methods described herein that contain predominantly saturated triglycerides can be further physically modified. In some embodiments, compositions that are formed from the methods described herein that contain predominantly saturated triglycerides are further modified by saponification. In some embodiments, compositions that are formed from the methods described herein that contain predominantly saturated triglycerides are further modified by glycerolysis. In some embodiments, compositions that are formed from the methods described herein that contain predominantly saturated triglycerides are further modified by hydrolysis. In some embodiments, compositions that are formed from the methods described herein that contain predominantly saturated triglycerides are further modified by transesterification. In some embodiments, compositions that are formed from the methods described herein that contain predominantly saturated triglycerides are further modified by interesterification.

In some embodiments, compositions containing predominantly saturated triglycerides can be further chemically or physically modified. For example, compositions rich in saturated monoglycerides (e.g., 1-monoacylglycerides, 2-monoacylglycerides) and saturated diglycerides (e.g. 1,2-diacylglycerides, 1,3-diacylglycerides) can be produced using the following procedure: 2.5 g of glycerol and 0.022 g of NaOH was added to 10 g of hydrogenated grape seed oil. The mixture was then heated to 240° C. for 1 hour with stirring under a nitrogen atmosphere. The residual glycerol can then be removed to afford 11 g of a composition derived from hydrogenated grapeseed oil comprising 65% monoglyceride, 28% diglyceride, and 7% triglyceride. Compositions rich in saturated fatty acid salts can be produced using the following procedures: 1.34 g of NaOH was added to a solution of 10 g of hydrogenated grape seed oil in 100 mL of ethanol and 100 mL of water and heated to 80° C. The mixture was then heated to 80° C. and stirred for 6 hours. The reaction mixture was then cooled to 55° C. at a rate of 15° C./hr. The resulting slurry is filtered through a hot clay Buchner funnel to afford 7 g of hydrogenated grape seed oil fatty acids salts. Additionally, for example, 5 g of hydrogenated grape seed oil and 0.68 g of NaOH was added to a milling jar with 40 g of milling media. The ball milling apparatus was then set to 650 rpm for 1 hour. The reaction mixture was passed through a 2 micron sieve to remove the milling media and afford 5.2 g of hydrogenated grape seed oil fatty acids salts.

The processes described above are representative methods to physically or chemically modify saturated triglycerides to produce compositions containing fatty acids, fatty acid salts, and fatty acid esters, including glyceryl esters of fatty acids (e.g., 1-monoacylglycerides or 2-monoacylglycerides, 1,2-diacylglycerides, 1,3-diacylglycerides), or alkyl esters thereof (e.g., methyl esters, ethyl esters, propyl esters, butyl esters, pentyl esters, hexyl esters, among others).

In some embodiments, physical or chemical modification of triglycerides affords compositions that are rich in monoglycerides (e.g., 1-monoglycerides, 2-monoglycerides), and diglycerides (e.g., 1,2-diglycerides, 1,3-diglycerides). For example, 2.5 g of glycerol and 0.045 g of NaOH was added to 10 g of refined grape seed oil. The mixture was then heated to 175° C. for 3 hours with stirring under a nitrogen atmosphere. The residual glycerol can then be removed to afford 11 g of a composition derived from grapeseed oil comprising about 60% monoglyceride, 30% diglyceride, and 10% triglyceride. Additionally, for example, 206 g of glycerol and 0.8 g of NaOH was added to 800 g of commercially refined mango butter. The mixture was then heated to 200° C. for 2 hours with stirring under a nitrogen atmosphere. The residual glycerol can then be removed to afford 370 g of composition derived from mango butter comprising about 60% monoglyceride, 30% diglyceride, and 10% triglyceride.

In one or more embodiments, the compositions that are formed from the methods described herein that contain mono- and diglycerides can be further physically or chemically modified. In one or more embodiments, the compositions that are formed from the methods described herein that contain mono- and diglycerides can be further chemically modified. In one or more embodiments, the compositions that are formed from the methods described herein that contain mono- and diglycerides can be further physically modified. In one or more embodiments, the compositions that are formed from the methods described herein that contain mono- and diglycerides can be modified by hydrogenation. In one or more embodiments, the compositions that are formed from the methods described herein that contain mono- and diglycerides can be modified by saponification. In one or more embodiments, the compositions that are formed from the methods described herein that contain mono- and diglycerides can be modified by transesterification. In one or more embodiments, the compositions that are formed from the methods described herein that contain mono- and diglycerides can be modified by crystallization. In one or more embodiments, the compositions that are formed from the methods described herein that contain mono- and diglycerides can be modified by interesterification.

In some embodiments, compositions containing mono- and diglycerides are further physically or chemically modified. For example, compositions rich in saturated monoglycerides (e.g. 1-monoacylglycerides, 2-monoacylglycerides) and diglycerides (e.g. 1,2-diacylglycerides, 1,3-diacylglycerides) can be produced by the following process: 9 g of a composition derived from grapeseed oil comprising about 60% monoglyceride, 30% diglyceride, and 10% triglyceride was dissolved in 30 ml of ethyl acetate and added to a reactor with 150 mg of a 20 wt % Ni hydrogenation catalyst. The mixture was then heated to 150° C. under an inert environment in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were filtered through a plug of Celite and the solvent was removed by vacuum distillation to afford 9 g of saturated composition derived from grape seed oil comprising about 60% monoglyceride, 30% diglyceride, and 10% triglyceride.

In some embodiments, physical or chemical modification of triglycerides extracted from virgin and/or non-virgin plant matter affords compositions that are rich in alkyl esters of fatty acids (e.g., methyl esters, ethyl esters, propyl esters, butyl esters, pentyl esters, hexyl esters, among others). For example, compositions rich in methyl esters can be produced by the following process: 3 mol % K₂CO₃ was added to a solution of 4 g of commercially refined canola oil in 6 equivalents of anhydrous methanol. The solution was stirred at 75° C. for 1 hour, then the solution was concentrated, diluted with water, and extracted 3 times with EtOAc. The combined organics were dried over MgSO₄, filtered and concentrated to afford 3.9 g of canola oil derived methyl esters. Additionally, for example, compositions rich in ethyl esters can be produced by the following process: 25 wt % Cal-B (immobilized on resin) was added to a solution of 3 grams of commercially refined canola oil in 25 equivalents of ethanol. The solution was stirred at 60° C. for 24 hours, filtered and then concentrated. The mixture was diluted with water, and extracted 3 times with EtOAc. The combined organics were dried over MgSO₄, filtered and concentrated to afford 2.85 g of canola oil derived ethyl esters (thereof 95 mol % ethyl ester, 5 mol % monoglyceride).

In some embodiments, formation of alkyl esters of fatty acids from triglycerides can be catalyzed by a base. In some embodiments, the base can be an inorganic base such as, for example, sodium hydroxide, potassium hydroxide, sodium carbonate, or potassium carbonate, among others. In some embodiments, the base can be an organic base such as, for example, 1,5,7-triazabicyclo[4.4.0]dec-5-ene. In some embodiments, the base catalyst can be a heterogeneous catalyst. In some embodiments, the base catalyst can be a homogeneous catalyst. In some embodiments, formation of alkyl esters of fatty acids from triglycerides can be catalyzed by an enzyme. In some embodiments, the enzyme can be a lipase such as, for example, Cal-B, TL-IM, or PPL. In some embodiments, the enzyme can be immobilized on a solid support (e.g. an inorganic support, an organic support).

In some embodiments, physical or chemical modification of triglycerides extracted from virgin and/or non-virgin plant matter affords fatty acids. For example, 100 g of commercially refined mango butter was added to 100 g of water. The mixture was then heated to 250° C. in a pressure vessel (approximately 600 psi) for 1 hour with stirring under a nitrogen atmosphere. The reaction was then allowed to cool to afford 75 g of mango butter free fatty acids. Additionally, for example, 106 g of commercially refined coconut oil was added to 100 g of water. The mixture was then heated to 250° C. in a pressure vessel (approximately 600 psi) for 2 hours with stirring under a nitrogen atmosphere. The reaction was then allowed to cool to afford 100 g of coconut oil fatty acid containing approximately 5 mol % coconut oil monoglyceride.

In some embodiments, the compositions that are formed from the methods described herein that contain fatty acids can be further physically or chemically modified. In some embodiments, the compositions that are formed from the methods described herein that contain fatty acids can be further chemically modified. In some embodiments, the compositions that are formed from the methods described herein that contain fatty acids can be further physically modified. In some embodiments, the compositions that are formed from the methods described herein that contain fatty acids can be modified by hydrogenation. In some embodiments, the compositions that are formed from the methods described herein that contain fatty acids can be modified by glycerolysis. In some embodiments, the compositions that are formed from the methods described herein that contain fatty acids can be modified by saponification. In some embodiments, the compositions that are formed from the methods described herein that contain fatty acids can be modified by transesterification. In some embodiments, the compositions that are formed from the methods described herein that contain fatty acids can be modified by interesterification.

In some embodiments, compositions resulting from the methods described herein that contain fatty acids are further physically or chemically modified. For example, compositions rich in saturated fatty acids can be produced from the corresponding unsaturated fatty acid by the following illustrative method: 0.5 mol % Ni hydrogenation catalyst was added to 1 gram of linoleic acid in in 30 mL of cyclohexane in a pressure vessel. The solution was stirred at 1200 rpm, heated to 140° C. and pressurized to 160 psi of hydrogen. After 3.5 hours, a sample was taken and there was determined to be a 41% reduction in unsaturation. Additionally, for example, 0.5 mol % Ni hydrogenation catalyst was added to 1 gram of oleic acid in in 30 mL of cyclohexane in a pressure vessel was added. The solution was stirred at 1200 rpm, heated to 140° C. and pressurized to 160 psi of hydrogen. After 3.5 hours, a sample was taken and there was determined to be a 97% reduction in unsaturation. Compositions rich in mono- and diglycerides can be produced from the corresponding fatty acid using, for example, the following methods: Oleic Acid (700 g) and glycerol (912 g) were combined in a 2 neck round bottom flask with a stir bar fitted with a distillation head to collect water liberated during the reaction. The flask was sparged with nitrogen, stirred and heated to 220° C. for 12 hours. The reaction mixture was allowed to cool to room temperature, and the glycerol was removed via liquid/liquid separation with water and EtOAc. The organic layer was washed with brine, dried over MgSO₄, and concentrated to a composition rich in mono- and diglycerides of oleic acid (thereof 62 mol % monoglyceride, 34 mol % diglyceride, 3 mol % triglyceride, and 1% free fatty acid). Additionally, for example, 300 g of capric acid and 5 equivalents of glycerol were stirred at 230° C. for 3 hours. The mixture was cooled and the glycerol layer was separated to afford 305 g of a composition rich in mono- and diglycerides (thereof 88 mol % monoglyceride, 10 mol % diglyceride, and 2 mol % glycerol). Compositions rich in triglycerides can be produced from the corresponding fatty acids using, for example, the following method: to 180 g of capric acid and 0.3 equivalents of glycerol at 60° C. was added 10 wt % CAL-B (immobilized on resin). The solution was held under vacuum (20 torr) at 60° C. with continuous removal of water for 24 hours to afford a composition rich in triglyceride (thereof >95% triglyceride). Compositions rich in fatty acid salts can be produced from the corresponding fatty acid using, for example, the following method: a 50 mL ZrO₂ milling jar was charged with 1 g of stearic acid, powdered NaOH (1.05 equiv), and ZrO₂ milling beads (40 g, 3 mm). The mixture was milled at 650 rpm for 1 hr in a Retsch CM 200 planetary ball mill. The resulting mixture was extracted with hot methanol (50 mL). The solids were removed via filtration over Celite and the filtrate was concentrated under reduced pressure to afford 925 mg of a sodium stearate.

### Purification and Separation

In one or more embodiments, the methods of the disclosure optionally include purification and/or separation processes of the extracted crude, refined, chemically modified and/or physically modified oil. In some embodiments, the oil is purified and/or separated after extraction. In some embodiments, the oil is purified and/or separated after refinement. In some embodiments, the oil is purified and/or separated after chemical modification. In some embodiments, the oil is purified and/or separated after physical modification. In a preferred embodiment, the oil is purified and/or separated after physical and/or chemical modification.

In some embodiments, physical and chemical modification(s) can serve to aid or simplify the separation and/or purification process. In some embodiments, the physical or chemical modification(s) can change the physical properties of the composition or components of the composition, such as solubility in solvent(s), partition coefficient (i.e. the distribution of components of the composition between two or more immiscible phases), melting point, and/or boiling point. In some embodiments, the changes to the physical properties of the composition or components of the composition can serve to aid separation of individual components within the composition. Separations and/or purifications after chemical modification(s) can aid in the isolation from the composition of one or more preferred component(s) of substantial purity that can be utilized on their own, or in combination with one or more other preferred component(s). Preferred components can be saturated and/or unsaturated fatty acids, fatty acid salts, or fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others). Separation and/or purification can produce one or more preferred component(s) of substantial purity. In some embodiments, preferred components can be at least about 50% pure by mass percent or mole percent, at least about 55% pure by mass percent or mole percent, at least about 60% pure by mass percent or mole percent, at least about 65% pure by mass percent or mole percent, at least about 70% pure by mass percent or mole percent, at least about 75% pure by mass percent or mole percent, at least about 80% pure by mass percent or mole percent, at least about 85% pure by mass percent or mole percent, at least about 90% pure by mass percent or mole percent, or at least about 99% pure by mass percent or mole percent. In some embodiments, the purity of the preferred components can be in the range of about 50% to 100% pure by mass percent or mole percent, about 55% to 100% by mass percent or mole percent, about 60% to 100% by mass percent or mole percent, about 65% to 100% by mass percent or mole percent, about 70% to 100% by mass percent or mole percent, about 75% to 100% by mass percent or mole percent, about 80% to 100% by mass percent or mole percent, about 85% to 100% by mass percent or mole percent, about 90% to 100% by mass percent or mole percent, or about 95% to 100% by mass percent or mole percent.

In some embodiments, the physical or chemical modification(s) can serve to change the solubility or dispersibility of the composition, or components of the composition, in one or more solvents. Solvents can include water, alcoholic solvents (e.g. methanol, ethanol, isopropanol, among others), ethers (e.g. diethyl ether, tetrahydrofuran, methyl tert-butyl ether, among others), esters (e.g. methyl acetate, ethyl acetate, among others), or other organic solvents (e.g. acetone, methyl ethyl ketone, dichloromethane, dichloroethane, chloroform, acetonitrile, among others). In some embodiments, the concentration of the composition in one or more solvents is less than about 50 g/L, is less than about 100 g/L, is less than about 150 g/L, is less than about 200 g/L, is less than about 250 g/L, is less than about 300 g/L, or is less than about 350 g/L. In some embodiments, the concentration of the composition in one or more solvents is from about 50 g/L to about 150 g/L, from about 100 g/L to about 200 g/L, from about 150 g/L to about 250 g/L, from about from about 200 g/L to about 300 g/L, from about 250 g/L to about 350 g/L, or from about 50 g/L to about 350 g/L. In some embodiments, a solvent can be added to the composition dissolved or dispersed in a different solvent in order to modulate the solubility of the composition, or components within the composition. In some embodiments, the addition of a solvent to a composition dissolved in a different solvent can increase the solubility of the composition, or components within the composition. In some embodiments, the addition of a solvent to a composition dissolved in a different solvent can decrease the solubility of the composition, or components within the composition. In some embodiments, the change in solubility or dispersibility of the composition, or components of the compositions, can aid in purification of the composition, or individual components of the composition, by removing residual impurities from the crude oil or various chemical modification steps. In some embodiments, the change in solubility or dispersibility can aid in the separation of individual components within the composition from other components within the composition.

The solubility of the composition, or components within the composition can also change as a function of temperature. In some embodiments, the temperature of the solution or dispersion can be changed to modulate the solubility of the composition, or individual components of the composition. By holding the solution or dispersion at a specific temperature, or by modulating the temperature within a specific range, preferred components of the composition can be separated from non-preferred components, due to the differences in solubility at a given temperature, or range of temperatures, between preferred and non-preferred components of a composition. In some embodiments, preferred components can be saturated and/or unsaturated fatty acids, fatty acid salts, or fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others). In some embodiments, non-preferred components can be residual impurities from the crude oil or from various chemical modification steps. In some embodiments, the selected temperature or range of temperatures can increase the concentration of the preferred components of the composition in the solution or dispersion relative to the non-preferred components. In some embodiments, the selected temperature or range of temperatures can decrease the concentration of the preferred components of the composition in the solution or dispersion relative to the non-preferred components. In some embodiments, the preferred temperature is about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., and about 100° C. In some embodiments, the preferred temperature range is from about 0° C. to about 40° C., from about 10° C. to about 50° C., from about 20° C. to about 60° C., from about 30° C. to about 70° C., from about 40° C. to about 80° C., from about 50° C. to about 90° C., from about 60° C. to about 100° C., about 20° C. to about 40° C., from about 30° C. to about 50° C., from about 40° C. to about 60° C., from about 50° C. to about 70° C., and from about 60° C. to about 80° C.

In some embodiments, saturated glyceryl esters of fatty acids (e.g., saturated 1-monoacylglycerides, saturated 2-monoacylglycerides, saturated 1,2-diacylglycerides, saturated 1,3-diacylglycerides, or saturated triacylglycerides), are separated from other non-preferred components of the composition. For example, to 25 g of 1-monoglycerides from mango butter (thereof, 54% saturated monoglycerides) was added 100 mL of anhydrous ethanol. The mixture was heated to 70° C. with stirring and held constant for 30 minutes. The material was then allowed to cool to 18° C. over 1 hour. The resultant slurry was then filtered to isolate 9.4 g of purified monoglycerides from mango butter (thereof 82% saturated monoglycerides). Additionally, for example, to 600 g of saturated glyceryl esters of fatty acids (thereof 33% diacylglycerides) was added anhydrous ethanol at 200 g/L. The solution was heated to 80° C. with stirring and held constant for 30 minutes. The material was then allowed to cool to 30° C. over 1 hour and the resultant slurry was filtered. To the filtered material was added anhydrous ethanol at 200 g/L. The solution was again heated to 80° C. with stirring and held constant for 30 minutes. The material was then allowed to cool to 30° C. over 1 hour and the resultant slurry was filtered. To the filtered material was added hexanes at 130 g/L. The solution was heated 60° C. with stirring and held constant for 30 minutes. The material was then allowed to cool to 40° C. over 1 hour and the resultant slurry was filtered to afford a composition of saturated glyceryl esters of fatty acids (thereof 95% diacylglycerides).

In some embodiments, physical and/or chemical modification(s) can change the partition coefficient (i.e. the relative distribution of a molecule between two or more immiscible phases) of individual components of the composition. In some embodiments, the two or more immiscible phases can include the composition. Solvents can include water (e.g. at a pH ranging from, for example, 2 to 12), alcoholic solvents (e.g. methanol, ethanol, isopropanol, among others), ethers (e.g. diethyl ether, tetrahydrofuran, methyl tert-butyl ether, among others), esters (e.g. methyl acetate, ethyl acetate, among others), or other organic solvents (e.g. acetone, methyl ethyl ketone, dichloromethane, dichloroethane, chloroform, acetonitrile, among others). By dissolving or dispersing individual components of the composition between two or more immiscible phases, preferred components of the composition can be separated from non-preferred components due to the difference in the partition coefficient of preferred and non-preferred components of a composition. In some embodiments, preferred components can be saturated and/or unsaturated fatty acids, fatty acid salts, or fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others). In some embodiments, non-preferred components can be residual impurities from the crude oil or from various chemical modification steps.

In some embodiments, physical and/or chemical modification(s) can change the melting point of the composition or individual components of the composition. By holding the composition at a specific temperature, or by modulating the temperature within a specific range, preferred components of the composition can be separated from non-preferred components due to the difference in melting point between preferred and non-preferred components of a composition. In some embodiments, non-preferred components of a composition can be fatty acid esters such as glyceryl esters of fatty acids (e.g., 1-monoacylglycerides or 2-monoacylglycerides, 1,2-diacylglycerides, 1,3-diacylglycerides, triglycerides), or alkyl esters thereof (e.g., methyl esters, ethyl esters, propyl esters, butyl esters, pentyl esters, hexyl esters, among others). In some embodiments, non-preferred components can be residual impurities from the crude oil or from various chemical modification steps. In some embodiments, the selected temperature or range of temperatures can increase the ratio of the preferred components of the composition in the liquid phase relative to the non-preferred components. In some embodiments, the selected temperature or range of temperatures can decrease the ratio of the preferred components of the composition in the solution or dispersion relative to the non-preferred components. In some embodiments, the preferred temperature is about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., and about 100° C. In some embodiments, the preferred temperature range is from about 0° C. to about 40° C., from about 10° C. to about 50° C., from about 20° C. to about 60° C., from about 30° C. to about 70° C., from about 40° C. to about 80° C., from about 50° C. to about 90° C., from about 60° C. to about 100° C., about 20° C. to about 40° C., from about 30° C. to about 50° C., from about 40° C. to about 60° C., from about 50° C. to about 70° C., and from about 60° C. to about 80° C. In some embodiments, the difference in melting point between preferred and non-preferred components is not less than about 10° C., not less than about 15° C., not less than about 20° C., not less than about 25° C., not less than about 30° C., not less than about 35° C., not less than about 40° C., not less than about 45° C., not less than about 50° C., not less than about 60° C., not less than about 70° C., not less than about 80° C., not less than about 90° C., or not less than about 100° C.

In some embodiments, saturated glyceryl esters of fatty acids (e.g., saturated 1-monoacylglycerides, saturated 2-monoacylglycerides, saturated 1,2-diacylglycerides, saturated 1,3-diacylglycerides, or saturated triacylglycerides), are separated from other non-preferred components of the composition after chemical and/or physical modification of the extracted and/or refined oil. For example, 30 g of composition of glyceryl esters derived from mango butter (thereof 85% monoglycerides and an iodine value of 35), was heated to 80° C. with stirring until the material was fully liquified. The material was then allowed to cool to 60° C., and to the mixture was added 0.5 wt % of pure glycerol monostearate. The material was stirred for 16 hours and then filtered. The filtered material was again heated to 80° C. with stirring until the material was fully liquified. The material was then allowed to cool to 67° C., and to the mixture was added 0.5 wt % of pure glycerol monostearate. The material was stirred for 16 hours and then filtered to afford a purified composition of glycerides from mango butter (thereof >95% monoglycerides and an iodine value of 14).

In some embodiments, saturated glyceryl esters of fatty acids (e.g., saturated 1-monoacylglycerides, saturated 2-monoacylglycerides, saturated 1,2-diacylglycerides, saturated 1,3-diacylglycerides, or saturated triacylglycerides), are separated from other non-preferred components of the composition before chemical and/or physical modification of the extracted and/or refined oil.

In some embodiments, physical and/or chemical modification(s) can change the boiling point of the composition or individual components of the composition. By holding the composition at a specific temperature and/or pressure, or by modulating the temperature and/or pressure within a specific range, preferred components of the composition can be separated from non-preferred components due to the difference in boiling point between preferred and non-preferred components of a composition. In some embodiments, non-preferred components of a composition can be fatty acid esters such as glyceryl esters of fatty acids (e.g., 1-monoacylglycerides or 2-monoacylglycerides, 1,2-diacylglycerides, 1,3-diacylglycerides, triglycerides), or alkyl esters thereof (e.g., methyl esters, ethyl esters, propyl esters, butyl esters, pentyl esters, hexyl esters, among others). In some embodiments, non-preferred components can be residual impurities from the crude oil or from various chemical modification steps. In some embodiments, the distillation removes residual glycerol or sodium hydroxide from the composition. In some embodiments, purification based on boiling point can afford a composition of preferred components that is at least about 50% pure by mass percent or mole percent, at least about 55% pure by mass percent or mole percent, at least about 60% pure by mass percent or mole percent, at least about 65% pure by mass percent or mole percent, at least about 70% pure by mass percent or mole percent, at least about 75% pure by mass percent or mole percent, at least about 80% pure by mass percent or mole percent, at least about 85% pure by mass percent or mole percent, at least about 90% pure by mass percent or mole percent, or at least about 99% pure by mass percent or mole percent. In some embodiments, purification based on boiling point can afford a composition of preferred components in the range of about 50% to 100% pure by mass percent or mole percent, about 55% to 100% by mass percent or mole percent, about 60% to 100% by mass percent or mole percent, about 65% to 100% by mass percent or mole percent, about 70% to 100% by mass percent or mole percent, about 75% to 100% by mass percent or mole percent, about 80% to 100% by mass percent or mole percent, about 85% to 100% by mass percent or mole percent, about 90% to 100% by mass percent or mole percent, or about 95% to 100% by mass percent or mole percent.

The processes described above are representative methods to separate and/or purify preferred components of a composition from non-preferred components after physically and/or chemically modifying triglycerides to produce compositions containing fatty acids, fatty acid salts, and fatty acid esters, including glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others). In some embodiments, the separation and/or purification method(s) can produce compositions that are substantially free of unsaturated molecules (e.g. unsaturated fatty acids, unsaturated fatty acid salts, unsaturated fatty acid esters). In some embodiments, the saturated molecules can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the saturated molecules can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, about 90% to 100% of the mass of the composition. In some embodiments, the iodine value of the composition is less than 10, less than 9, less than 8, less than 7, less than 6, less than 5, less than 4, less than 3, or less than 2. In some embodiments, the composition can be substantially free of fatty acids, fatty acid salts, or fatty acid esters containing trans-double bonds (i.e. trans fats).

In some embodiments, the separation and/or purification method(s) can produce compositions that are substantially free of saturated molecules (e.g. saturated fatty acids, saturated fatty acid salts, saturated fatty acid esters). In some embodiments, the unsaturated molecules can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the unsaturated molecules can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition.

### Compositions of the Disclosure

The methods according to this disclosure are useful for the modification of oils comprising triglycerides (i.e., a compound of Formula I) that have been extracted from virgin and or non-virgin plant matter to form a composition, where Formula I is:

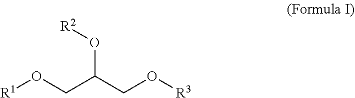

wherein:

R¹, R², and R³ are each independently at each occurrence fragments of Formula II, where Formula II is:

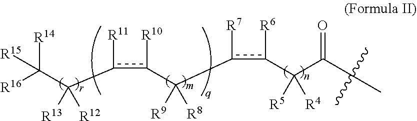

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the compounds in the compositions that are formed from the triglycerides (e.g., the compounds of Formula I) via the methods described herein can include one or more of the following fragments of Formula II:

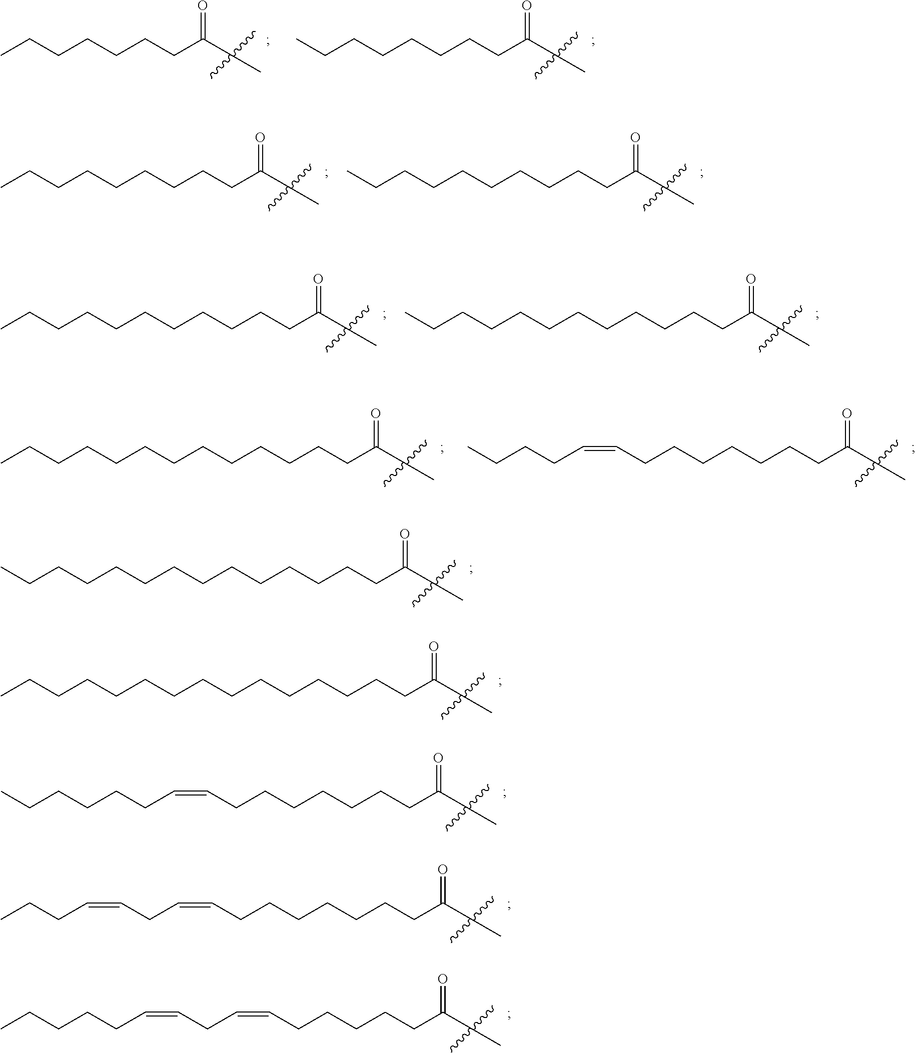

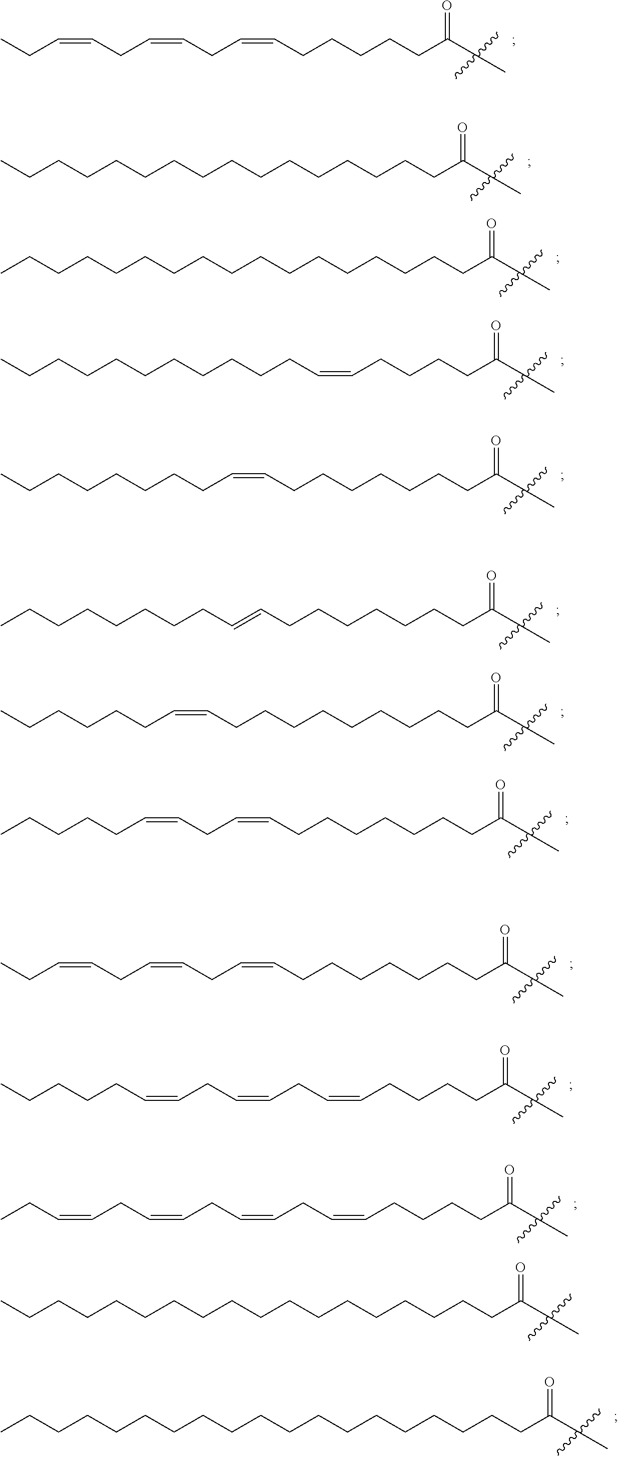

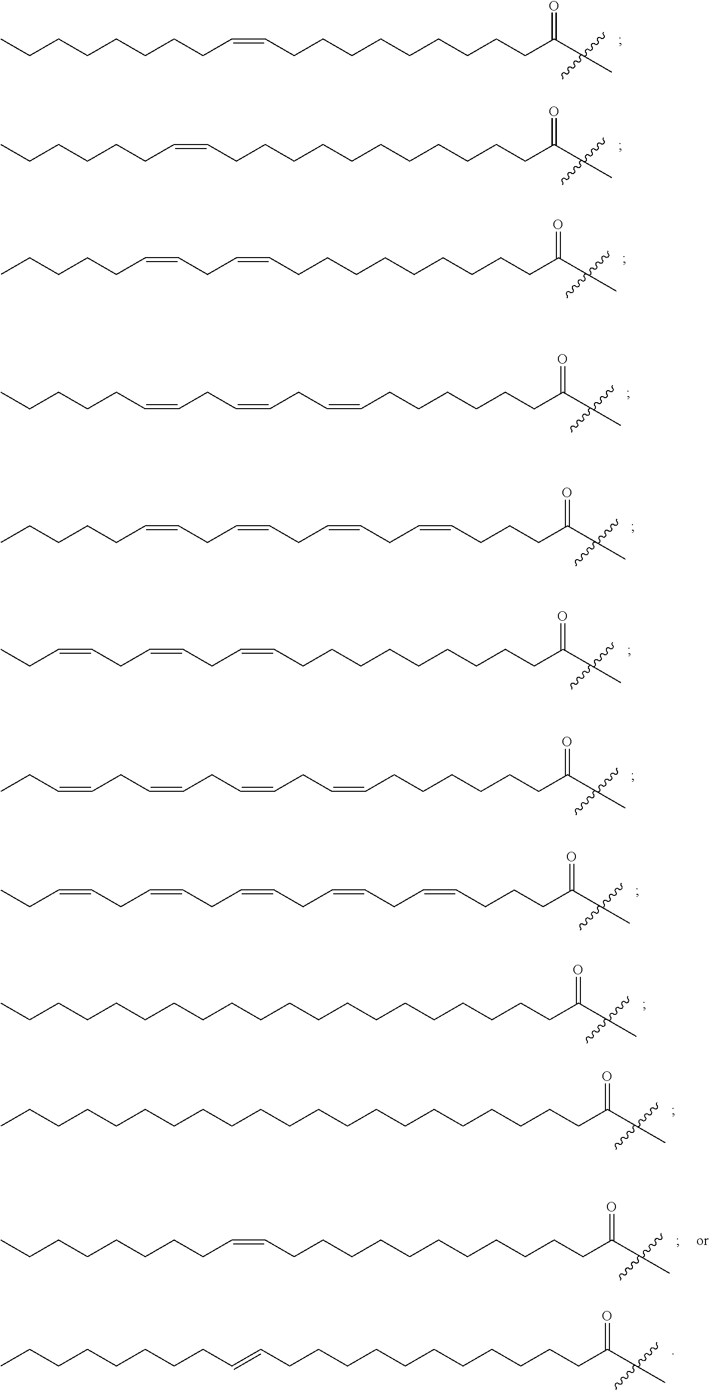

In one or more embodiments, the compositions that are formed from the methods described herein comprise triglycerides that are substantially free of unsaturation. In some embodiments, the saturated triglycerides can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the saturated triglycerides can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, about 90% to 100% of the mass of the composition. In some embodiments, the iodine value of the composition is less than 10, less than 9, less than 8, less than 7, less than 6, less than 5, less than 4, less than 3, or less than 2.

In some embodiments, the triglyceride content of the compositions that are formed from the methods described herein can be less than about 15% of the composition, less than about 14% of the composition, less than about 13% of the composition, less than about 12% of the composition, less than about 11% of the composition, less than about 10% of the composition, less than about 9% of the composition, less than about 8% of the composition, less than about 7% of the composition, less than about 6% of the composition, less than about 5% of the composition, less than about 4% of the composition, less than about 2% of the composition, or less than about 1% of the composition. In some embodiments, the composition can be substantially free of triglycerides.

The compounds in the compositions that are formed from the triglycerides (e.g., the compounds of Formula I) via the methods described herein can optionally include fatty acids. Accordingly, the compounds in the compositions that are formed from the triglycerides (e.g., the compounds of Formula I) via the methods described herein can optionally include one or more compounds of Formula III, where Formula III is:

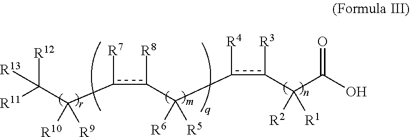

wherein:

R¹, R², R⁵, R⁶, R⁹, R¹⁰, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

The compositions that are formed from the triglycerides (e.g., the compounds of Formula I) via the methods described herein can optionally include one or more of the following fatty acid compounds (e.g., compounds of Formula III):

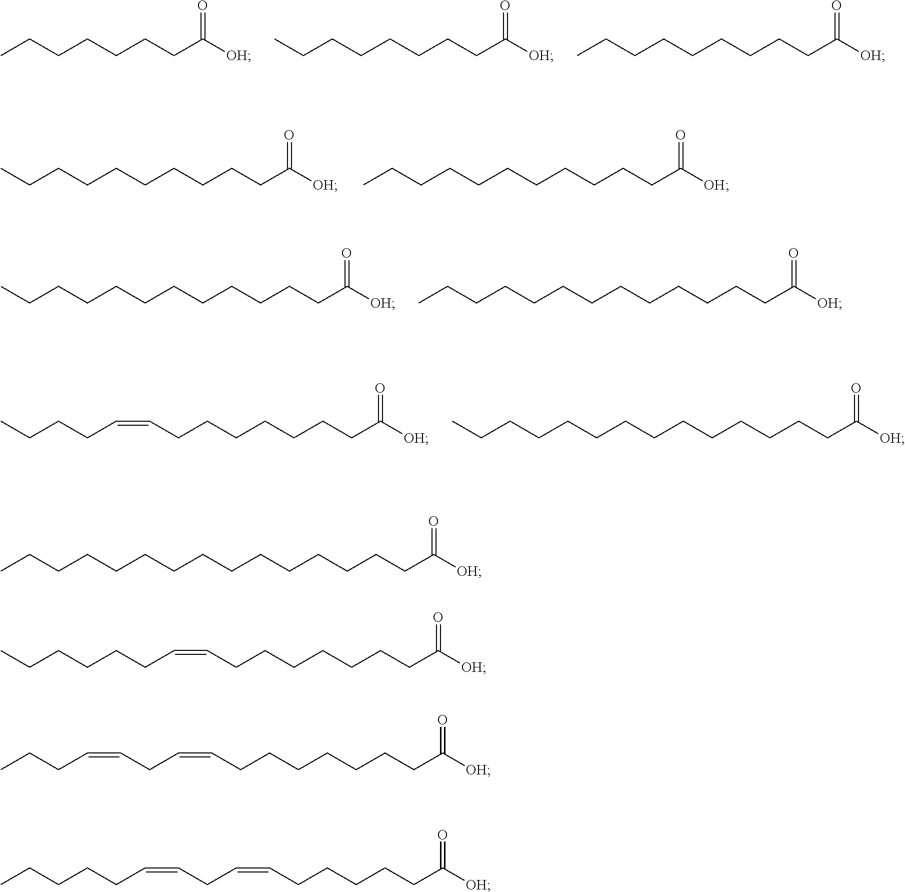

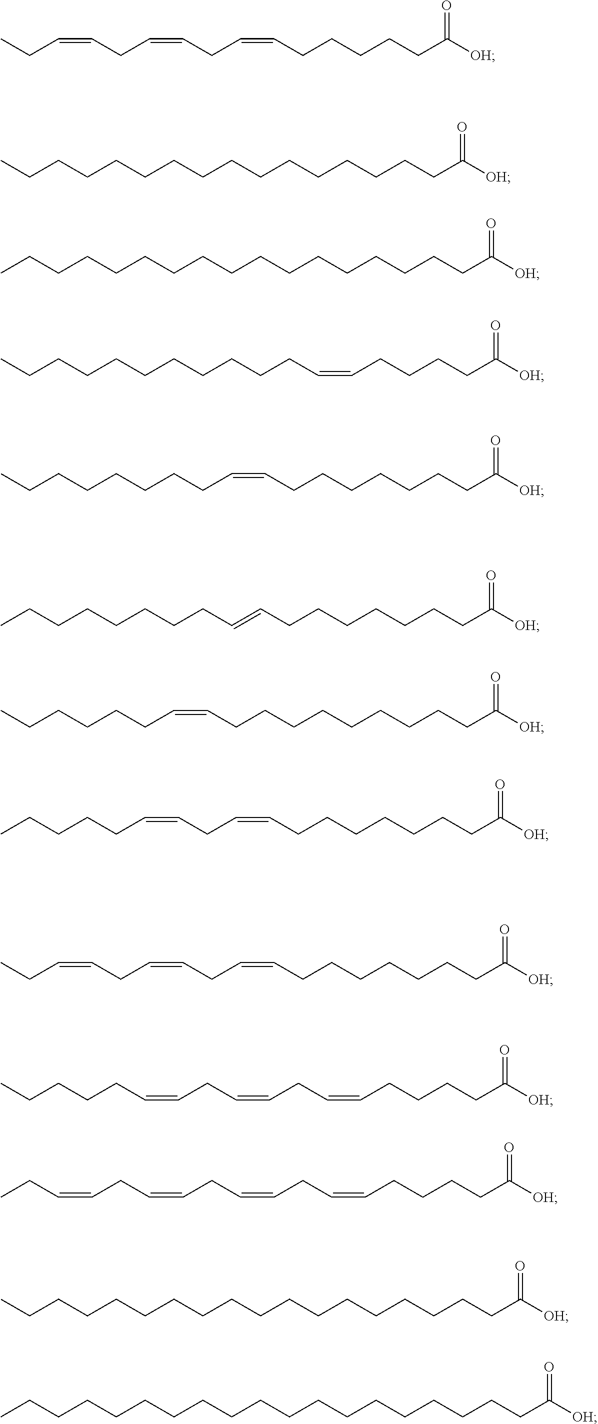

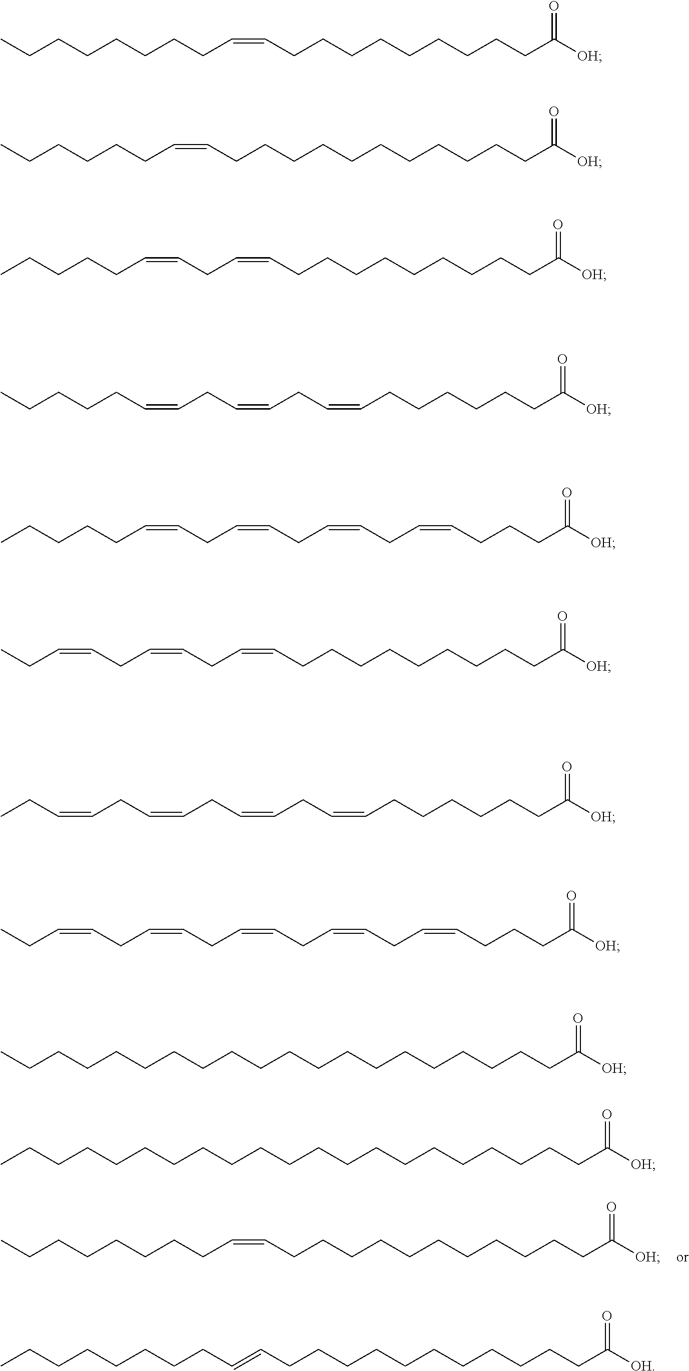

In some embodiments, the compositions can be rich in fatty acids (e.g. saturated and unsaturated fatty acids). In some embodiments, the fatty acid content can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the fatty acid content can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition.

The compositions that are formed from the triglycerides (e.g., the compounds of Formula I) via the methods described herein can optionally include fatty acid salts. Accordingly, the compounds in the compositions that are formed from the triglycerides (e.g., the compounds of Formula I) via the methods described herein can optionally include one or more compounds of Formula IV, where Formula IV is:

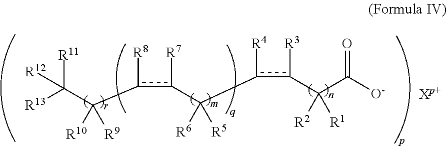

wherein:

R¹, R², R⁵, R⁶, R⁹, R¹⁰, R¹¹, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8; and

X^{p+} is a cationic counter ion having a charge state p, and p is 1, 2, or 3.

The compounds in the compositions that are formed from the triglycerides (e.g., the compounds of Formula I) via the methods described herein can optionally include one or more of the following fatty acid salt compounds such as sodium salts, potassium salts, calcium salts, or magnesium salts (e.g., compounds of Formula IV) wherein X^{p+} is Na⁺, K⁺, Ca²⁺, or Mg²⁺:

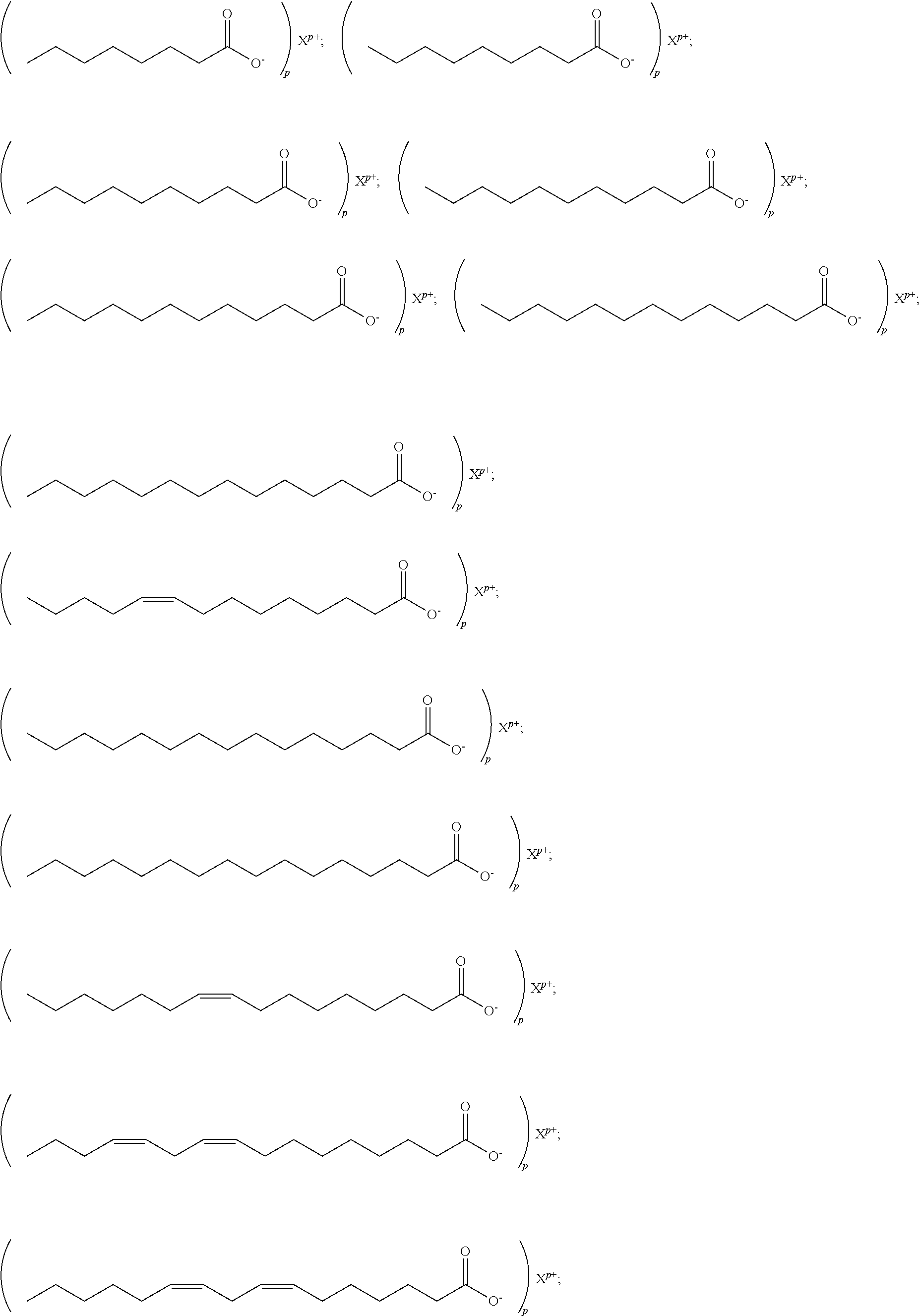

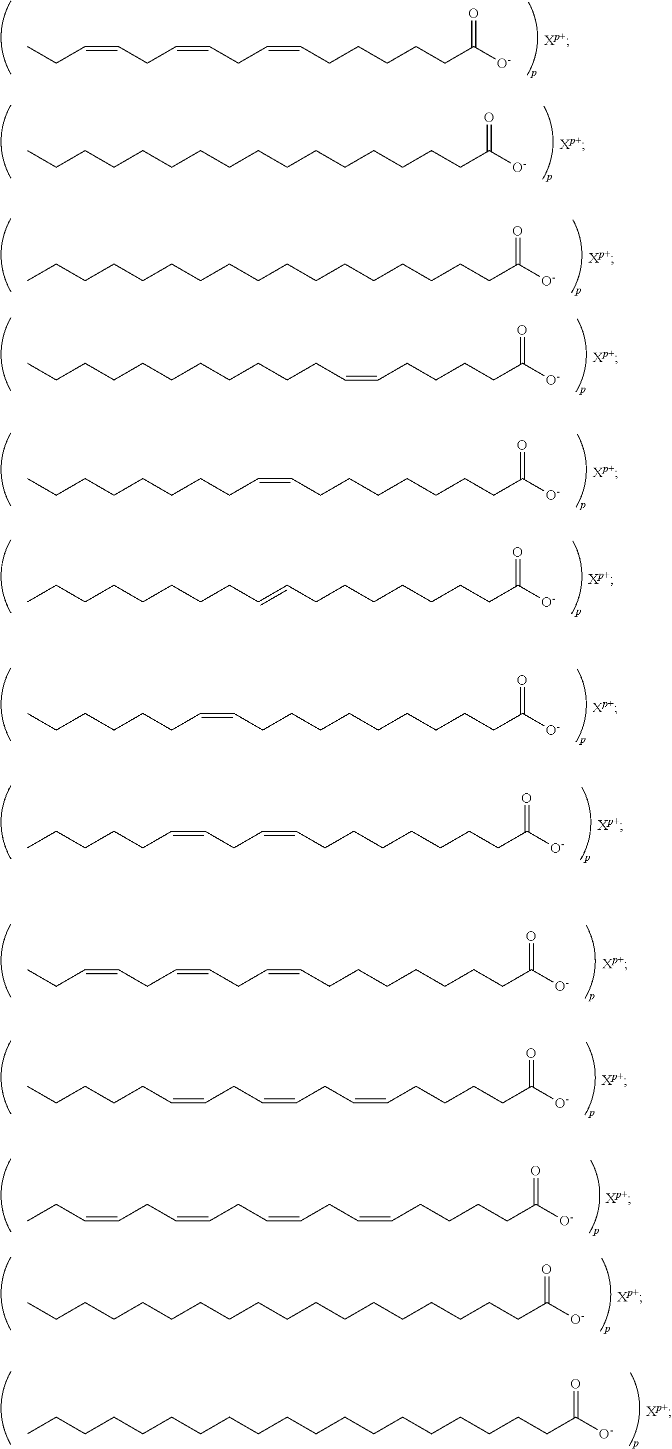

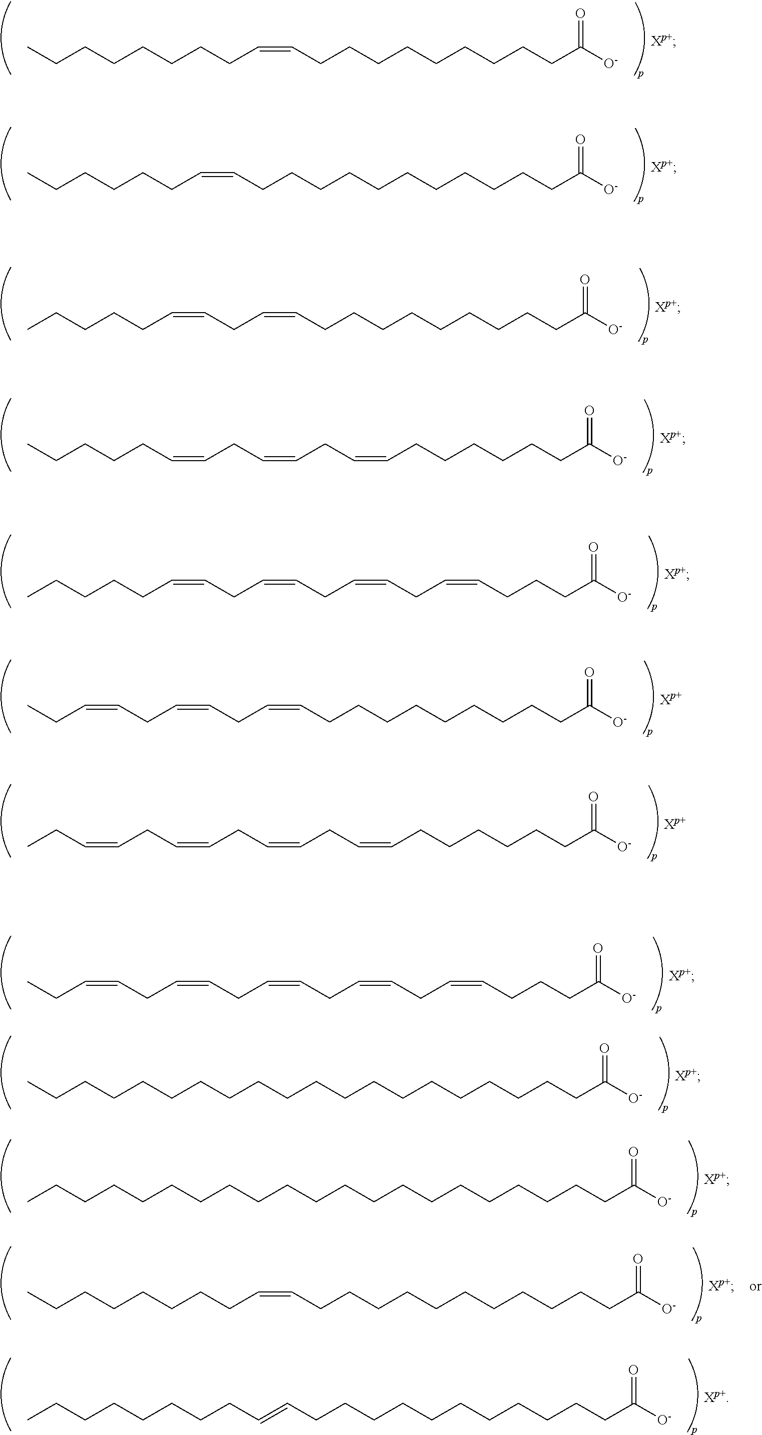

In some embodiments, the fatty acid salts can be sodium salts, potassium salts, calcium salts, or magnesium salts. In some embodiments the cationic counter ion can have a charge state of +1, can have a charge state +2, or can have a charge state of +3.

In some embodiments, the compositions can be rich in fatty acid salts (e.g. saturated fatty acid salts, unsaturated fatty acid salts). In some embodiments, the fatty acid salts can be at least about 30% of the mass of the composition, at least about 35% of the mass of the composition, at least about 40% of the mass of the composition, at least about 45% of the mass of the composition, at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the fatty acid salts can be about 30% to 100% of the mass of the composition, about 30% to 99% of the mass of the composition, about 30% to 95% of the mass of the composition, about 30% to 90% of the mass of the composition, about 30% to 85% of the mass of the composition, about 30% to 80% of the mass of the composition, about 30% to 75% of the mass of the composition, about 30% to 70% of the mass of the composition, about 30% to 65% of the mass of the composition, about 30% to 60% of the mass of the composition, about 30% to 55% of the mass of the composition, about 35% to 60% of the mass of the composition, about 40% to 65% of the mass of the composition, about 45% to 70% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition.

In some embodiments, the fatty acid salts (e.g. saturated fatty acid salts, unsaturated fatty acid salts) can be less than about 30% of the mass of the composition, less than about 25% of the mass of the composition, less than about 20% of the mass of the composition, less than about 15% of the mass of the composition, less than about 10% of the mass of the composition, less than about 9% of the mass of the composition, less than about 8% of the mass of the composition, less than about 7% of the mass of the composition, less than about 6% of the mass of the composition, less than about 5% of the mass of the composition, less than about 4% of the mass of the composition, less than about 3% of the mass of the composition, less than about 2% of the mass of the composition, or less than about 1% of the mass of the composition. In some embodiments, the compositions can be substantially free of fatty acid salts. In some embodiments, the fatty acid salts can be about 1% to about 30% of the mass of the composition, about 1% to about 25% of the mass of the composition, about 1% to about 20% of the mass of the composition, about 1% to about 15% of the mass of the composition, about 1% to about 10% of the mass of the composition, or about 1% to about 6% of the mass of the composition.

The compositions that are formed from the triglycerides (e.g., the compounds of Formula I) via the methods described herein can optionally include 1-monoacylglycerides. Accordingly, the compounds in the compositions that are formed from the triglycerides (e.g., the compounds of Formula I) via the methods described herein can optionally include one or more compounds of Formula V, where Formula V is:

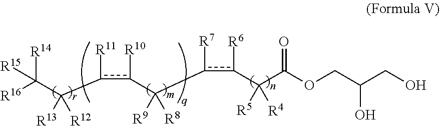

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the compounds in the compositions that are formed from the triglycerides (e.g., the compounds of Formula I) via the methods described herein can optionally include one or more of the following 1-monoglycerides (e.g. compounds of Formula V)

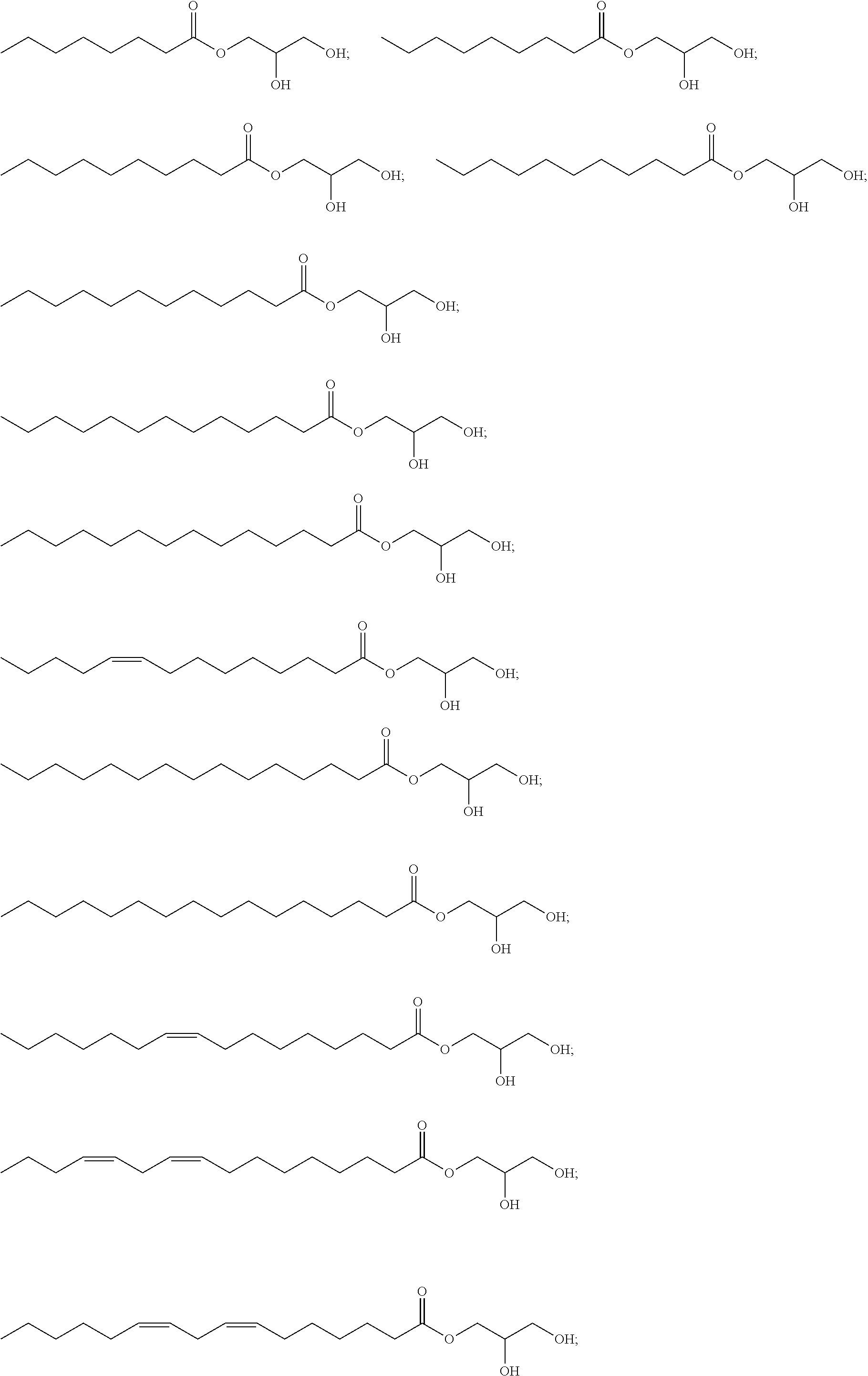

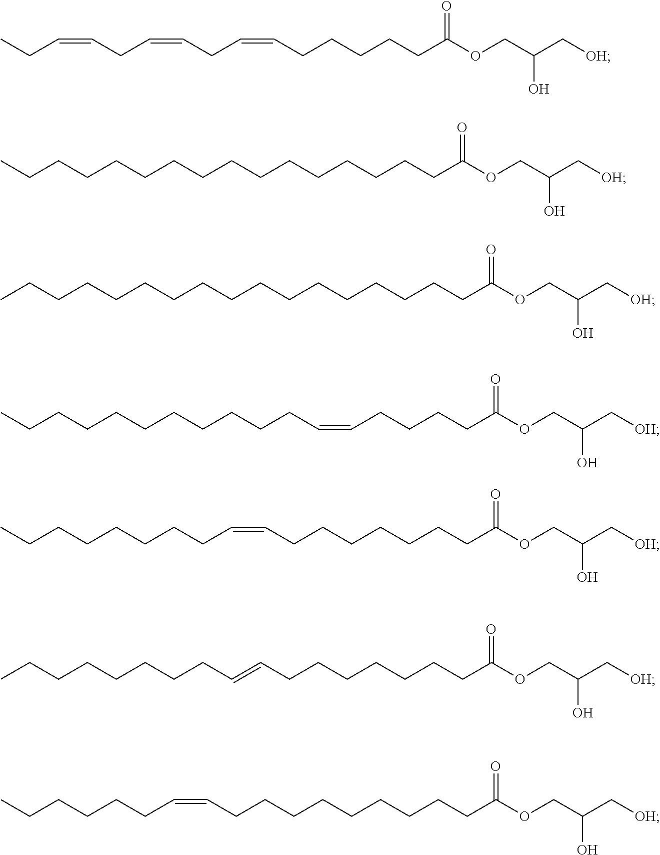

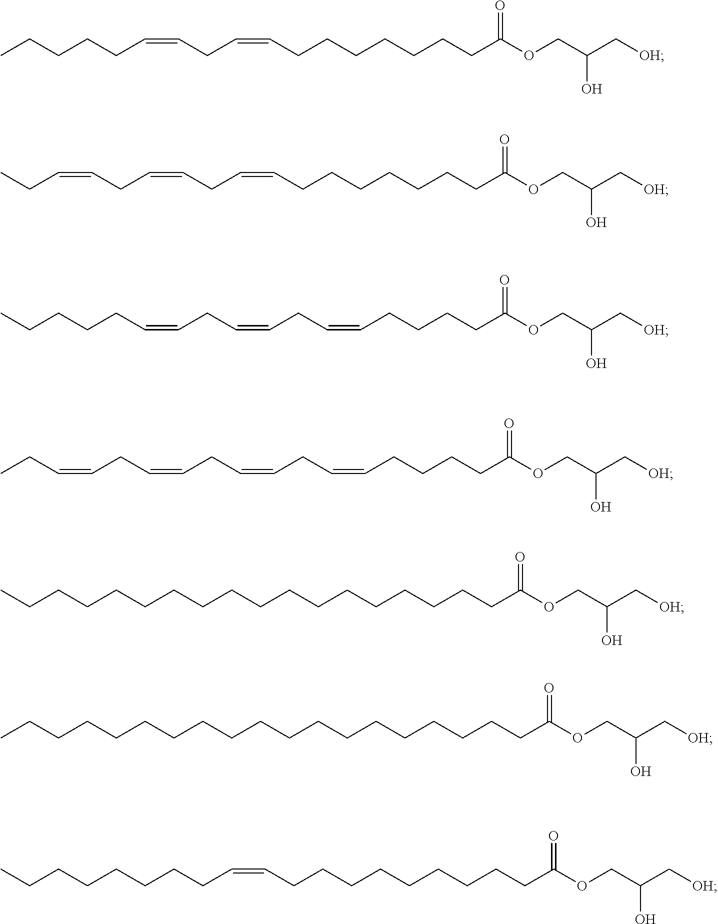

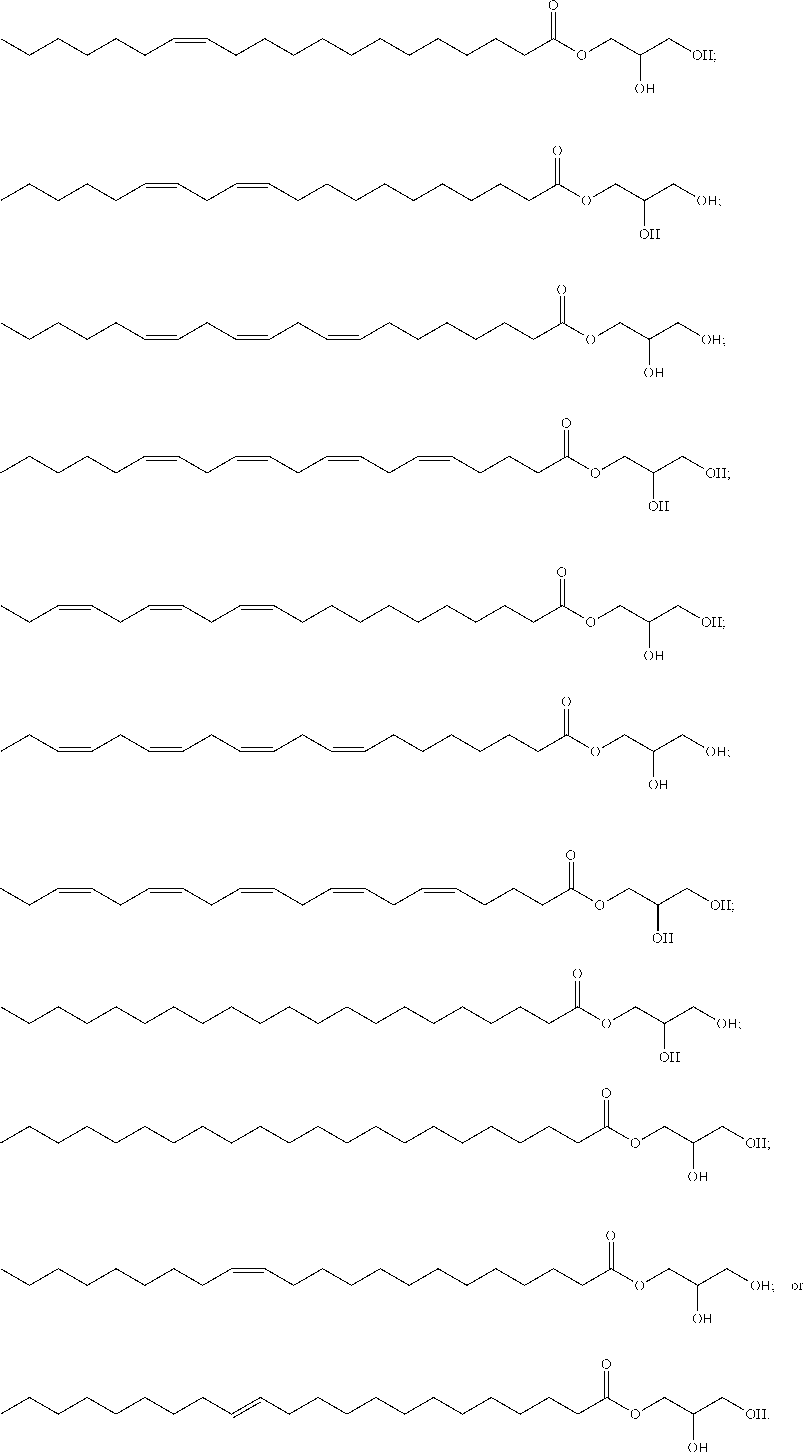

In some embodiments, the compounds in the compositions that are formed from the triglycerides (e.g., the compounds of Formula I) via the methods described herein optionally include 2-monoacylglycerides. Accordingly, in some embodiments, the compounds in the compositions that are formed from the triglycerides (e.g., the compounds of Formula I) via the methods described herein can optionally include one or more compounds of Formula VI, where Formula VI is:

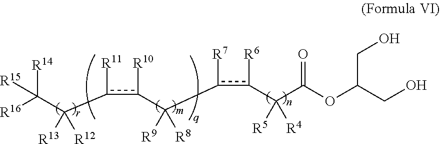

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R^{H11} are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the compounds in the compositions that are formed from the triglycerides (e.g., the compounds of Formula I) via the methods herein can optionally include one or more of the following 2-monoglycerides (e.g. compounds of Formula VI)

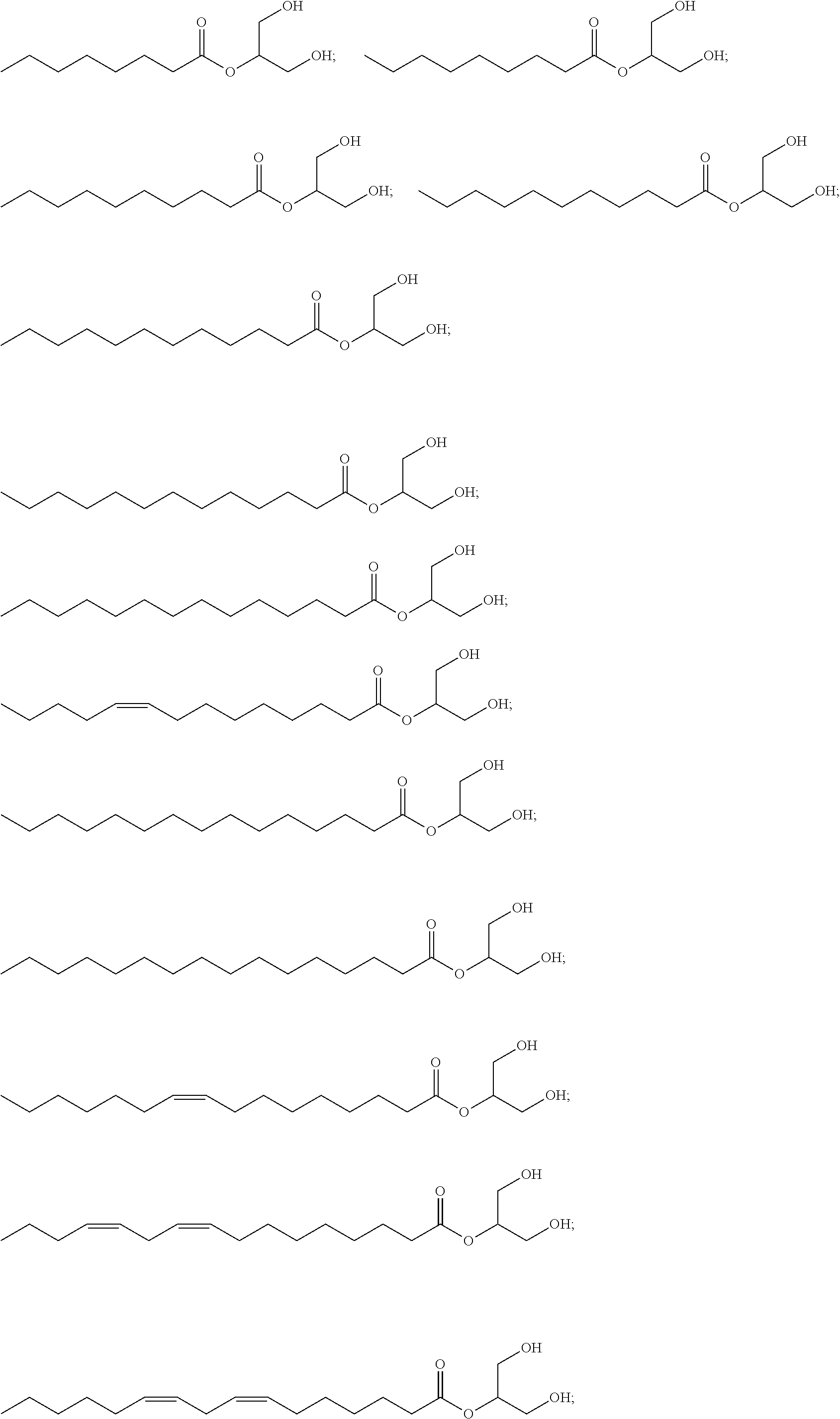

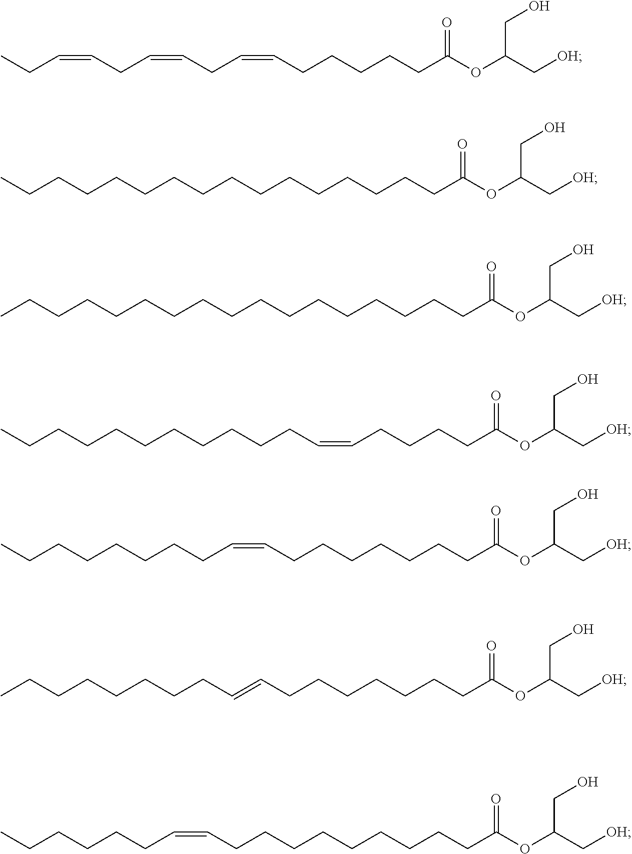

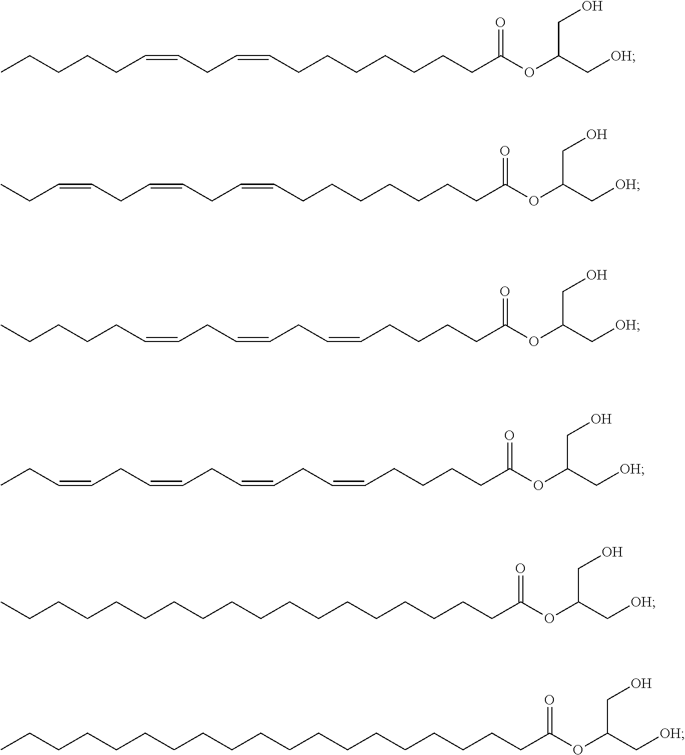 [SMILES: CCCCC/C=C\C/C=C\CCCCCCCC(=O)OC(CO)CO ; CC/C=C\C/C=C\C/C=C\CCCCCCCC(=O)OC(CO)CO ; CCCCC/C=C\C/C=C\C/C=C\CCCCC(=O)OC(CO)CO ; CC/C=C\C/C=C\C/C=C\C/C=C\CCCCC(=O)OC(CO)CO ; CCCCCCCCCCCCCCCCCCC(=O)OC(CO)CO ; CCCCCCCCCCCCCCCCCCCC(=O)OC(CO)CO]

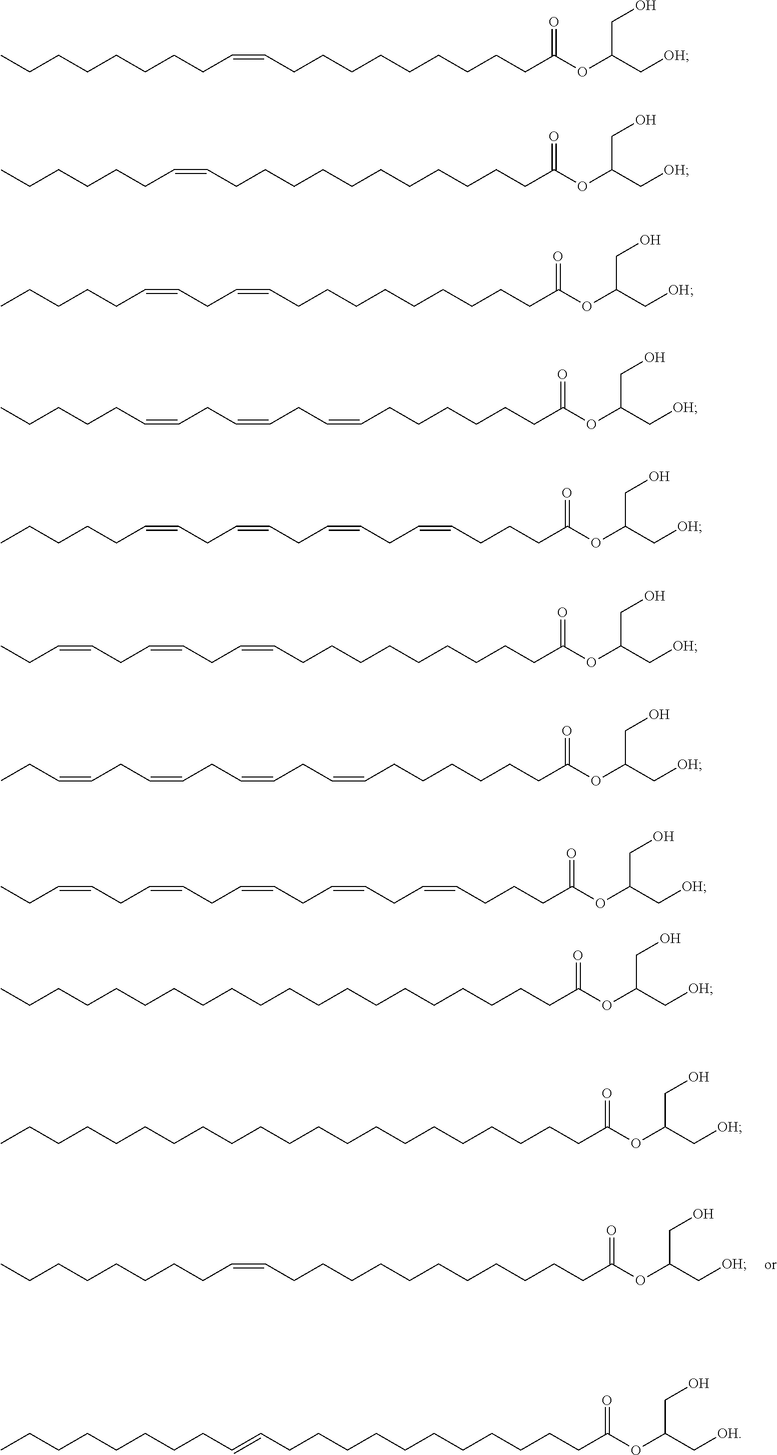

In some embodiments, the compositions can be rich in monoglycerides (e.g. 1-monoacylglycerides, 2-monoacylglycerides). In some embodiments, the monoglycerides can be at least about 30% of the mass of the composition, at least about 35% of the mass of the composition, at least about 40% of the mass of the composition, at least about 45% of the mass of the composition, at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the monoglycerides can be about 30% to 100% of the mass of the composition, about 30% to 99% of the mass of the composition, about 30% to 95% of the mass of the composition, about 30% to 90% of the mass of the composition, about 30% to 85% of the mass of the composition, about 30% to 80% of the mass of the composition, about 30% to 75% of the mass of the composition, about 30% to 70% of the mass of the composition, about 30% to 65% of the mass of the composition, about 30% to 60% of the mass of the composition, about 30% to 55% of the mass of the composition, about 35% to 60% of the mass of the composition, about 40% to 65% of the mass of the composition, about 45% to 70% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition.

In some embodiments, the compounds in the compositions that are formed from the triglycerides (e.g., the compounds of Formula I) via the methods described herein can optionally include diglycerides (e.g., 1,2-diacylglycerides, 1,3-diacylglycerides). Accordingly, in some embodiments, the compounds in the compositions that are formed from the triglycerides (e.g., the compounds of Formula I) via the methods described herein can optionally include one or more compounds of Formula VII, where Formula VII is:

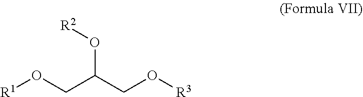

wherein:

R¹, R² are each independently at each occurrence —H, or a fragment of Formula II, and R³ is a fragment of Formula II, where Formula II is:

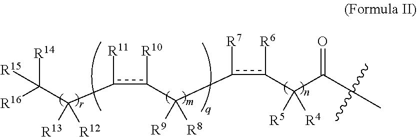

and the total number of —H substituents on R¹ and R² is 1.

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the compounds in the compositions that are formed from the triglycerides (e.g., the compounds of Formula I) via the methods described herein can optionally include one or more diglyceride (e.g., the compounds of Formula VII) containing any combination of one or more of the following fragments of Formula II:

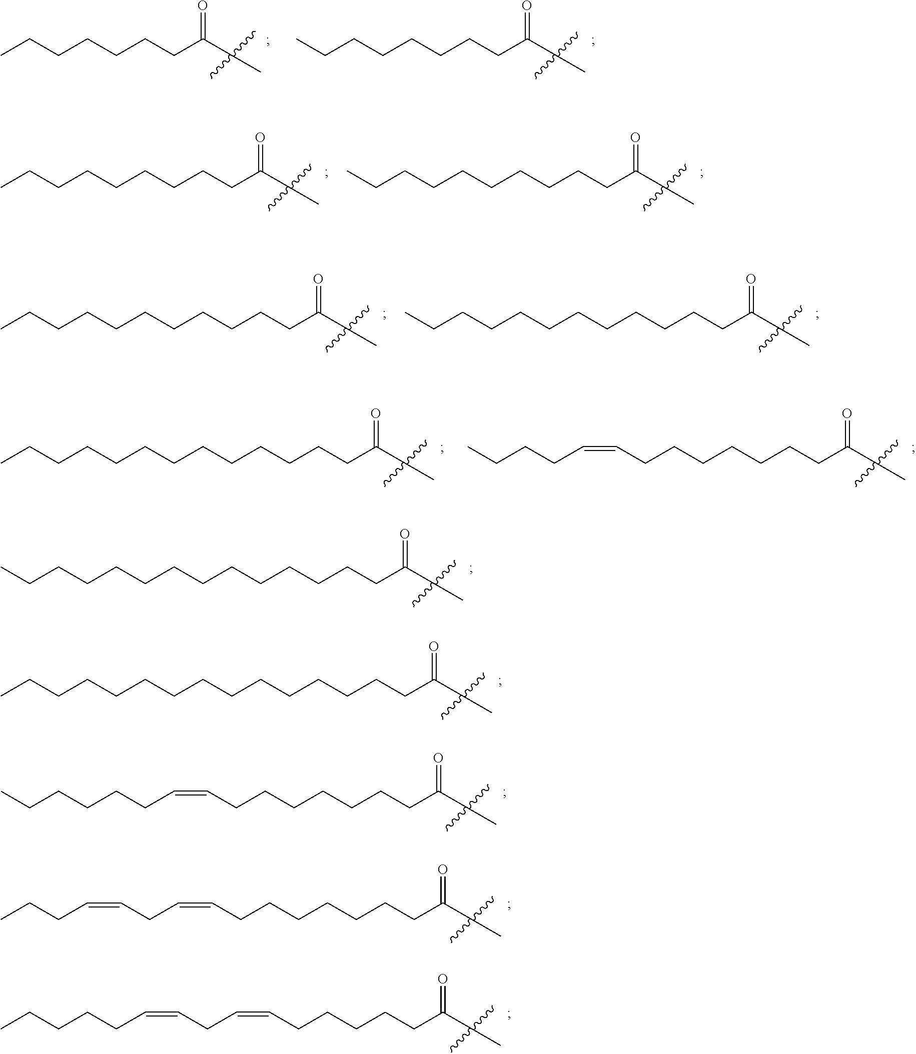

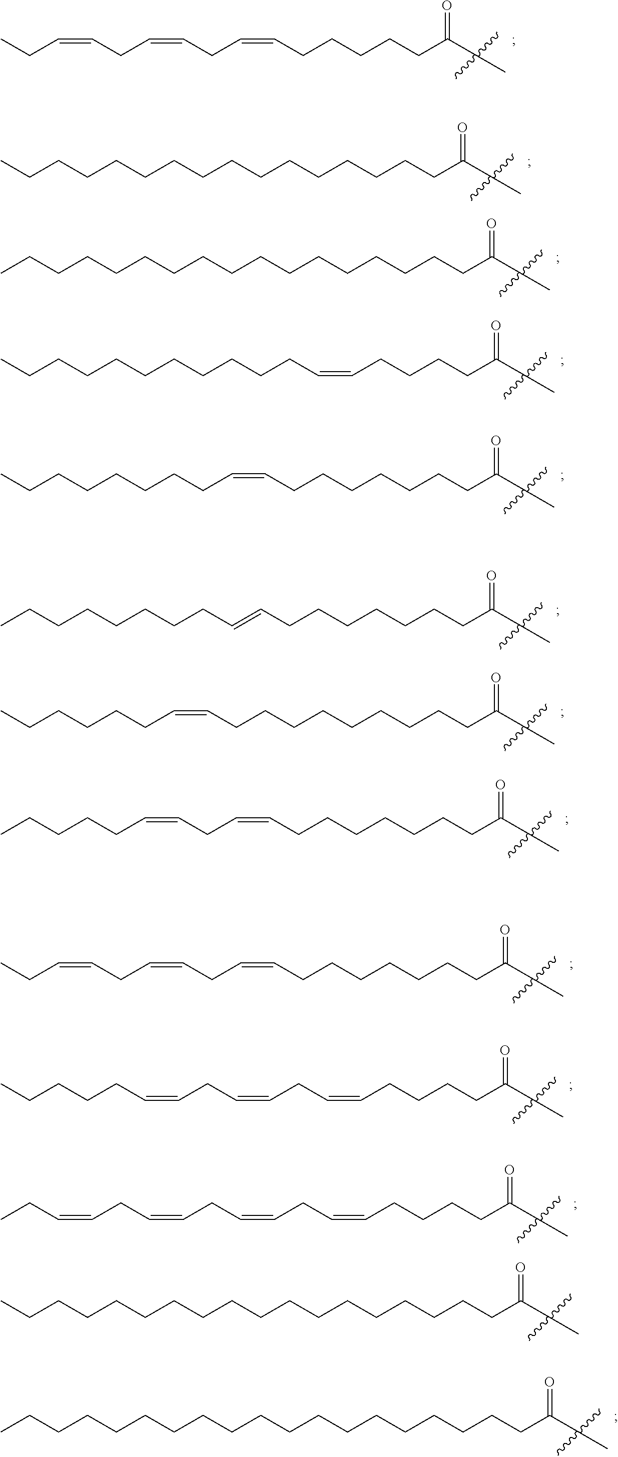

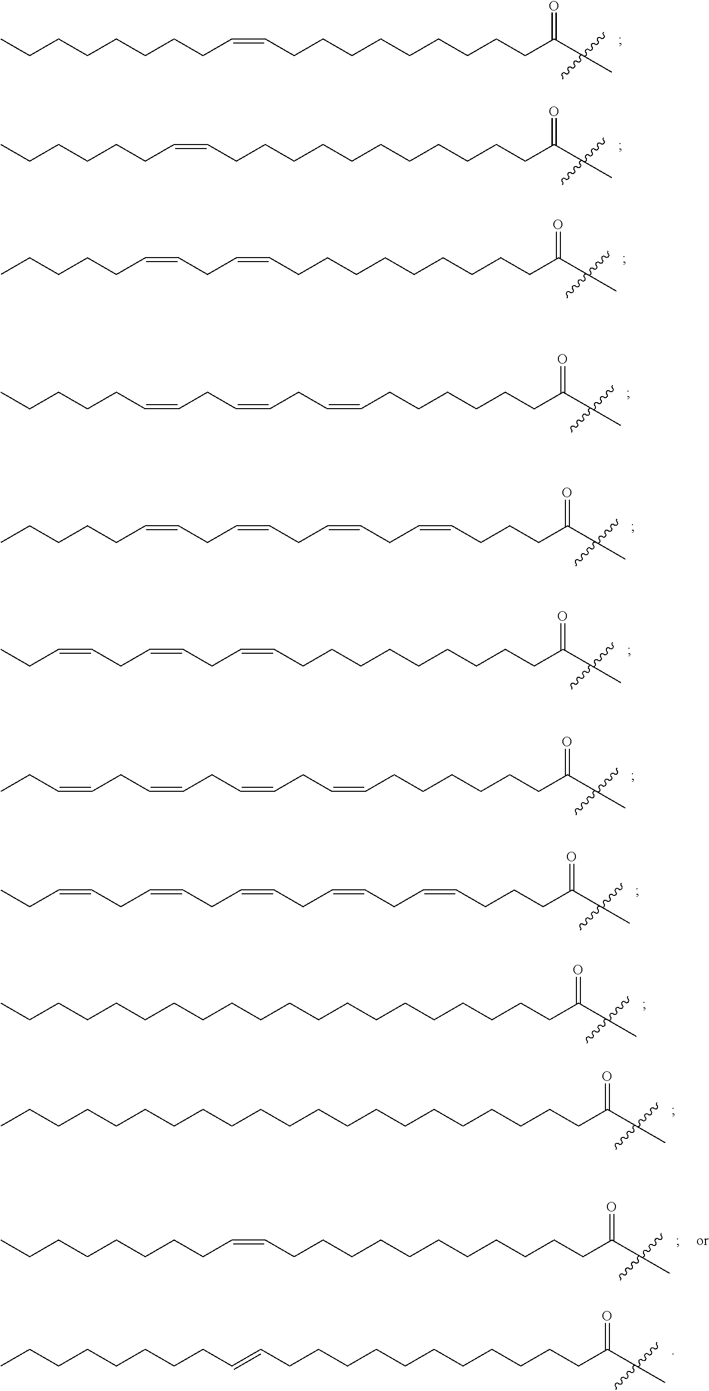

In some embodiments, the compositions can be rich in monoglycerides (e.g. 1-monoacylglycerides, 2-monoacylglycerides) and diglycerides (e.g. 1,2-diacylglycerides, 1,3-diacylglycerides). In some embodiments, the mono- and diglyceride content can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the mono- and diglyceride content can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition. In some embodiments the ratio of monoglycerides to diglycerides can be about 1:3, about 1:2, about 2:3, about 1:1, about 3:2, about 2:1, about 3:1, about 4:1, about 5:1, about 6:1, about 7:1, about 8:1, about 9:1, about 20:1, about 50:1, or about 100:1.

In some embodiments, the compounds in the compositions that are formed from the triglycerides (e.g., the compounds of Formula I) via the methods described herein can optionally include alkyl esters of fatty acids. Accordingly, the compounds in the compositions that are formed from the triglycerides (e.g., the compounds of Formula I) via the methods described herein can optionally include one or more compounds of Formula VIII, where Formula VIII is:

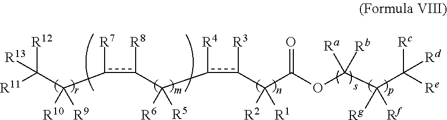

wherein:

R¹, R², R⁵, R⁶, R⁹, R¹⁰, R¹¹, R¹², R¹³, R^{c}, R^{d}, R^{e}, R^{f} and R^{g} are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl;

R^{a} and R^{b} are each independently, at each occurrence, —H, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O; and/or

R^{a} and R^{b} can combine with the carbon atoms to which they are attached to form C═O; and/or

R^{g} and R^{f} can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8;

s is 0 or 1; and

p is 0, 1, 2, 3, 4, 5, 6, 7, 8.

Any of the compounds in the compositions that are formed from the triglycerides (e.g., the compounds of Formula I) via the methods described herein can optionally include one or more of the following alkyl esters of fatty acid compounds (e.g., compounds of Formula VIII) where R is a C₁-C₆ alkyl:

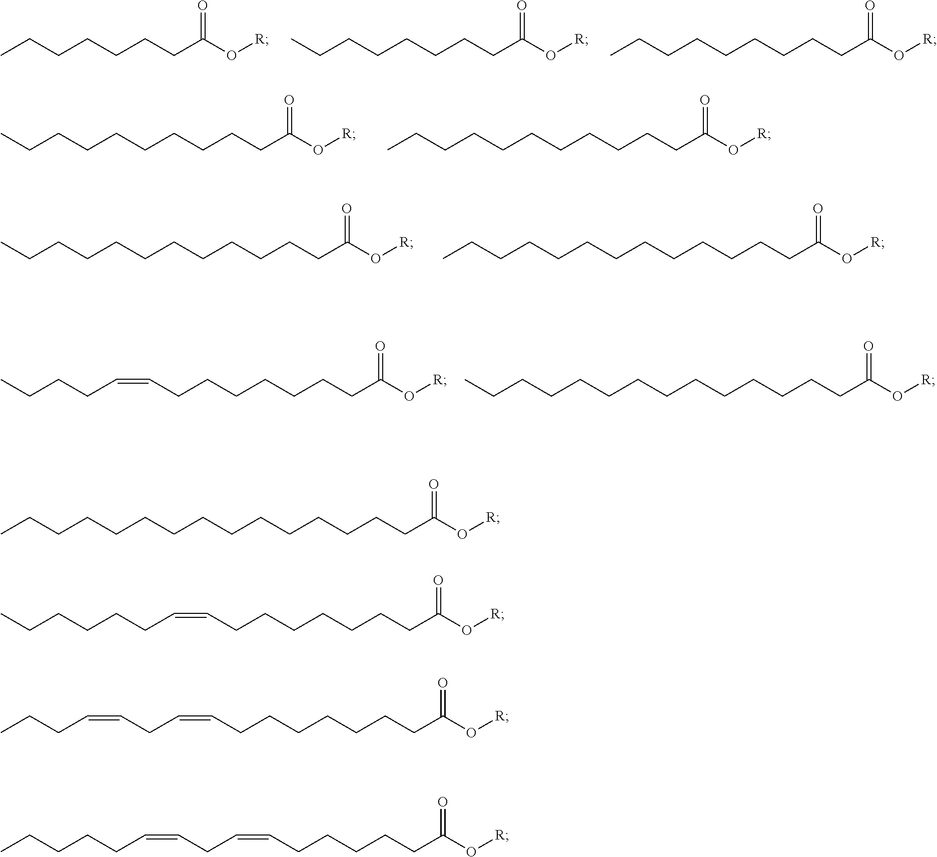

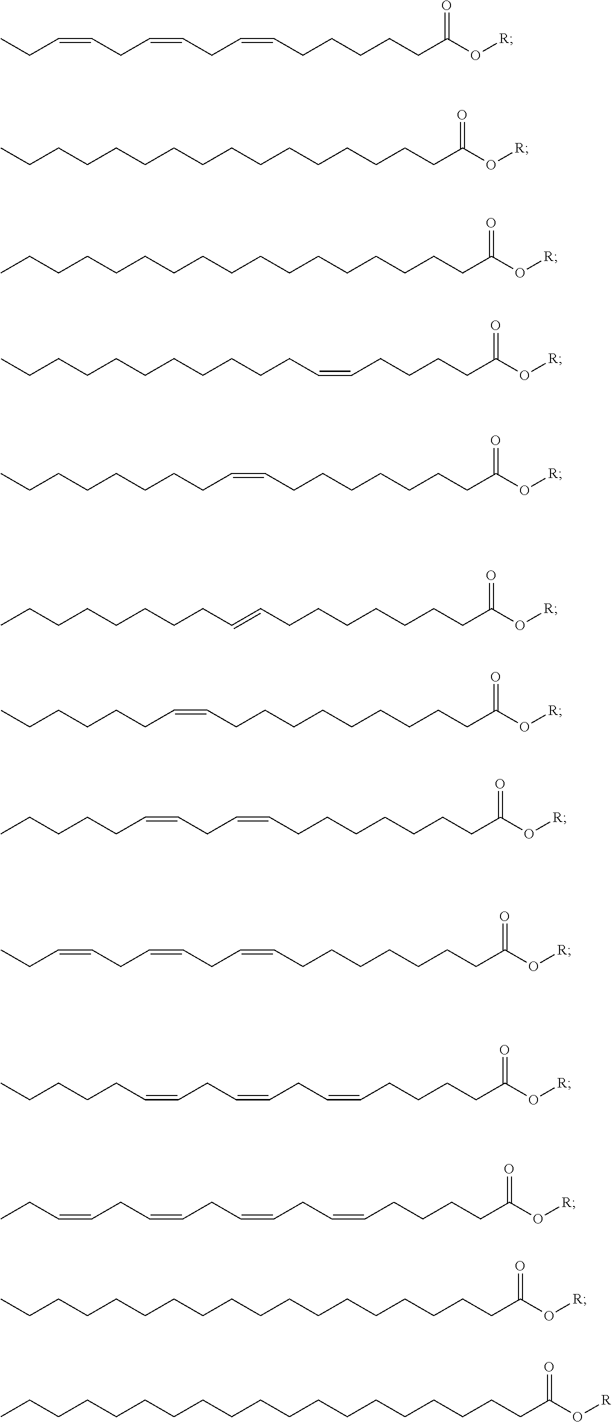

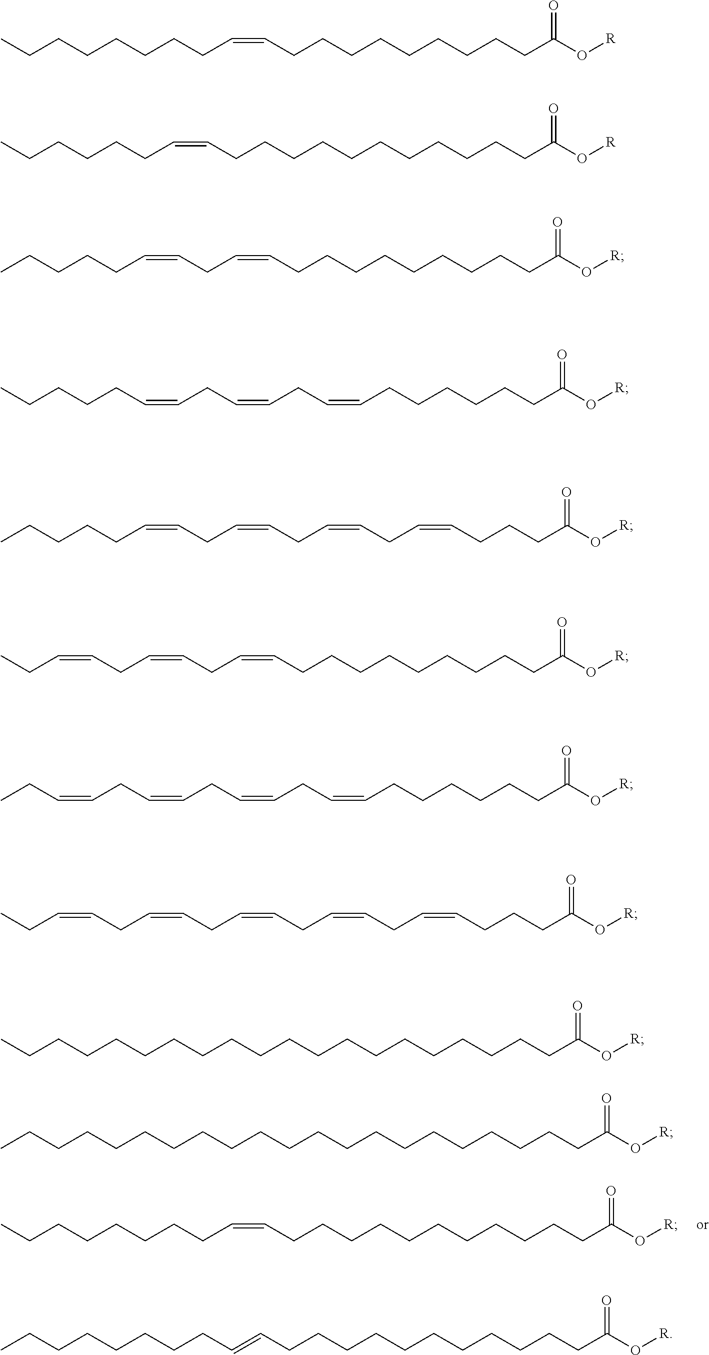

In some embodiments, the compositions can be rich in alkyl esters of fatty acids (e.g., methyl esters, ethyl esters, propyl esters, butyl esters, pentyl esters, hexyl esters, among others). In some embodiments, the alkyl esters of fatty acids can be at least about 30% of the mass of the composition, at least about 35% of the mass of the composition, at least about 40% of the mass of the composition, at least about 45% of the mass of the composition, at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the alkyl esters of fatty acids can be about 30% to 100% of the mass of the composition, about 30% to 99% of the mass of the composition, about 30% to 95% of the mass of the composition, about 30% to 90% of the mass of the composition, about 30% to 85% of the mass of the composition, about 30% to 80% of the mass of the composition, about 30% to 75% of the mass of the composition, about 30% to 70% of the mass of the composition, about 30% to 65% of the mass of the composition, about 30% to 60% of the mass of the composition, about 30% to 55% of the mass of the composition, about 35% to 60% of the mass of the composition, about 40% to 65% of the mass of the composition, about 45% to 70% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, or about 90% to 100% of the mass of the composition.

In some embodiments, the compositions can be substantially free of unsaturated molecules (e.g. unsaturated fatty acids, unsaturated fatty acid salts, unsaturated fatty acid esters). In some embodiments, the saturated molecules can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the saturated molecules can be about 50% to 100% of the mass of the composition, about 50% to 99% of the mass of the composition, about 50% to 95% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, about 90% to 100% of the mass of the composition. In some embodiments, the iodine value of the composition is less than 10, less than 9, less than 8, less than 7, less than 6, less than 5, less than 4, less than 3, or less than 2.

In some embodiments, the compositions can be substantially free of saturated molecules (e.g. saturated fatty acids, saturated fatty acid salts, saturated fatty acid esters). In some embodiments, the unsaturated molecules can be at least about 50% of the mass of the composition, at least about 55% of the mass of the composition, at least about 60% of the mass of the composition, at least about 65% of the mass of the composition, at least about 70% of the mass of the composition, at least about 75% of the mass of the composition, at least about 80% of the mass of the composition, at least about 85% of the mass of the composition, at least about 90% of the mass of the composition, at least about 95% of the mass of the composition, or at least about 99% of the mass of the composition. In some embodiments, the unsaturated molecules can be about 50% to 100% of the mass of the composition, about 50% to 99% of the mass of the composition, about 50% to 95% of the mass of the composition, about 50% to 90% of the mass of the composition, about 50% to 90% of the mass of the composition, about 50% to 85% of the mass of the composition, about 50% to 80% of the mass of the composition, about 50% to 75% of the mass of the composition, about 55% to 80% of the mass of the composition, about 60% to 85% of the mass of the composition, about 65% to 90% of the mass of the composition, about 70% to 95% of the mass of the composition, about 75% to 99% of the mass of the composition, about 75% to 100% of the mass of the composition, about 80% to 95% of the mass of the composition, about 80% to 99% of the mass of the composition, about 80% to 100% of the mass of the composition, about 85% to 95% of the mass of the composition, about 85% to 99% of the mass of the composition, about 85% to 100% of the mass of the composition, about 90% to 95% of the mass of the composition, about 90% to 96% of the mass of the composition, about 90% to 97% of the mass of the composition, about 90% to 98% of the mass of the composition, about 90% to 99% of the mass of the composition, about 90% to 100% of the mass of the composition. In some embodiments, the composition can be substantially free of fatty acids, fatty acid salts, or fatty acid esters containing trans-double bonds (i.e. trans fats).

In some embodiments, the compositions that are made from the methods described herein are certified USDA organic. In some embodiments, the seed, bean, nut, kernel, or pulp material of virgin or non-virgin plant matter can be from a certified USDA organic source, which after extraction and refining can afford triglycerides from crude oil extracts that are also certified USDA Organic, provided that the extraction and refining methods adhere to National Organic Program regulations (7 CFR § 205.605). Optionally, methods of chemical and/or physical modification of triglycerides from crude oil extracts can provide a composition that is certified USDA Organic comprising one or more fatty acids, fatty acid salts, and fatty acid esters, including glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others), provided that the process of chemical and/or physical modification adheres to National Organic Program regulations (7 CFR § 205.605). Optionally, methods of separation and/or purification can provide a composition that is certified USDA Organic comprising one or more fatty acids, fatty acid salts, and fatty acid esters, including glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others), provided that the process of chemical and/or physical modification adheres to National Organic Program regulations (7 CFR § 205.605).

In some embodiments, the methods described above can be used to form monoglycerides that are certified USDA Organic. For example, a crude oil having at least 30% saturated compounds can first be extracted, and optionally the crude oil can undergo a separation via melt fractionalization or crystallization. The crude oil can optionally undergo additional purification or refining steps such as those previously described, either before or after the (optional) separation. This can result in an oil with a high percentage of saturated compounds (e.g., saturated triglycerides) which is certified USDA Organic (e.g., >95% organic). This USDA Organic oil is then subjected to a glycerolysis reaction with USDA Organic glycerol (e.g., >95% organic) using <5 wt % NaOH as a catalyst, or alternatively another catalyst that is allowed as per National Organic Program regulations (7 CFR § 205.605). This produces a mixture of products that can undergo a similar distillation process as mentioned above to produce USDA Organic mono- and diglycerides. If not performed at an earlier step, the saturated fat content of these products can optionally be enhanced via melt fractionation or crystallization as necessary (crystallization solvent must adhere to 7 CFR § 205.605, and can, e.g., be >95% USDA Organic Ethanol). If any fatty acids salts are produced during these procedures, the resulting compositions can still be certified as USDA Organic provided that the total input of NaOH is <5 wt % total. There are currently no known available sources of USDA Organic monoglycerides, for which there is a long felt need in the industry. The methods above can therefore be utilized to meet this long felt need.

In some embodiments, methods described above can be used to form fatty acid salts that are certified USDA Organic. For example, a crude oil having at least 30% saturated compounds can first be extracted, and optionally the crude oil can undergo a separation via melt fractionalization or crystallization. The crude oil can optionally undergo additional purification or refining steps such as those previously described, either before or after the (optional) separation. This can result in an oil with a high percentage of saturated compounds (e.g., saturated triglycerides) which is certified USDA Organic (e.g., >95% organic). This USDA Organic oil is then subjected to a saponification reaction performed with <5% NaOH to produce a fatty acid salt that is certified USDA Organic (e.g., >95% USDA Organic). The resulting mixture can optionally undergo a similar distillation process as mentioned above. If not performed at an earlier step, the saturated fat content of these products can optionally be enhanced via melt fractionation or crystallization (in accordance with 7 CFR § 205.605). This can result in a USDA Organic certified fatty acid salt. There are currently no known available sources of USDA Organic fatty acid salts, for which there is a long felt need in the industry. The methods above can therefore be utilized to meet this long felt need.

In some embodiments, methods described above can be used to form fatty acids that are certified USDA Organic. For example, a crude oil having at least 30% saturated compounds can first be extracted, and optionally the crude oil can undergo a separation via melt fractionalization or crystallization. The crude oil can optionally undergo additional purification or refining steps such as those previously described, either before or after the (optional) separation. This can result in an oil with a high percentage of saturated compounds (e.g., saturated triglycerides) which is certified USDA Organic (e.g., >95% organic). This USDA Organic oil is then subjected to a hydrolysis reaction with, for example, water at 250° C. and elevated pressure to produce a fatty acid that is certified USDA Organic (e.g., >95% USDA Organic). The resulting mixture can optionally undergo a similar distillation process as mentioned above. If not performed at an earlier step, the saturated fat content of these products can optionally be enhanced via melt fractionation or crystallization (in accordance with 7 CFR § 205.605). This can result in a USDA Organic certified fatty acid. There are currently no known available sources of USDA Organic fatty acids, for which there is a long felt need in the industry. The methods above can therefore be utilized to meet this long felt need.

In some embodiments, the composition containing fatty acids, fatty acid salts, and/or fatty acid esters, including glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others) resulting from any of physical and/or chemical modification and/or separation and/or purification can be further treated to obtain a specific particle size distribution. In some embodiments, the particle size of the composition can be controlled via crystallization, milling, sieving, or spray cooling/drying. In some embodiments, the composition can have an average grain size of less than about 2000 μm, less than about 1500 μm, less than about 1000 μm, less than about 900 μm, less than about 800 μm, less than about 700 μm, less than about 600 μm, less than about 500 μm, less than about 400 μm, less than about 300 μm, less than about 200 μm, less than about 100 μm, or less than about 50 μm. In some embodiments, the composition can be formed by blending one or more fatty acids, fatty acid salts, and/or fatty acid esters, including glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others) wherein the particle size of has been controlled via crystallization, milling, sieving, or spray cooling/drying. In some embodiments, the composition can be comprised of a mixture of one or more components with an average grain size or each of the components in the range of about 2000 μm to about 1000 μm, in the range of about 1000 μm to about 100 μm, in the range of about 750 μm to about 100 μm, in the range of about 500 μm to about 100 μm, or in the range of about 250 μm to about 10 μm. In some embodiments, control of the average grain size can provide advantages such as allowing for more efficient dissolution of the mixture in a solvent.

In some embodiments, any of the compositions formed by methods described herein can be applied to the outer surface of substrates such as a perishable item (e.g., agricultural products, plants, fruits, vegetables, produce, cut flowers, etc) to form a protective coating over the surface. The coating can, for example, protect the perishable item from degradation by biotic and/or abiotic stressors. The composition can include one or more constituents of the subsequently formed coating. The coating can be formed by adding the constituents of the coating, e.g., by combining one or more compositions described herein (collectively a “coating agent”) to a solvent (e.g., water and/or ethanol) to form a mixture (e.g., a solution, suspension, or colloid), applying the mixture to the outer surface of the product to be coated, e.g., by dipping the product in the mixture or by spraying the mixture over the surface of the product or by brushing the mixture onto the surface of the product, and then removing the solvent from the surface of the product, e.g., by allowing the solvent to evaporate, thereby causing the coating to be formed from the coating agent over the surface of the product. The coating agent (i.e., the one or more compositions described herein) can be formulated such that the resulting coating provides a barrier to water and/or oxygen transfer, thereby preventing water loss from and/or oxidation of the coated product. The coating agent (i.e., the one or more compositions described herein) can additionally or alternatively be formulated such that the resulting coating provides a barrier to CO₂, ethylene and/or other gas transfer. In some embodiments the substrate is edible and/or the coating is edible.

The solvent to which the coating agent (i.e., the one or more compositions described herein) is added to form the mixture can include any polar, non-polar, protic, or aprotic solvents, including any combinations thereof. Examples of solvents that can be used include water, methanol, ethanol, isopropanol, butanol, acetone, ethyl acetate, chloroform, acetonitrile, tetrahydrofuran, diethyl ether, methyl tert-butyl ether, any other suitable solvent or combinations thereof. In cases where the coating is going to be applied to plants or other edible products, it may be preferable to use a solvent that is safe for consumption, for example water, ethanol, or combinations thereof.

Coating agents (i.e., the one or more compositions described herein) including fatty acids (e.g., palmitic acid, stearic acid, myristic acid, and/or other fatty acids) and/or esters or salts thereof obtained by any of the methods described herein can both be safe for human consumption and can be used as coating agents to form coatings that are effective at reducing mass loss and oxidation in a variety of produce. For example, coatings formed from coating agents (i.e., the one or more compositions described herein) that include various combinations of palmitic acid, myristic acid, stearic acid, 1-glyceryl esters of palmitic acid (i.e., 2,3-dihydroxypropan-1-yl palmitate, herein “PA-1G”), 2-glyceryl esters of palmitic acid (i.e., 1,3-dihydroxypropan-2-yl palmitate, herein “PA-2G”), 1-glyceryl esters of myristic acid (i.e., 2,3-dihydroxypropan-1-yl tetradecanoate, herein “MA-1G”), 1-glyceryl esters of stearic acid (i.e., 2,3-dihydroxypropan-1-yl octadecenoate, herein “SA-1G”), and/or other fatty acids or salts or esters thereof have been shown to be effective at reducing mass loss rates in many types of produce, for example finger limes, avocados, blueberries, and lemons.

Coatings deposited by methods described above can form a thin layer on the surface of an agricultural product, which can protect the agricultural product from biotic stressors, water loss, and/or oxidation. In some embodiments, the deposited coating can have a thickness of less than 10 microns, less than 9 microns, less than 8 microns, less than 7 microns, less than 6 microns, less than 5 microns, less than 4 microns, less than 3 microns, less than 2 microns, or less than about 1500 nm, and/or the coating can be transparent to the naked eye. For example, the deposited coating can have a thickness of about 10 nm, about 20 nm, about 30 nm, about 40 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, 1,000 nm, about 1,100 nm, about 1,200 nm, about 1,300 nm, about 1,400 nm, about 1,500 nm, about 1,600 nm, about 1,700 nm, about 1,800 nm, about 1,900 nm, about 2,000 nm, about 2,100 nm, about 2,200 nm, about 2,300 nm, about 2,400 nm, about 2,500 nm, about 2,600 nm, about 2,700 nm, about 2,800 nm, about 2,900 nm, or about 3,000 nm, inclusive of all ranges therebetween.

Any of the coating agents described herein (i.e., the one or more compositions described herein) can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some embodiments, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO₂, or ethylene through the coating or enable the coating to absorb more ultra violet (UV) light, for example to protect the agricultural product (or any of the other products described herein). In some embodiments, the additive can be configured to provide an intentional odor, for example a fragrance (e.g., smell of flowers, fruits, plants, freshness, scents, etc.). In some embodiments, the additive can be configured to provide color and can include, for example, a dye or a US Food and Drug Administration (FDA) approved color additive.

Any of the coating agents (i.e., the one or more compositions described herein) or coatings formed thereof that are described herein can be flavorless or have high flavor thresholds, e.g. above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

In some embodiments, the deposited coating can be deposited substantially uniformly over the substrate and can be free of defects and/or pinholes. In some embodiments, the dip-coating process can include sequential coating of the agricultural product in baths of coating precursors that can undergo self-assembly or covalent bonding on the agricultural product to form the coating. In some embodiments, the coating can be deposited on agricultural products by passing the agricultural products under a stream of the coating solution/suspension/colloid (e.g., a waterfall of the coating solution/suspension/colloid). For example, the agricultural products can be disposed on a conveyor that passes through the stream of the coating solution/suspension/colloid. In some embodiments, the coating can be misted, vapor- or dry vapor-deposited on the surface of the agricultural product. In some embodiments, the coating solution/suspension/colloid can be mechanically applied to the surface of the product to be coated, for example by brushing it onto the surface. In some embodiments, the coating can be configured to be fixed on the surface of the agricultural product by UV crosslinking or by exposure to a reactive gas, for example oxygen.

In some embodiments, the coating solutions/suspensions/colloids can be spray-coated on the agricultural products. Commercially available sprayers can be used for spraying the coating solutions/suspensions/colloids onto the agricultural product. In some embodiments, the coating formulation can be electrically charged in the sprayer before spray-coating on to the agricultural product, such that the deposited coating electrostatically and/or covalently bonds to the exterior surface of the agricultural product.

As previously described, the coatings formed from coating agents (i.e., the one or more compositions described herein) can be configured to prevent water loss or other moisture loss from the coated portion of the plant, delay ripening, and/or prevent oxygen diffusion into the coated portion of the plant, for example, to reduce oxidation of the coated portion of the plant. The coatings can also serve as a barrier to diffusion of carbon dioxide and/or ethylene into or out of the plant or agricultural product. The coatings can also protect the coated portion of the plant against biotic stressors, such as, for example, bacteria, fungi, viruses, and/or pests that can infest and decompose the coated portion of the plant. Since bacteria, fungi and pests all identify food sources via recognition of specific molecules on the surface of the agricultural product, coating the agricultural products with the coating agent can deposit molecularly contrasting molecules on the surface of the portion of the plant, which can render the agricultural products unrecognizable. Furthermore, the coating can also alter the physical and/or chemical environment of the surface of the agricultural product making the surface unfavorable for bacteria, fungi or pests to grow. The coating can also be formulated to protect the surface of the portion of the plant from abrasion, bruising, or otherwise mechanical damage, and/or protect the portion of the plant from photodegradation. The portion of the plant can include, for example, a leaf, a stem, a shoot, a flower, a fruit, a root, etc.

Any of the coatings described herein can be used to protect any agricultural product. In some embodiments, the coating can be coated on an edible agricultural product, for example, fruits, vegetables, edible seeds and nuts, herbs, spices, produce, meat, eggs, dairy products, seafood, grains, or any other consumable item. In such embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located at “http://www.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be configured to be washed off an edible agricultural product, for example, with water.

In some embodiments, the coatings described herein can be formed on an inedible agricultural product. Such inedible agricultural products can include, for example, inedible flowers, seeds, shoots, stems, leaves, whole plants, and the like. In such embodiments, the coating can include components that are non-toxic, but the threshold level for non-toxicity can be higher than that prescribed for edible products. In such embodiments, the coating can include an FDA approved food contact substance, an FDA approved food additive, or an FDA approved drug ingredient, for example, any ingredient included in the FDA's database of approved drugs, which can be found at “http://www.accessdata.fda.gov/scripts/cder/drugsatfda/index.cfm”, the entire contents of which are hereby incorporated herein by reference. In some embodiments, the coating can include materials that satisfy FDA requirements to be used in drugs or are listed within the FDA's National Drug Discovery Code Directory, “http://www.accessdata.fda.gov/scripts/cder/ndc/default.cfm”, the entire contents of which are hereby incorporated herein by reference. In some embodiments, the materials can include inactive drug ingredients of an approved drug product as listed within the FDA's database, “http://www.accessdata.fda.gov/scripts/cder/ndc/default.cfm”, the entire contents of which are hereby incorporated herein by reference.

Embodiments of the coatings described herein provide several advantages, including, for example: (1) the coatings can protect the agricultural products from biotic stressors, i.e. bacteria, viruses, fungi, or pests; (2) the coatings can prevent evaporation of water and/or diffusion of oxygen, carbon dioxide, and/or ethylene; (3) coating can help extend the shelf life of agricultural products, for example, post-harvest produce, without refrigeration; (4) the coatings can introduce mechanical stability to the surface of the agricultural products eliminating the need for expensive packaging designed to prevent the types of bruising which accelerate spoilage; (5) use of agricultural waste materials to obtain the coatings can help eliminate the breeding environments of bacteria, fungi, and pests; (6) the coatings can be used in place of pesticides to protect plants, thereby minimizing the harmful impact of pesticides to human health and the environment; (7) the coatings can be naturally derived and hence, safe for human consumption. Since in some cases the components of the coatings described herein can be obtained from agricultural waste, such coatings can be made at a relatively low cost. Therefore, the coatings can be particularly suited for small scale farmers, for example, by reducing the cost required to protect crops from pesticides and reducing post-harvest losses of agricultural products due to decomposition by biotic and/or environmental stressors.

### Exemplary Embodiments of the Disclosure

Some exemplary embodiments of the disclosure include:

1. A method of forming a composition from seed, bean, nut, kernel, or pulp material of plant matter, comprising:

at least partially separating the seed, bean, nut, kernel, or pulp material from other portions of the plant matter;

extracting an oil comprising one or more triglycerides from the seed, bean, nut, kernel, or pulp material;

refining the oil to remove one or more impurity components; and

chemically modifying the oil.

2. The method of embodiment 1, wherein the seed, bean, nut, kernel, or pulp material comprises rapeseed, grapeseed, citrus seed, sunflower seed, mango seed, cherry kernel, stone fruit kernel, palm kernel, shea nut, other edible and non-edible nuts, cacao, coconut, soy, olive, or wood pulp.
3. The method of embodiment 1, wherein the extraction of the oil from the seed, bean, nut, kernel, or pulp material comprises mechanical pressing, hydraulic pressing, solvent extraction, extraction with supercritical solvents, distillation, maceration, or the enfleurage method.
4. The method of embodiment 3, further comprising purifying the extracted oil to form a clarified oil prior to the refining of the oil.
5. The method of embodiment 4, wherein the purification of the extracted oil comprises centrifugation or filtration.
6. The method of embodiment 1, wherein the refining of the oil comprises (i) treating the oil with an acid to form a first mixture, (ii) neutralizing the first mixture with a base to form a second mixture, and (iii) treating the second mixture with a bleaching clay.
7. The method of embodiment 6, wherein the treating of the oil with the acid is carried out at a temperature greater than 80° C.
8. The method of embodiment 6, wherein the refining of the oil further comprises deodorization or winterization.
9. The method of embodiment 1, wherein the chemical modification of the oil comprises transesterification of at least one of the one or more triglycerides to form fatty acids, fatty acid salts, fatty acid esters, or monoglycerides.
10. The method of embodiment 1, wherein the chemical modification of the oil comprises hydrolysis of at least one of the one or more triglycerides to form compounds of Formula III, wherein Formula III is:

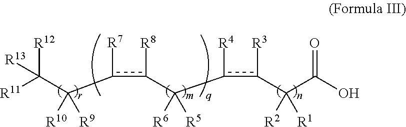

wherein.

R¹, R², R⁵, R⁶, R⁹, R¹⁰, R¹¹, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

11. The method of embodiment 1, wherein the chemical modification of the oil comprises modifying at least one of the one or more triglycerides to form compounds of Formula IV, wherein Formula IV is:

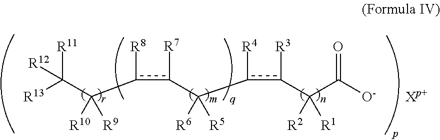

wherein:

R¹, R², R⁵, R⁶, R⁹, R¹⁰, R¹¹, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the [symbol] symbol represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8; and

X^{p+} is a cationic counter ion having a charge state p, and p is 1, 2, or 3.

12. The method of embodiment 1, wherein the chemical modification of the oil comprises modifying at least one of the one or more triglycerides to form compounds of Formula V, wherein Formula V is:

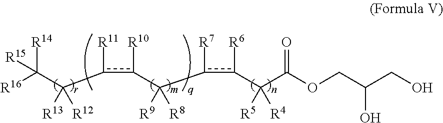

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

13. The method of embodiment 1, wherein the chemical modification of the oil comprises modifying at least one of the one or more triglycerides to form compounds of Formula VI, wherein Formula VI is:

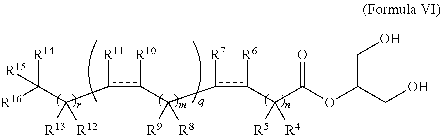

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

14. The method of embodiment 1, wherein the chemical modification of the oil comprises modifying at least one of the one or more triglycerides to form compounds of Formula VII, wherein Formula VII is:

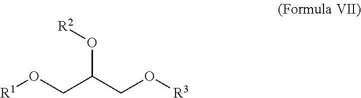

wherein:

R¹, R² are each independently at each occurrence —H, or a fragment of Formula II, and R³ is a fragment of Formula II, where Formula II is:

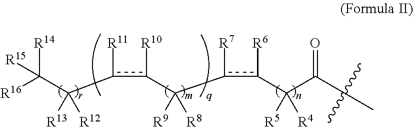

and the total number of —H substituents on R¹ and R² is 1.

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

15. The method of embodiment 1, wherein the chemical modification of the oil comprises modifying at least one of the one or more triglycerides to form compounds of Formula VIII, wherein Formula VIII is:

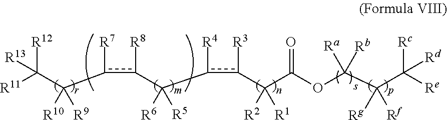

wherein:

R¹, R², R⁵, R⁶, R⁹, R¹⁰, R¹¹, R¹², R¹³, R^{c}, R^{d}, R^{e}, R^{f} and R^{g} are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl;

R^{a} and R^{b} are each independently, at each occurrence, —H, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O; and/or

R^{a} and R^{b} can combine with the carbon atoms to which they are attached to form C═O; and/or

R^{g} and R^{f} can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8;

s is 0 or 1; and

p is 0, 1, 2, 3, 4, 5, 6, 7, 8.

16. The method of embodiment 1, wherein the chemical modification of the oil comprises hydrogenation to form saturated fatty acids or derivatives thereof.
17. The method of embodiment 1, wherein an iodine value of the hydrogenated oil is less than 4.
18. The method of embodiment 13, wherein the hydrogenated oil is substantially free of trans fats.
19. The method of embodiment 12, wherein the fatty acids or derivatives thereof comprise triglycerides.
20. The method of embodiment 15, wherein the chemical modification further comprises transesterification of the triglycerides to form fatty acids, fatty acid salts, or monoglycerides.
21. The method of embodiment 15, wherein the chemical modification further comprises transesterification of the triglycerides to form compounds of Formula V or Formula IV, where Formulas V and IV are as given above.
22. The method of any of the previous embodiments, wherein the chemical modification of the oil comprises esterification or transesterification.
23. The method of embodiment 18, wherein the esterification or transesterification comprises glycerolysis to form monoglycerides.
24. The method of embodiment 19, further comprising distilling the composition.
25. The method of embodiment 20, wherein the distilling removes residual glycerol or sodium hydroxide from the composition.
26. The method of embodiment 1, wherein the composition comprises one or more compounds of Formula III, wherein Formula III is:

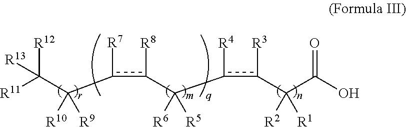

wherein

R¹, R², R⁵, R⁶, R⁹, R¹⁰, R¹¹, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

27. The method of embodiment 1, wherein the composition comprises one or more compounds of Formula IV, wherein Formula IV is:

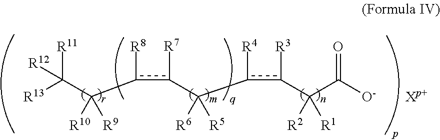

wherein:

R¹, R², R⁵, R⁶, R⁹, R¹⁰, R¹¹, R¹² and R¹³ are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8; and

X^{p+} is a cationic counter ion having a charge state p, and p is 1, 2, or 3.

28. The method of embodiment 1, wherein the composition comprises one or more compounds of Formula V, wherein Formula V is:

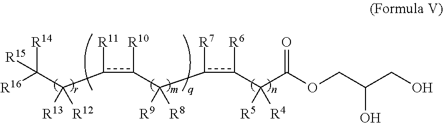

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

29. The method of embodiment 1, wherein the composition comprises one or more compounds of Formula VI, wherein Formula VI is:

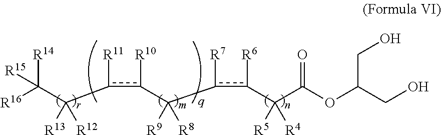

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

30. The method of embodiment 1, wherein the composition comprises one or more compounds of Formula VII, wherein Formula VII is:

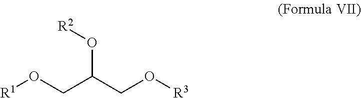

wherein:

R¹, R² are each independently at each occurrence —H, or a fragment of Formula II, and R³ is a fragment of Formula II, where Formula II is:

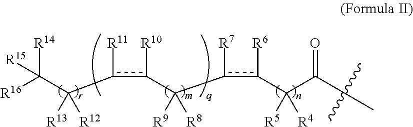

and the total number of —H substituents on R¹ and R² is 1.

wherein:

R⁴, R⁵, R⁸, R⁹, R¹², R¹³, R¹⁴, R¹⁵ and R¹⁶ are each independently, at each occurrence, —H, —OH, —OR¹⁷ or a C₁-C₆ alkyl;

R⁶, R⁷, R¹⁰, and R¹¹ are each independently, at each occurrence, —H, —OR¹⁷, or C₁-C₆ alkyl; or

R⁴ and R⁵ can combine with the carbon atoms to which they are attached to form C═O; and/or

R⁸ and R⁹ can combine with the carbon atoms to which they are attached to form C═O; and/or

R¹² and R¹³ can combine with the carbon atoms to which they are attached to form C═O;

R¹⁷ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

31. The method of embodiment 1, wherein the composition comprises one or more compounds of Formula VIII, wherein Formula VIII is:

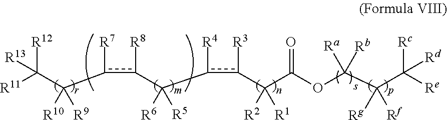

wherein:

R¹, R², R⁵, R⁶, R⁹, R¹⁰, R¹¹, R¹², R¹³, R^{c}, R^{d}, R^{e}, R^{f} and R^{g} are each independently, at each occurrence, —H, —OH, —OR¹⁴, or a C₁-C₆ alkyl;

R³, R⁴, R⁷, and R⁸ are each independently, at each occurrence, —H, —OR¹⁴, or C₁-C₆ alkyl;

R^{a} and R^{b} are each independently, at each occurrence, —H, or C₁-C₆ alkyl; or

R¹ and R² can combine with the carbon atoms to which they are attached to form C═O; and/or

R⁵ and R⁶ can combine with the carbon atoms to which they are attached to form C═O; and/or

R⁹ and R¹⁰ can combine with the carbon atoms to which they are attached to form C═O; and/or

R^{a} and R^{b} can combine with the carbon atoms to which they are attached to form C═O; and/or

R^{g} and R^{f} can combine with the carbon atoms to which they are attached to form C═O;

R¹⁴ is at each occurrence a C₁-C₆ alkyl,

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5;

r is 0, 1, 2, 3, 4, 5, 6, 7 or 8;

s is 0 or 1; and

p is 0, 1, 2, 3, 4, 5, 6, 7, 8.

32. The method of embodiment 1, further comprising causing the composition to be applied to a surface of a substrate to form a protective coating.
33. The method of embodiment 23, wherein the substrate is a perishable item.
34. The method of embodiment 23, wherein the substrate and the protective coating are both edible.
35. A method of forming a composition from seed, bean, nut, kernel or pulp material of plant matter, comprising:

at least partially separating the seed, bean, nut, kernel, or pulp material from other portions of the plant matter;

extracting an oil comprising one or more triglycerides from the seed, bean, nut, kernel, or pulp material;

refining the oil to remove one or more impurity components; and

physically modifying the oil.

36. A method of forming a composition comprising saturated compounds from seed, bean, nut, kernel or pulp material of plant matter, comprising:

providing a crude oil comprising one or more triglycerides, wherein at least 30% of the triglycerides in the crude oil are saturated;

optionally refining the crude oil to remove one or more impurity components; and

separating the saturated triglycerides of the oil from unsaturated triglycerides of the oil; wherein

the crude oil is formed by at least partially separating the seed, bean, nut, kernel, or pulp material from other portions of the plant matter, and extracting the crude oil from the seed, bean, nut, kernel, or pulp material.

37. The method of embodiment 27, wherein the crude oil comprises mango oil, shea oil, or cocoa oil.
38. The method of any of embodiments 27-28, wherein the crude oil is USDA Organic certified.
39. The method of any of embodiments 27-29, wherein the separating of the saturated triglycerides of the oil from the unsaturated triglycerides of the oil comprises melt fractionation or crystallization.
40. The method of any of embodiments 27-30, further comprising transesterifying the separated saturated triglycerides to form the saturated compounds.
41. The method of embodiment 31, wherein the transesterifying of the separated saturated triglycerides comprises glycerolysis to form saturated monoglycerides.
42. The method of embodiment 32, wherein the glycerolysis reaction is carried out using USDA Organic glycerol (>95% organic) and with <5 wt % NaOH as a catalyst.
43. The method of any of embodiments 32-33, wherein the saturated monoglycerides are USDA Organic certified.
44. The method of any of embodiments 27-33, wherein the saturated compounds are USDA Organic certified.
45. The method of any of embodiments 27-35, wherein the saturated compounds, saturated triglycerides, or saturated monoglycerides make up at least 80% of the mass of the composition.

Additional exemplary embodiments include:

1. A method of forming a composition from seed, bean, nut, kernel, or pulp material of non-virgin plant matter, comprising:
a. at least partially separating the seed, bean, nut, kernel, or pulp material from other portions of the plant matter;
b. extracting a crude oil comprising one or more triglycerides from the seed, bean, nut, kernel, or pulp material;
c. optionally refining the crude oil to remove one or more impurity components; and
d. modifying the refined oil to form the composition.
   2. The method according to embodiment 1, wherein the composition comprises at least one of monoglycerides, diglycerides, fatty acids, fatty acid salts, fatty acid esters or any combinations thereof.
   3. The method according to embodiment 1 or 2, wherein the seed, bean, nut, kernel or pulp material is separated from other portions of the plant matter by manual hand separation or by mechanical equipment.
   4. The method according to any one of embodiments 1 to 3 further comprising treating the seed, bean, nut, kernel or pulp material with a water wash, an enzymatic treatment, or any combinations thereof prior to extracting the crude oil.
   5. The method according to any one of embodiments 1 to 4, wherein the crude oil is extracted from the seed, bean, nut, kernel, or pulp material by mechanical pressing, hydraulic pressing, solvent extraction, supercritical solvent extraction, distillation, maceration or the enfleurage method.
   6. The method according to any one of embodiments 1 to 5, wherein the crude oil is refined by clarifying the crude oil, degumming the crude oil, neutralizing the crude oil, bleaching the crude oil, deodorizing the crude oil, washing the crude oil with a solvent, or any combinations thereof.
   7. The method according to embodiment 6, wherein the crude oil is refined by washing the crude oil with a solvent, and the solvent is water, an alcohol, a hydrocarbon, or any mixtures thereof.
   8. The method according to any one of embodiments 1 to 7, wherein the refined oil is chemically modified, physically modified, or a combination thereof.
   9. The method according to embodiment 8, wherein the refined oil is chemically modified by at least one of hydrogenation, glycerolysis, transesterification, hydrolysis, saponification, esterification, deprotonation, or any combinations thereof.
   10. The method according to embodiment 8, wherein the refined oil is physically modified by at least one of crystallization, winterization, melt fractionalization, positional interchange, fatty acid interchange or any combinations thereof.
   11. The method according to embodiment 10, wherein the physically modified oil has an enriched content of saturated molecules.
   12. The method according to any one of embodiments 1-11, wherein the composition is certified USDA organic.
   13. A method of refining crude oil extracted from non-virgin plant matter to be suitable for chemical or physical modification comprising washing the crude oil with water, an alcohol, a hydrocarbon or a combination thereof.
   14. The method according to embodiment 13, wherein the oil is chemically modified by one or more of hydrogenation, transesterification, glycerolysis, hydrolysis, saponification, esterification, deprotonation or any combinations thereof.
   15. The method according to any one of embodiments 13 to 14, wherein the refined oil is physically modified.
   16. The method according to embodiment 15, wherein the refined oil is physically modified by at least one of crystallization, positional interchange, fatty acid interchange or any combinations thereof.
   17. The method according to any one of embodiments 14 to 16, wherein the modified oil is certified USDA organic.
   18. A method of producing a composition substantially comprising saturated compounds comprising:
a. extracting a crude oil from seed, bean, nut, kernel, or pulp material of non-virgin plant matter;
b. optionally refining the crude oil to remove one or more impurity components; and
c. modifying the refined oil to form the composition.
   19. The method according to embodiment 18, wherein the seed, bean, nut, kernel or pulp material is separated from other portions of the plant matter by manual hand separation or by mechanical equipment.
   20. The method according to embodiment 18 or 19 further comprising treating the seed, bean, nut, kernel or pulp material with a water wash, an enzymatic treatment, or any combinations thereof prior to extracting the crude oil.
   21. The method according to any one of embodiments 19-20, wherein the crude oil is extracted from the seed, bean, nut, kernel, or pulp material by mechanical pressing, hydraulic pressing, solvent extraction, supercritical solvent extraction, distillation, maceration or the enfleurage method.
   22. The method according to any one of embodiments 19-21, wherein the crude oil is refined by:
a. optionally clarifying the crude oil, degumming the crude oil, neutralizing the crude oil, bleaching the crude oil, deodorizing the crude oil, or any combinations thereof; and
b. washing the crude oil with a solvent.
   23. The method according to embodiment 22, wherein the solvent is water, an alcohol, a hydrocarbon, or any mixtures thereof.
   24. The method according to any one of embodiments 19-23, wherein the refined oil comprises at least one of monoglycerides, diglycerides, fatty acids, fatty acid salts, fatty acid esters or any combinations thereof.
   25. The method according to any one of embodiments 19-24, wherein the refined oil is chemically modified, physically modified, or a combination thereof.
   26. The method according to embodiment 25, wherein the refined oil is chemically modified by at least one of hydrogenation, transesterification, glycerolysis, hydrolysis, esterification, or any combinations thereof.
   27. The method according to embodiment 26, wherein the chemically modified oil is physically modified to enrich the content of saturated monoglycerides in the composition.
   28. The method according to embodiment 27, wherein the chemically modified oil is physically modified by crystallization, melt fractionalization, winterization, positional interchange, fatty acid interchange or any combinations thereof.
   29. The method according to embodiment 25, wherein the refined oil is physically modified to enrich the content of saturated molecules in the composition.
   30. The method according to embodiment 29, wherein the refined oil is physically modified by at least one of crystallization, melt fractionalization, winterization, positional interchange, fatty acid interchange or any combinations thereof.
   31. The method according to embodiment 29 or 30, wherein the physically modified oil is chemically modified to result in a composition substantially comprising monoglycerides.
   32. The method according to embodiment 31, wherein the physically modified oil is chemically modified by at least one of hydrogenation, transesterification, glycerolysis, hydrolysis, esterification, or any combinations thereof.
   33. The method according to any one of embodiments 18-32, wherein the composition is certified USDA Organic.
   34. A modified non-virgin oil that is characterized by one of:
a. a saturated molecule content of greater than 50%;
b. a triglyceride content of less than 15%;
c. a fatty acid salt content of less than 30%; and
d. a monoglyceride content greater than 50%.
   35. The modified non-virgin oil according to embodiment 34, that is characterized by at least a saturated molecule content of greater than 50%, a triglyceride content of less than 15%, and a monoglyceride content greater than 50%.
   36. The modified non-virgin oil according to embodiment 34 or 35, wherein the saturated molecule content is greater than 60%.
   37. The modified non-virgin oil according to any one of embodiments 34-36 that is certified USDA Organic.
   38. The modified non-virgin oil according to any one of embodiments 34-37, wherein the saturated molecule is one or more of monoglycerides, diglycerides, triglycerides, fatty acids, fatty acid salts, or fatty acid esters.

### Examples

The disclosure is further illustrated by the following examples, which are not to be construed as limiting this disclosure in scope or spirit to the specific procedures herein described. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

The examples provided herein describe methods of producing compositions containing saturated and/or unsaturated fatty acids, fatty acid salts, and/or fatty acid esters, such as glyceryl esters of fatty acids (e.g., 1-monoacylglycerides or 2-monoacylglycerides, 1,2-diacylglycerides, 1,3-diacylglycerides, triacylglycerides), or alkyl esters thereof (e.g., methyl esters, ethyl esters, propyl esters, butyl esters, pentyl esters, hexyl esters, among others). Accordingly, characterization of the mixtures to determine purity or molecular composition can be conducted using characterization tools known to those skilled in the art, including but not limited to nuclear magnetic resonance (e.g., ¹HNMR, ¹³CNMR, ³¹PNMR), mass spectrometry, inductively coupled plasma, chromatography (e.g., gas chromatography, liquid chromatography), spectroscopy (e.g., infrared, ultraviolet-visible), or combinations thereof.

### Examples of Separation of Seed, Bean, Nut, Kernel or Pulp from Plant Matter

Example 01: 1,530 lbs of Grenache pomace (white wine pomace) was processed through a rotary screen separator for the bulk separation of seeds from the rest of the biomass. The seeds were then washed with water to remove residual sugars present on the seeds. The seeds were then spread out for sun drying to remove the bulk moisture. The seeds were then further dried by forced convection drying. The seeds were then sifted to remove residual skins, sticks, and extraneous biomass to afford 100 lbs of extracted seeds.

Example 02: 982 lbs of Pinot Noir pomace (red wine pomace) was processed through a rotary screen separator for the bulk separation of seeds from the rest of the biomass. The seeds were then spread out for sun drying to remove the bulk moisture. The seeds were then further dried by forced convection drying. The seeds were then sifted to remove residual skins, sticks, and extraneous biomass to afford 110 lb of extracted seeds.

Example 03: 2.6 g of lemon seeds were extracted manually from 67.48 g of lemon pomace. The seeds were treated with ColorX Enzyme and dried to 15% moisture using an oven.

Example 04: 50 g of apple pomace was diluted with 400 mL of water and then treated with 0.7 mL of a concentrated ColorX Enzyme solution for 2 hr. The material was then filtered, the seeds were removed manually and then dried to remove the bulk moisture. This afforded 6.5 g of dried Apple seeds.

Example 05: Avocado pits were manually separated from the flesh of the avocado, cracked, and the husks were peeled away from the pit. The cracked pits were hammered into quarters, then the quarters were flattened. The flattened pieces were torn into smaller pieces and then ground in a spice grinder for 30 seconds to afford 158 grams of ground avocado pit.

### Examples of Extraction of Oil Containing Triglycerides from Seed, Bean, Nut, Kernel or Pulp Material

Example 06: 14 g of apple seeds were ground with a spice grinder and subjected to Soxhlet extraction for 24 hours using 700 mL of hexane as solvent. The hexane was then removed by vacuum distillation to afford 1.6 g of Apple seed oil.

Example 07: 65 g of cherry kernels were ground with a spice grinder and subjected to Soxhlet extraction for 24 hours using 1.2 L of hexane as solvent. The hexane was then removed by vacuum distillation to afford 3.0 g of cherry kernel oil.

Example 08: 11.4 g of ground raw peanuts were packed into a 0.5″ OD by 6″ supercritical fluid extractor equipped with a 2000 PSI back pressure regulator at a temperature of 60° C. The ground raw peanuts were extracted using a 1.25 mL/min flow rate of pure CO₂ for 3 hours, followed by 1 hour using 10% ethanol in CO₂ followed by 5 hours using pure CO₂ to afford 3.7 g of peanut oil.

Example 09: 5.7 g of dried and ground olive pomace (250-500 μm particle size) was packed into a 0.5″ OD by 6″ supercritical fluid extractor equipped with a 2000 PSI back pressure regulator at a temperature of 60° C. The olive pomace was extracted using 7 mL/min CO₂ with 0.4 mL/min ethanol for 3 hours to afford 1.1 g of olive pomace oil.

Example 10: 60 kg of red grape seeds were processed with an expeller press to afford crude oil. The oil was then clarified using a bowl centrifuge to afford 5 kg of clear grape seed oil.

Example 11: 67 kg of concord grape seeds were processed with an expeller press to afford crude oil. The oil was then clarified using a bowl centrifuge followed by a filter press to afford 3.6 kg of clear grape seed oil.

### Examples of Purification and/or Refinement of the Extracted Oil

Example 12: 71 g of clarified pumpkin seed oil was degummed by treatment with 0.268 g of citric acid at 85° C. for 1 hour, after which 1.4 mL of water was added to the solution and the temperature was increased to 95° C. The resulting mixture was left to react for 1 hour. The degummed pumpkin seed oil was then neutralized by treatment with 0.18 g of NaOH in 1.4 mL of water at 95° C. for 30 minutes. The product was then isolated by centrifugation. Subsequently, 31 g of neutralized pumpkin seed oil was bleached by treatment with 0.725 g of bleaching clay and 0.1 wt % water at 115° C. for 30 hours under a vacuum of 50 torr. The bleached oil was then isolated by filtration or centrifugation to afford 19.5 g of bleached oil.

Example 13: To 631.7 g of crude grape seed oil was added 1.58 g of citric acid and the mixture was heated to 80° C. with stirring for 1 hour, then 12.63 mL of water was added and the temperature was increased to 95° C. for an additional hour. The mixture was then neutralized with 2.85 g of NaOH in 12.6 mL of water, the solution was left stirring for 30 minutes. The solution was then cooled and filtered (or centrifuged) to afford 578.8 g of oil. The degummed and neutralized grape seed oil was determined to have <0.03% free fatty acid and a peroxide value of >50 mEq O₂/kg oil.

Example 14: To 299.8 g of neutralized grape seed oil was added 7.5 g of bleaching clay, and the mixture was heated to 115° C. with stirring for 30 hours under a vacuum of 50 torr. The material was then filtered to afford bleached grape seed oil. The bleached grape seed oil was determined to have <0.03 wt % free fatty acid and a peroxide value of 3.2 mEq O₂/kg oil.

Example 15: 95 g of bleached grape seed oil heated to 220° C. for 1 hour under a vacuum of 10-50 torr with steam being sparged through the mixture at a rate of 0.1 mL/min. The mixture was then cooled and filtered to afford deodorized grape seed oil. The deodorized grape seed oil was determined to have 0.1 wt % free fatty acid and a peroxide value of 1.3 mEq O₂/kg oil.

Example 16: To 104.8 g of commercially refined peach kernel oil was added 0.36 g of citric acid, and the mixture was heated to 85° C. for 1 hour, after which 2.1 mL of water was added and the temperature was increased to 95° C. and stirred for an additional 1 hour. The mixture was then neutralized with 0.321 g of NaOH in 2.1 mL of water at 95° C. for 30 minutes. Centrifugation afforded the degummed and neutralized oil.

Example 17: 37.5 g of degummed and neutralized peach kernel oil was bleached by treatment with 0.94 g of bleaching clay and 0.1 wt % water at 115° C. for 30 minutes under a vacuum of 50 torr. Subsequent filtration afforded 29.8 g of bleached oil.

Example 18: 34.2 g of commercially refined peach kernel oil was diluted in 150 mL of hexane. The mixture was washed with 35 mL of 87:13 EtOH:water three times. The hexane layer was then treated with MgSO₄ and filtered to remove solids. The solvent was then removed to afford 29.5 g of washed and commercially refined peach kernel oil.

Example 19: To 80 g of commercially refined grapefruit seed oil was added 0.28 g of citric acid, and the mixture was heated to 85° C. for 1 hour, after 1 hour 1.6 mL of water was added and the temperature was increased to 95° C. and stirred for 1 hour. The mixture was then neutralized with 0.245 g of NaOH in 1.6 mL of water at 95° C. for 30 minutes. The degummed and neutralized oil could be isolated by filtration or centrifugation.

Example 20: To 39.5 g of degummed and neutralized grapefruit seed oil was bleached by treatment with 0.987 g of bleaching clay and 0.1 wt % water at 115° C. for 30 minutes under a vacuum of 50 torr. The material was filtered to afford 28.2 g of bleached oil.

Example 21: To 36.1 g of commercially refined grapefruit seed oil was added 150 mL of hexane. The mixture was washed with 35 mL of 87:13 EtOH:water three times. The hexane layer was then treated with MgSO₄ and filtered to remove solids. The solvent was then removed to afford 29.2 g of subsequently refined grapefruit seed oil.

### Examples of Physical or Chemical Modification of Oil

Example 22: 40 g of commercially refined mango butter (thereof 53% saturated fat content) was heated to 70° C. for 30 minutes. The oil was then allowed to cool to 25° C. over 2 hours and held for an additional hour. The material was then filtered to afford 2 g of mango butter (thereof 65% saturated fat content).

Example 23: 10.00 g of commercially refined canola oil (thereof, 4.1% palmitic acid) and 2.93 g of palmitic acid was added to a 20 mL microwave vial. To this was added a stir bar to ensure efficient mixing, and the vial was heated to 65° C. in a heating block. 190 mg of 4-dodecylbenzenesulfonic acid was added to the stirring vial and quickly capped. After heating for 24 hours, the vial was poured into a stirring mix of 150 mL heptane and 150 mL of 70/30 of IPA/H2O with 3 mL of saturated sodium carbonate. The vial was washed out with heptane and the combined mixture transferred to a separatory funnel. The heptane layer was separated, and the aqueous layer was extracted with 150 mL fresh heptane. The combined heptane washes were extracted with 150 mL of 70/30 of IPA/H2O and dried to give the crude triglyceride (thereof, 15.3% palmitic acid).

Example 24: 150 mg of a 20 wt % Ni hydrogenation catalyst was added to 30 g of refined pumpkin seed oil. The mixture was then heated to 150° C. under an inert atmosphere in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were then diluted with chloroform and filtered through a plug of Celite. The solvent was then removed by vacuum distillation to afford 30 g of hydrogenated pumpkin seed oil (thereof >95% saturated triglyceride).

Example 25: 206 g of glycerol and 0.8 g of NaOH was added to 800 g of commercially refined mango butter. The mixture was then heated to 200° C. for 2 hours with stirring under a nitrogen atmosphere. The residual glycerol can then be removed to afford 370 g of composition derived from mango butter comprising about 60% monoglyceride, 30% diglyceride, and 10% triglyceride.

Example 26: 9 g of a composition derived from refined grapeseed oil comprising about 60% monoglyceride, 30% diglyceride, and 10% triglyceride was dissolved in 30 ml of ethyl acetate and added to a reactor with 150 mg of a 20 wt % Ni hydrogenation catalyst. The mixture was then heated to 150° C. under an inert environment in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were filtered through a plug of Celite and the solvent was removed by vacuum distillation to afford 9 g of saturated composition derived from grape seed oil comprising about 60% monoglyceride, 30% diglyceride, and 10% triglyceride.

Example 27: 2.05 g NaOH and 15.1 g of commercially refined mango butter was added to 50 mL of a 1:1 solution of ethanol to water. The mixture is then heated to 80° C. and stirred for 19 hours. After the reaction had gone to completion, the solution was diluted with 250 mL of a 1:1 solution (ethanol to water) to a final concentration of 50 g/L. This solution was then cooled to 45° C. over the course of 1 hour. The solution was then cooled to 30° C. at a rate of 0.22° C./min. The slurry was poured over a filter paper affixed to a filter flask under vacuum and left to dry overnight to afford 3.5 g of mango butter fatty acid salts.

Example 28: A 50 mL ZrO₂ milling jar was charged with ground, dried grape seeds (5 g), powdered NaOH (140 mg), and ZrO₂ milling beads (40 g, 3 mm). The mixture was milled at 650 rpm for 1 hr in a Retsch CM 200 planetary ball mill. The resulting mixture was extracted with hot methanol (50 mL). The solids were removed via filtration over Celite and the filtrate was concentrated under reduced pressure to afford 230 mg of a crude mixture of fatty acid salts derived from grape seeds.

Example 29: A 50 mL ZrO₂ milling jar was charged with dried, used coffee grounds (5 g), powdered NaOH (140 mg), and ZrO₂ milling beads (40 g, 3 mm). The mixture was milled at 650 rpm for 1 hr in a Retsch CM 200 planetary ball mill. The resulting mixture was extracted with hot methanol (50 mL). The solids were removed via filtration over Celite and the filtrate was concentrated under reduced pressure to afford 150 mg of a crude mixture of fatty acid salts.

Example 30: 100 g of commercially refined mango butter was added to 100 g of water. The mixture was then heated to 250° C. in a pressure vessel (approximately 600 psi) for 1 hour with stirring under a nitrogen atmosphere. The reaction was then allowed to cool to afford 75 g of mango butter free fatty acids.

Example 31: 106 g of commercially refined coconut oil was added to 100 g of water. The mixture was then heated to 250° C. in a pressure vessel (approximately 600 psi) for 2 hours with stirring under a nitrogen atmosphere. The reaction was then allowed to cool to afford 100 g of coconut oil fatty acid containing approximately 5 mol % coconut oil monoglyceride.

Example 32: 0.5 mol % Ni hydrogenation catalyst was added to 1 gram of linoleic acid in 30 mL of cyclohexane in a pressure vessel. The solution was stirred at 1200 rpm, heated to 140° C. and pressurized to 160 psi of hydrogen. After 3.5 hours, a sample was taken and there was determined to be a 41% reduction in unsaturation

Example 33: 0.5 mol % Ni hydrogenation catalyst was added to 1 gram of oleic acid in in 30 mL of cyclohexane in a pressure vessel. The solution was stirred at 1200 rpm, heated to 140° C. and pressurized to 160 psi of hydrogen. After 3.5 hours, a sample was taken and there was determined to be a 97% reduction in unsaturation.

Example 34: Oleic Acid (700 g) and glycerol (912 g) were combined in a 2 neck round bottom flask with a stir bar fitted with a distillation head to collect water liberated during the reaction. The flask was sparged with nitrogen, stirred and heated to 220° C. for 12 hours. The reaction mixture was allowed to cool to room temperature, and the glycerol was removed via liquid/liquid separation with water and EtOAc. The organic layer was washed with brine, dried over MgSO₄, and concentrated to a composition rich in mono- and diglycerides of oleic acid (thereof 62% monoglyceride, 34% diglyceride, 3% triglyceride, and 1% free fatty acid).

Example 35: 300 g of capric acid and 5 equivalents of glycerol were stirred at 230° C. for 3 hours. The mixture was cooled and the glycerol layer was separated to afford 305 g of a composition rich in mono- and diglycerides (thereof 88% monoglyceride, 10% diglyceride, and 2% glycerol).

Example 36: 10 wt % CAL-B (immobilized on resin) was added to 180 g of capric acid and 0.3 equivalents of glycerol at 60° C. The solution was held under vacuum (20 torr) at 60° C. with continuous removal of water for 24 hours to afford a composition rich in triglyceride (thereof >95% triglyceride).

Example 37: 3 mol % K₂CO₃ was added to a solution of 4 g of commercially refined canola oil in 6 equivalents of anhydrous methanol. The solution was stirred at 75° C. for 1 hour, then the solution was concentrated, diluted with water, and extracted 3 times with EtOAc. The combined organics were dried over MgSO₄, filtered and concentrated to afford 3.9 g of canola oil derived methyl esters.

Example 38: 25 wt % Cal-B (immobilized on resin) was added to a solution of 3 grams of commercially refined canola oil in 25 equivalents of ethanol. The solution was stirred at 60° C. for 24 hours, filtered and then concentrated. The mixture was diluted with water, and extracted 3 times with EtOAc. The combined organics were dried over MgSO₄, filtered and concentrated to afford 2.85 g of canola oil derived ethyl esters (thereof 95% ethyl ester, 5% monoglyceride).

Example 39: A 50 mL ZrO₂ milling jar was charged with 1 g of stearic acid, powdered NaOH (1.05 equiv), and ZrO₂ milling beads (40 g, 3 mm). The mixture was milled at 650 rpm for 1 hr in a Retsch CM 200 planetary ball mill. The resulting mixture was extracted with hot methanol (50 mL). The solids were removed via filtration over Celite and the filtrate was concentrated under reduced pressure to afford 925 mg of a sodium stearate.

### Effect of Refinement Methods on the Hydrogenation of Grape Seed Oil

The influence of various refinement methods of grape seed oil on hydrogenation reactions was investigated.

Example 40: The hydrogenation of commercially refined grape seed oil was initially assessed. To 30 g of commercially refined grape seed oil, having an iodine value between 124 and 143, was added 150 mg of a 20 wt % Ni hydrogenation catalyst. The mixture was then heated to 150° C. under an inert atmosphere in a glass lined reactor, and then pressurized to 155 psi with hydrogen gas. The reaction was allowed to proceed for 1 hour with stirring set to 1700 rpm. The reactor was then vented to remove hydrogen gas and allowed to cool under a stream of nitrogen. The reaction contents were then diluted with chloroform and filtered through a plug of Celite. The solvent was then removed by vacuum distillation to afford 30 g of hydrogenated grape seed oil (thereof >95% saturated triglyceride; iodine value <10).

Example 41: The hydrogenation of crude grape seed oil was next assessed. To 30 g of centrifuged crude grape seed oil (thereof 111.6 ppm phosphorous, 0.43% free fatty acid, and a peroxide value of 9.5 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 30 minutes. A sample was taken after 30 minutes and reaction conversion was found to be 75%.

Example 42: The influence of clarification, degumming and neutralization refinement methods on hydrogenation reactions was next investigated. To 30 g of centrifuged, degummed and neutralized grape seed oil (thereof 4.43 ppm phosphorous, <0.03% free fatty acid, and a peroxide value of >50 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 30 minutes. A sample was taken after 30 minutes and reaction conversion was found to be 30%.

Example 43: The influence of clarification, degumming, neutralization and bleaching refinement methods on hydrogenation reactions was also investigated. To 30 g of centrifuged, degummed, neutralized, and bleached grape seed oil (thereof <1 ppm phosphorous, <0.03% free fatty acid, and a peroxide value of 3.2 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 30 minutes. A sample was taken after 30 minutes and reaction conversion was found to be 96%.

Example 44: The influence of clarification, degumming, neutralization, bleaching and deodorizing refinement methods on hydrogenation reactions was assessed. To 30 g of centrifuged, degummed, neutralized, bleached, and deodorized grape seed oil (thereof <1 ppm phosphorous, 0.1% free fatty acid, and a peroxide value of 1.3 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 30 minutes. A sample was taken after 30 minutes and reaction conversion was found to be 92%.

The above examples demonstrate that the refinement methods used prior to hydrogenating grape see oil influences how amendable the oil is to that chemical modification. In particular, Example 41 demonstrates that clarified (i.e., centrifuged) grape seed oil yields modest results when hydrogenation reactions are carried out (i.e., 75% conversion). The efficacy of the hydrogenation reaction is reduced drastically when the oil is refined including traditional degumming and neutralization refinement methods (Example 42). The percent conversion is improved substantially by refining the oil by combining clarification, degumming, neutralization, bleaching and optionally deodorizing refinement methods (Examples 43 and 44).

### Effect of Refinement Methods on the Hydrogenation of Peach Kernel Oil

The influence of various refinement methods of peach kernel oil on hydrogenation reactions was investigated.

Example 45: The hydrogenation of commercially refined peach kernel oil was initially assessed. To 30 g of commercially refined peach kernel oil (thereof 3.3 ppm phosphorous, <1% free fatty acid, and a peroxide value of 2.3 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 4%.

Example 46: The influence of degumming, neutralization and bleaching refinement methods on hydrogenation reactions was next investigated. To 30 g of degummed, neutralized, and bleached peach kernel oil was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 51%.

Example 47: The influence of washing peach kernel oil in lieu of traditional refinement methods was assessed. To 30 g of commercially refined and water washed peach kernel oil was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 100%.

The above examples demonstrate that traditional refinement methods (e.g., degumming, neutralizing, bleaching, and deodorizing) are not sufficient for preparing peach kernel oil for subsequent hydrogenation. In particular, peach kernel oil is particularly resistant to hydrogenation (4% conversion; Example 45). The conversion is improved when traditional refinement methods are employed (51% conversion; Example 46). However, washing the peach kernel oil in lieu of those traditional refinement methods surprisingly results in 100% conversion (Example 47).

### Effect of Refinement on the Hydrogenation of Grapefruit Seed Oil

The influence of refinement methods of grapefruit seed oil was investigated to optimize the conditions for hydrogenation reactions.

Example 48: Initially, the hydrogenation of commercially refined grapefruit seed oil was assessed. To 31 g of commercially refined grapefruit seed oil (thereof 3.5 ppm phosphorous, <1% free fatty acid, and a peroxide value of 9.0 mEq O₂/kg) was added 150 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 32%.

Example 49: Next, traditional refinement methods were assessed for the ability to prepare grapefruit seed oil for hydrogenation. To 28 g of degummed, neutralized, and bleached grapefruit seed oil was added 141 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 52%.

Example 50: Finally, the hydrogenation of commercially refined grapefruit seed oil that was further washed with water was assessed. To 29 g of commercially refined and water washed grapefruit seed oil was added 153 mg of a 20 wt % Ni hydrogenation catalyst. The mixture was then heated to 150° C. with stirring under a nitrogen atmosphere. The reaction mixture was then placed under 155 psi of hydrogen gas and allowed to stir for 90 minutes. A sample was taken after 90 minutes and reaction conversion was found to be 65%.

The above examples demonstrate that the efficacy of hydrogenation reactions on grapefruit seed oil is sensitive to refinement methods. In particular, commercially refined grapefruit seed oil yields poor conversion rates (32% conversion; Example 48). While traditional refinement methods did improve the conversion rate (52%; Example 49), the best results were achieved when the oil was washed in addition to traditional refinement methods (65% conversion; Example 50).

### Examples of Chemical Modifications to Hydrogenated Oil

Example 51—Glycerolysis of Hydrogenated Grape Seed Oil: 2.5 g of glycerol and 0.022 g of NaOH was added to 10 g of hydrogenated grape seed oil. The mixture was then heated to 240° C. for 1 hour with stirring under a nitrogen atmosphere. The residual glycerol can then be removed to afford 11 g of a composition derived from hydrogenated grapeseed oil comprising 65% monoglyceride, 28% diglyceride, and 7% triglyceride.

Example 52—Saponification of Hydrogenated Grape Seed Oil: To a solution of 10 g of hydrogenated grape seed oil in 100 mL of ethanol and 100 mL of water heated to 80° C. was added 1.34 g of NaOH. The mixture was then heated to 80° C. and stirred for 6 hours. The reaction mixture was then cooled to 55° C. at a rate of 15° C./hr. The resulting slurry is filtered through a hot clay Buchner funnel to afford 7 g of hydrogenated grape seed oil fatty acids salts.

Example 53—Saponification of Hydrogenated Grape Seed Oil: To a milling jar with 40 g of milling media was added 5 g of hydrogenated grape seed oil and 0.68 g of NaOH. The ball milling apparatus was then set to 650 rpm for 1 hour. The reaction mixture was passed through a 2 micron sieve to remove the milling media and afford 5.2 g of hydrogenated grape seed oil fatty acids salts.

Example 54—Glycerolysis of Hydrogenated Grape Seed Oil: 2.5 g of glycerol and 0.045 g of NaOH was added to 10 g of grape seed oil. The mixture was then heated to 175° C. for 3 hours with stirring under a nitrogen atmosphere. The residual glycerol can then be removed to afford 11 g of a composition derived from grapeseed oil comprising about 60% monoglyceride, 30% diglyceride, and 10% triglyceride.

### Examples of Separation and/or Purification of Compositions

Example 55: 25 g of 1-monoglycerides from mango butter (thereof, 54% saturated monoglycerides) was added to 100 mL of anhydrous ethanol. The mixture was heated to 70° C. with stirring and held constant for 30 minutes. The material was then allowed to cool to 18° C. over 1 hour. The resultant slurry was then filtered to isolate 9.4 g of purified monoglycerides from mango butter (thereof 82% saturated monoglycerides).

Example 56: 600 g of saturated glyceryl esters of fatty acids (thereof 33% diacylglycerides) was added to anhydrous ethanol at 200 g/L. The solution was heated to 80° C. with stirring and held constant for 30 minutes. The material was then allowed to cool to 30° C. over 1 hour and the resultant slurry was filtered. To the filtered material was added anhydrous ethanol at 200 g/L. The solution was again heated to 80° C. with stirring and held constant for 30 minutes. The material was then allowed to cool to 30° C. over 1 hour and the resultant slurry was filtered. To the filtered material was added hexanes at 130 g/L. The solution was heated 60° C. with stirring and held constant for 30 minutes. The material was then allowed to cool to 40° C. over 1 hour and the resultant slurry was filtered to afford a composition of saturated glyceryl esters of fatty acids (thereof 95% diacylglycerides).

Example 57: 30 g of composition of glyceryl esters derived from mango butter (thereof 85% monoglycerides and an iodine value of 35), was heated to 80° C. with stirring until the material was fully liquified. The material was then allowed to cool to 60° C., and to the mixture was added 0.5 wt % of pure glycerol monostearate. The material was stirred for 16 hours and then filtered. The filtered material was again heated to 80° C. with stirring until the material was fully liquified. The material was then allowed to cool to 67° C., and to the mixture was added 0.5 wt % of pure glycerol monostearate. The material was stirred for 16 hours and then filtered to afford a purified composition of glycerides from mango butter (thereof >95% monoglycerides and an iodine value of 14).

### EQUIVALENTS

Various methods of forming compositions from oils extracted from plant matter have been described. However, it should be understood that they have been presented by way of example only, and that various changes in form and details may be made. Where methods and steps described above indicate certain events occurring in certain order, those of ordinary skill in the art having the benefit of this disclosure would recognize that the ordering of certain steps may be modified, and such modification are in accordance with the variations of the disclosure. The embodiments have been particularly shown and described, but it will be understood that various changes in form and details may be made. Accordingly, other embodiments are within the scope of the following claims.

1. A method of forming a composition from seed, bean, nut, kernel, or pulp material of non-virgin plant matter, comprising:
a. at least partially separating the seed, bean, nut, kernel, or pulp material from other portions of the plant matter;
b. extracting a crude oil comprising one or more triglycerides from the seed, bean, nut, kernel, or pulp material;
c. optionally refining the crude oil to remove one or more impurity components; and
d. modifying the refined oil to form the composition.

2. The method according to claim 1, wherein the composition comprises at least one of monoglycerides, diglycerides, fatty acids, fatty acid salts, fatty acid esters or any combinations thereof.

3. The method according to claim 1, wherein the seed, bean, nut, kernel or pulp material is separated from other portions of the plant matter by manual hand separation or by mechanical equipment.

4. The method according to claim 1 further comprising treating the seed, bean, nut, kernel or pulp material with a water wash, an enzymatic treatment, or any combinations thereof prior to extracting the crude oil.

5. The method according to claim 1, wherein the crude oil is extracted from the seed, bean, nut, kernel, or pulp material by mechanical pressing, hydraulic pressing, solvent extraction, supercritical solvent extraction, distillation, maceration or the enfleurage method.

6. The method according to claim 1, wherein the crude oil is refined by clarifying the crude oil, degumming the crude oil, neutralizing the crude oil, bleaching the crude oil, deodorizing the crude oil, washing the crude oil with a solvent, or any combinations thereof.

7. The method according to claim 6, wherein the crude oil is refined by washing the crude oil with a solvent, and the solvent is water, an alcohol, a hydrocarbon, or any mixtures thereof.

8. The method according to claim 1, wherein the refined oil is chemically modified, physically modified, or a combination thereof.

9. The method according to claim 8, wherein the refined oil is chemically modified by at least one of hydrogenation, glycerolysis, transesterification, hydrolysis, saponification, esterification, deprotonation, or any combinations thereof.

10. The method according to claim 8, wherein the refined oil is physically modified by at least one of crystallization, winterization, melt fractionalization, positional interchange, fatty acid interchange or any combinations thereof.

11. The method according to claim 10, wherein the physically modified oil has an enriched content of saturated molecules.

12. The method according to claim 1, wherein the composition is certified USDA Organic.

13. A method of refining crude oil extracted from non-virgin plant matter to be suitable for chemical or physical modification comprising washing the crude oil with water, an alcohol, a hydrocarbon or a combination thereof.

14. The method according to claim 13, wherein the refined oil is chemically modified by one or more of hydrogenation, transesterification, glycerolysis, hydrolysis, saponification, esterification, deprotonation or any combinations thereof.

15. The method according to claim 13, wherein the refined oil is physically modified.

16. The method according to claim 15, wherein the refined oil is physically modified by at least one of crystallization, positional interchange, fatty acid interchange or any combinations thereof.

17. The method according to claim 14, wherein the chemically modified oil is certified USDA Organic.

18. The method according to claim 15, wherein the physically modified oil is certified USDA Organic.

19. A modified non-virgin oil that is characterized by at least one of:
a. a saturated molecule content of greater than 50%;
b. a triglyceride content of less than 15%;
c. a fatty acid salt content of less than 30%; and
d. a monoglyceride content greater than 50%.

20. The modified non-virgin oil according to claim 19, that is characterized by at least a saturated molecule content of greater than 50%, a triglyceride content of less than 15%, and a monoglyceride content greater than 50%.

21. The modified non-virgin oil according to claim 19, wherein the saturated molecule content is greater than 60%

22. The modified non-virgin oil according to claim 19, wherein the saturated molecule is one or more of monoglycerides, diglycerides, triglycerides, fatty acids, fatty acid salts, or fatty acid esters.

23. The modified non-virgin oil according to claim 19 that is certified USDA Organic.
